(19) United States
(12) Patent Application Publication
(10) Pub. No.: US 2021/0069910 A1
(43) Pub. Date: Mar. 11, 2021

(54) SYSTEMS AND METHODS FOR MINIMANIPULATION LIBRARY ADJUSTMENTS AND CALIBRATIONS OF MULTI-FUNCTIONAL ROBOTIC PLATFORMS WITH SUPPORTED SUBSYSTEM INTERACTIONS

(71) Applicant: Mark Oleynik, Monaco (MC)

(72) Inventor: Mark Oleynik, Monaco (MC)

(21) Appl. No.: 16/900,842

(22) Filed: Jun. 12, 2020

Related U.S. Application Data
(60) Provisional application No. 62/860,293, filed on Jun. 12, 2019.
(60) Provisional application No. 62/929,973, filed on Nov. 4, 2019.
(60) Provisional application No. 62/970,725, filed on Feb. 6, 2020.
(60) Provisional application No. 62/984,321, filed on Mar. 3, 2020.
(60) Provisional application No. 63/026,328, filed on May 18, 2020.

(51) Int. Cl. B25J 11/00; B65G 1/137; B25J 9/16; B25J 13/08; F25D 23/02

(52) U.S. Cl. CPC B25J 11/0045; B65G 1/137; B25J 5/02; B25J 13/08; F25D 23/028; B25J 9/1692

(57) ABSTRACT

The present disclosure is directed to methods, computer program products, and computer systems of a multi-functional robotic platform including a robotic kitchen for calibration with either a joint state trajectory or in a coordinate system like a cartesian coordinate for mass installation of robotic kitchens, multi-mode operations of the robotic kitchen to provide different ways to prepare food dishes, and subsystems tailored to operate and interact with the various elements of a robotic kitchen, such as the robotic effectors, other subsystems, and containers, ingredients. Calibration verifications and minimanipulation library adaptation and adjustment of any serial model or different models provide scalability in the mass manufacturing of a robotic kitchen system, as well as methods as to how each manufactured robotic kitchen system meets the operational requirements. A robotic kitchen with multi-mode provides a robot mode, a collaboration mode and a user mode which a particular food dish can be prepared by the robot, a collaboration on sharing tasks between the robot and a user, or the robot serves as an aid for the user to prepare a food dish.

### CROSS REFERENCE TO RELATED APPLICATIONS

This application claims priority to U.S. Provisional Application Ser. No. 62/860,293 entitled “Systems and Methods for Operation Automated and Robotic Environments in Living and Warehouse Facilities,” filed 12 Jun. 2019; U.S. Provisional Application Ser. No. 62/929,973 entitled “Method and System of Robotic Kitchen and IOT Environments,” filed 4 Nov. 2019; U.S. Provisional Application Ser. No. 62/970,725 entitled “Systems and Methods for Operation Automated and Robotic, Instrumental Environments Including Living and Warehouse Facilities,” filed 6 Feb. 2020; and U.S. Provisional Application Ser. No. 62/984,321 entitled “Systems and Methods for Operation Automated and Robotic, Instrumental Environments Including Living and Warehouse Facilities,” filed 3 Mar. 2020; U.S. Provisional Application Ser. No. 63/026,328 entitled “Ingredient Storing Smart Container for Human and Robotic Operation Environment,” filed 18 May 2020, the disclosures of which are incorporated herein by reference in their entireties.

### BACKGROUND

### Technical Field

The Present Disclosure Relates Generally to the Interdisciplinary Fields of Robotics and Artificial intelligence (AI), more particularly to computerized robotic systems employing electronic libraries of minimanipulations with transformed robotic instructions for replicating movements, processes, and techniques with real-time electronic adjustments.

### BACKGROUND ART

Research and development in robotics have been undertaken for decades, but the progress has been mostly in the heavy industrial applications like automobile manufacturing automation or military applications. Simple robotics systems have been designed for the consumer markets, but they have not seen a wide application in the home-consumer robotics space, thus far. With advances in technology, combined with a population with higher incomes, the market may be ripe to create opportunities for technological advances to improve people's lives. Robotics has continued to improve automation technology with enhanced artificial intelligence and emulation of human skills and tasks in many forms in operating a robotic apparatus or a humanoid.

The notion of robots replacing humans in certain areas and executing tasks that humans would typically perform is an ideology in continuous evolution since robots were first developed in the 1970s. Manufacturing sectors have long used robots in teach-playback mode, where the robot is taught, via pendant or offline fixed-trajectory generation and download, which motions to copy continuously and without alteration or deviation. Companies have taken the pre-programmed trajectory-execution of computer-taught trajectories and robot motion-playback into such application domains as mixing drinks, welding or painting cars, and others. However, all of these conventional applications use a 1:1 computer-to-robot or tech-playback principle that is intended to have only the robot faithfully execute the motion-commands, which is usually following a taught/pre-computed trajectory without deviation.

As the research and development in the robotic industry has accelerated in recent years, both in consumer robotics, commercial robotics and industrial robotics, companies are working to design robotic products that can be scaled and widely deployed in their respective regions and worldwide. Due in part to the mechanical compositions of a robotic product, mass manufacturing and installation of robotic products present challenges to ensure that the finished robotic product operates to meet with the technical specification, which can arise from issues such as part variations, manufacturing errors, installation differences, and others.

Accordingly, it is desirable to have a robotic system with a fully or semi automatic calibration operating framework and minimanipulation library adjustment for mass manufacturing kitchen modules, multiple modes of operations, and subsystems operating and interacting in a robotic kitchen.

### SUMMARY OF THE DISCLOSURE

Embodiments of the present disclosure are directed to methods, computer program products, and computer systems of a multi-functional robotic platform including a robotic kitchen for calibration with either a joint state trajectory or in a coordinate system like a cartesian coordinate for mass installation of robotic kitchens, multi-mode (also referred to as multiple modes, e.g., bimodal, trimodel, multimodal, etc.) operations of the robotic kitchen to provide different ways to prepare food dishes, and subsystems tailored to operate and interact with the various elements of a robotic kitchen, such as the robotic effectors, other subsystems, and containers, ingredients.

In a first aspect of the present disclosure, a system and a method comprises a reliable operation inside a robotic kitchen in an instrumented environment is the capability to rely on absolute positioning of the instrumented environment. As to resolve a common problem in robotics in which each robotic system manufactured undergoes calibration verifications and minimanipulation library adaptation and adjustment of any serial model or different models automatic adaptation. The disclosure is directed to the scalability in the mass manufacturing of a robotic kitchen system, as well as methods as to how each manufactured robotic kitchen system meets the operational requirements. Standardized procedures are adopted which are aimed to automate the calibration process. Accurate and repeatable assembly process is the first step in assuring that each manufactured robotic system is as close as possible to the assumed (or predetermined) geometry or geometric parameters. Lifetime product natural deformation could be also the reason to process time to time automatic calibration and minimanipulation library adaptation and adjustment. The different product models need to have also adapted and validated library of minimanipulation which support various functional operations. Automated calibration procedures assure that operations created inside a master (or model) kitchen environment works in each robotic kitchen system and the solution is easily scalable for mass production. The physical geometry is adapted for robotic operations, any displacement in the robotic system is being compensated using various techniques as described in the present disclosure. In another embodiment, the present disclosure is directed to a robotic system compatibility operable in a plurality of different modes. User mode, robot mode and collaborative mode. Document specifying the way of mitigation for the risk in collaborative mode, using different sensors to keep environment safe for human collaborative operation. For example, the present disclosure describes a robotic kitchen system and a method that operates with any functional robotic platform having minimanipulation operations libraries of a master robotic kitchen module with an automatic calibration system for initializing the initial state of another robotic kitchen during an installation.

In a second aspect of the present disclosure, a robotic system and a method that comprise a plurality of modes of operations of a robotic kitchen, including but not limited to, a robot operating mode, a collaborative operating mode between a robot apparatus and a user, and a user operating mode which the robotic kitchen facilitating to the requirements by the user.

In a third aspect of the present disclosure, a robotic kitchen includes subsystems that are designed to operate and interact with a robot (e.g., one or more robotic arms coupled to one or more end effectors), or interact with other subsystems, kitchen tools, kitchen devices, or containers.

Broadly stated, a system for mass production of a robotic kitchen module, comprises a kitchen module frame for housing a robotic apparatus in an instrumented environment, the robotic apparatus having one or more robotic arms and one or more effectors, the one or more robotic arms including a share joint, the kitchen module having a set of robotic operatable parameters for calibration verifications to an initial state for operation by the robotic apparatus; and one or more calibration actuators coupled to a respective one of the one or more robotic arms, each calibration actuator corresponding to an axis on x-y-z axes, each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations.

Advantageously, the robotic systems and methods of the present disclosure provide greater functions and capabilities that work on multi-functional robotic platforms with calibration techniques with a joint state embodiment or a cartesian embodiment with multiple modes of operating the robotic kitchen.

The structures and methods of the present disclosure are disclosed in detail in the description below. This summary does not purport to define the disclosure. The disclosure is defined by the claims. These and other embodiments, features, aspects, and advantages of the disclosure will become better understood with regard to the following description, appended claims, and accompanying drawings.

### BRIEF DESCRIPTION OF THE DRAWINGS

The disclosure will be described with respect to specific embodiments thereof, and reference will be made to the drawings, in which:

FIG. 1A is a system diagram illustrating a top sectional view in an intersection of a robotic kitchen in a robot operating mode in accordance with the present disclosure; FIG. 1B is a system diagram illustrating a front view in the intersection of a robotic kitchen in a robot operating mode in accordance with the present disclosure; and FIG. 1C is a system diagram illustrating a front view of a robotic kitchen in a robot operating mode, with safeguard actuated to a down position to create a physical barrier between a robot apparatus in operation and human user, in accordance with the present disclosure; and

FIGS. 1D, 1E, 1F, 1G are flow diagrams illustrating a software system of the robotic kitchen with several subsystems, including a kitchen core, a chief executor, a creator software, shared components, and a user interface in accordance with the present disclosure.

FIGS. 2A-1 to 2A-4 collectively represent one complete flow diagram illustrating a process for different modes of operations, including a robot mode, a collaborative mode and a user mode, in a robotic kitchen in accordance with the present disclosure.

FIG. 2B is a flow diagram illustrating robotic task-execution via one or more minimanipulation library data sets to execute recipes from an electronic library database in a collaborative mode with a safety function and as to how a remote robotic system would utilize the minimanipulation (MM) library(ies) to carry out a remote replication of a particular task (cooking, painting, etc.) in accordance with the present disclosure.

FIG. 2C is a block diagram illustrating a data-centric view of the robotic system with a database for collaborative mode use safety workspace analysis sensory data in accordance with the present disclosure.

FIG. 2D depicts a dual-arm torso humanoid robot system as a set of manipulation function phases associated with any manipulation activity, regardless of the task to be accomplished, for MM library manipulation-phase combinations and transitions for task-specific action-sequences in accordance with the present disclosure.

FIG. 2E depicts a flow diagram illustrating the process of minimanipulation Library(ies) generation, for both generic and task-specific motion-primitives as part of the studio-data generation, collection and analysis process in accordance with the present disclosure.

FIG. 2F depicts a block diagram illustrating an automated minimanipulation parameter-set building engine for a minimanipulation task-motion primitive associated with a particular task in accordance with the present disclosure.

FIG. 2G is a block diagram illustrating examples of various minimanipulation data formats in the composition, linking and conversion of minimanipulation robotic behavior data in accordance with the present disclosure.

FIG. 2H depicts a logical diagram of main action blocks in the software-module/action layer within the macro-manipulation and micro-manipulation subsystems and the associated minimanipulation libraries dedicated to each in accordance with the present disclosure.

FIG. 2I depicts a block diagram illustrating the macro-manipulation and micro-manipulation physical subsystems and their associated sensors, actuators and controllers with their interconnections to their respective high-level and subsystem planners and controllers as well as world and interaction perception and modelling systems for minimanipulation planning and execution process in accordance with the present disclosure.

FIG. 2J depicts a block diagram illustrating one embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems in accordance with the present disclosure.

FIG. 2K depicts the process by which minimanipulation command-stack sequences are generated for any robotic system, in this case deconstructed to generate two such command sequences for a single robotic system that has been physically and logically split into a macro- and micro-manipulation subsystem in accordance with the present disclosure.

FIG. 2L depicts a block diagram illustrating another embodiment of the physical layer structured as a macro-manipulation/micro-manipulation in accordance with the present disclosure.

FIG. 2M depicts a block diagram illustrating another embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems in accordance with the present disclosure.

FIG. 2N depicts one of a myriad number of possible decision trees that may be used to decide on a macro-/micro-logical and physical breakdown of a system for the purpose of high fidelity control in accordance with the present disclosure.

FIG. 2O is a block diagram illustrating an example of a macro manipulation (also referred to as macro minimanipulation) of a stir process with todo parameters divided into (or composed of) multiple micro manipulations in accordance with the present disclosure.

FIG. 2P is a flow diagram illustrating the process of a macro/micro manager in allocating one or more macro manipulations and one or more micro manipulations in accordance with the present disclosure.

FIG. 3A is a system diagram illustrating a top view in the intersection of a robotic kitchen in a user operating mode in accordance with the present disclosure. In this illustration, the robot is hidden in the storage, the safeguard is actuated in the upper position, and human user is operating inside the cooking zone; FIG. 3B is a system diagram illustrating a front view in of a robotic kitchen in a user operating mode in accordance with the present disclosure. In this illustration, the robot is hidden in the storage, the safeguard is actuated in an upper position, and the human user is operating inside the cooking zone; and FIG. 3C is a system diagram illustrating a front view of the robotic kitchen in a user operating mode in accordance with the present disclosure. In this illustration, the robot is hidden in the storage, the safeguard is actuated in the upper position, and the human user is operating inside the cooking zone; FIG. 3D is a system diagram illustrating robot storage automatic doors closed and robot inside storage zone in accordance with the present disclosure; FIG. 3E is a system diagram illustrating robot storage automatic doors opened and robot inside the cooking zone; and FIG. 3F is a system diagram illustrating robot storage automatic doors with sensors, actuators guides, and safety components.

FIG. 4A is a system diagram illustrating a top view in the intersection of a robotic kitchen in a collaborative operating mode in accordance with the present disclosure. Safeguard is actuated to the upper position allowing the user to operate inside the cooking zone. Example robots are operating alongside human users. Camera and safety sensor system are monitoring the user position to plan robot actions and keep the user safe; FIG. 4B is a system diagram illustrating the front view of a robotic kitchen in a collaborative operating mode in accordance with the present disclosure. Safeguard is actuated to the upper position allowing the user to operate inside the cooking zone. Example robots are located inside cooking zone, safety sensors are visible; and FIG. 4C is a system diagram illustrating the front view of a robotic kitchen in a collaborative operating mode in accordance with the present disclosure. Safeguard is actuated to the upper position allowing the user to operate inside the cooking zone. Example robots are operating alongside human users. Camera and safety sensor system are monitoring the user position to plan robot actions and keep the user safe.

FIG. 5 is a system diagram illustrating a robotic kitchen system in a collaborative mode in accordance with the present disclosure.

FIG. 6 is a system diagram illustrating collaborative robot cooking station with conveyor belt system. Robots are performing cooking operations and passing dishes on the conveyor belts to human users.

FIG. 7A is a system diagram illustrating stationary collaborative robot cooking station in accordance with the present disclosure. A user is not harmed by the robot, as the robot is not able to physically reach the user. Zoning sensors are also placed in roboti kitchen the system. Robot is portioning the meals for human users in the common area, the user picks the dish, and then robot portions another one. Common area external zoning sensors for user detection are visible, the system understands when the user entered the common area; and FIG. 7B is a system diagram illustrating a stationary collaborative robot cooking station in accordance with the present disclosure. A user is not harmed by the robot, as the robot is not able to physically reach the user. Zoning sensors are also placed in roboti kitchen the system. Robot is portioning the meals for human users in the common area, the user picks the dish, and then robot portions another one. Common area internal zoning sensors for robot detection are visible, the system understands when the robot entered the common operation area.

FIG. 8 is a system diagram illustrating a robotic kitchen low level control system architecture in accordance with the present disclosure.

FIG. 9 is a system diagram illustrating an example of a robots system using different types of actuators in accordance with the present disclosure.

FIG. 10 is a system diagram illustrating a robotic hand with a plurality of sensors and a plurality of actuators for handling reliable recipe execution (e.g., sensors: RFID tag reader, UV light, LED light, tactile sensors, pressure sensors, barcode scanner) in accordance with the present disclosure.

FIG. 11A is a system diagram illustrating automatic tendon adjustment process for robotic hands in accordance with the present disclosure. If an object gets displaced after cooking operation i.e. stirring, the hand is commanding finger joints position to readjust itself to fix the object position back to the starting one. A system is using sensors and cameras to determine the displacement of the object and fixed position accuracy; and FIG. 11B is a system diagram illustrating a robot system with cameras attached to the carriage body. The System is able to monitor the surrounding environment. Grasp validation procedure available on the drawing. Camera ability to adjust its position and orientation with different angular configurations making the vision system more versatile. A vision system field of view is visible on the drawing.

FIG. 12 is a system diagram illustrating the reliable and repeatable assembly process of the frame in accordance with the present disclosure. Single parts of the frame illustrated on the diagram have the ability to interface one to another in only one way, to high precision machined inserts. The same way of interfacing is applied between the frame and subsystems.

FIG. 13 is a system diagram illustrating example assembly procedure for the robotic kitchen frame explained in accordance with the present disclosure. Profiles come in pre-assembled kits for ease of transport, which in one embodiment, is assembled only in one way, as to minimize the risk of inaccuracy and mistakes.

FIG. 14 is a system diagram illustrating a bottom view of the frame and subsystem interfacing one to another. High precision interfaces are visible on the drawing, High accuracy and repeatability inside the system is ensured inside the assembled system.

FIG. 15A is a system diagram illustrating an isometric view of the etalon model in accordance with the present disclosure.

FIG. 15B is a system diagram illustrating an side view of the etalon model in accordance with the present disclosure.

FIG. 15C is a system diagram illustrating an isometric view of the etalon model in accordance with the present disclosure.

FIG. 15D is a system diagram illustrating an isometric view of the etalon model in accordance with the present disclosure.

FIG. 16A is a system diagram illustrating automatic robot error tracking procedure, with the Y, Z positions and the X1, Y1 and Z1 positions illustrated in FIG. 16C, in accordance with the present disclosure; and FIG. 16B is a system diagram illustrating automatic robot error tracking procedure in accordance with the present disclosure.

FIG. 17 is a system diagram illustrating automatic adjustment procedure of robot model n in joint state execution library mode in accordance with the present disclosure.

FIG. 18 is a calibration flow chart indicating sequence of operation during calibration in accordance with the present disclosure.

FIG. 19 is a system diagram illustrating a tool storage mechanism for robotic kitchen in an exploded view in accordance with the present disclosure.

FIG. 20 is a system diagram illustrating vertical movement of the tool storage inside the kitchen environment in accordance with the present disclosure.

FIG. 21 is a system diagram illustrating vertical movement of the tool storage inside the kitchen environment in accordance with the present disclosure.

FIG. 22 is a system diagram illustrating tool storing drawers with its linear actuation, position feedback, position locking functionality for defined grasp position in accordance with the present disclosure.

FIG. 23A is a pictorial diagram illustrating a front view of quadruple direction hook interface in accordance with the present disclosure; and FIG. 23B is a system diagram illustrating isometric view of quadruple direction hook interface in accordance with the present disclosure.

FIG. 24 is a system diagram illustrating a tool storage system in a user mode in accordance with the present disclosure.

FIG. 25A is a visual diagram illustrating an exploded view of an inventory tracking device hook with multiple sensors, actuators, indicators, and communication modules in accordance with the present disclosure; and FIG. 25B is a visual diagram illustrating an exploded view of an inventory tracking device with multiple sensors, actuators, indicators, and communication modules in accordance with the present disclosure.

FIG. 26A is a visual diagram illustrating an inventory tracking device actuated hook initial position and orientation in accordance with the present disclosure; FIG. 26B is a visual diagram illustrating an inventory tracking device actuated hook position and orientation change executed by actuator system inside in accordance with the present disclosure; and FIG. 26C is a visual diagram illustrating an inventory tracking device actuated hook position and orientation change executed by actuator system inside in accordance with the present disclosure.

FIG. 27 is a system diagram illustrating one embodiment of an inventory tracking device architecture in accordance with the present disclosure.

FIG. 28 is a system diagram illustrating inventory tracking device example communication architecture in accordance with the present disclosure.

FIG. 29 is a system diagram illustrating one embodiment of an inventory tracking device for product installation in accordance with the present disclosure.

FIG. 30 is a system diagram illustrating one embodiment of an inventory tracking device for object training in accordance with the present disclosure.

FIG. 31 is a system diagram illustrating one embodiment of an inventory tracking device for object detection in accordance with the present disclosure.

FIG. 32 is a system diagram illustrating one example of an inventory tracking device on the sequence behaviour for product installation in accordance with the present disclosure.

FIG. 33 is a system diagram illustrating one example of an inventory tracking device on sequence behaviour for object training and detection in accordance with the present disclosure.

FIG. 34 is a system diagram illustrating one embodiment of a smart rail system in accordance with the present disclosure.

FIG. 35 is a system diagram illustrating one example on the functionality of a smart rail system in accordance with the present disclosure.

FIG. 36 is a system diagram illustrating one embodiment of a smart rail device example communication system in accordance with the present disclosure.

FIG. 37 is a system diagram illustrating an exploded view of a smart refrigerator with a different type of sensors, actuators and indicators integrated inside as part of a robotic kitchen in accordance with the present disclosure.

FIG. 38 is a system diagram illustrating an exploded view of a smart refrigerator tray with functionality provided by different types of sensors, actuators and indicators for use with the smart refrigerator in the robotic kitchen in accordance with the present disclosure.

FIG. 39 is a system diagram illustrating a user grasping of a container from container tray, with a light-emitting diode (LED) light projected on the position of the container in accordance with the present disclosure.

FIG. 40 is a visual diagram illustrating a refrigerator system with an integrated container tray and a set of containers in a robotic kitchen in accordance with the present disclosure.

FIG. 41 is a visual diagram illustrating one or more containers placed on the tray with electromagnet auto positioning functionality in accordance with the present disclosure.

FIG. 42 is a visual diagram illustrating the operational compatibility representation with robot and a human hand. Containers placed inside the refrigerator system can be operated freely by anthropomorphic hands in accordance with the present disclosure.

FIG. 43 is a system diagram illustrating the operational compatibility with a gripper type (for example, parallel and electromagnetic) in accordance with the present disclosure.

FIG. 44 is a system diagram illustrating a robotic system gripper with an electromagnet grasping and operating one or more container sin accordance with the present disclosure.

FIG. 45 is a visual diagram illustrating the back of a container with the lid in a closed position in accordance with the present disclosure.

FIG. 46 is a visual diagram of a coupler for robot gripper, with terminals for power and data exchange, in accordance with the present disclosure.

FIG. 47. is a system diagram illustrating the bottom view of the container in accordance with the present disclosure.

FIG. 48 is a system diagram illustrating an exploded view of the container with the functional components in accordance with the present disclosure.

FIG. 49 is a system diagram illustrating an automatic charging station inside the tray for containers, with physical contacts and wireless charging modules, in accordance with the present disclosure.

FIG. 50A is a system diagram illustrating a robot actuating to push to open a container lid mechanism, with a visible closed position, in accordance with the present disclosure.

FIG. 50B is a system diagram illustrating a robot actuating the push to open a container lid mechanism, with a visible open position, in accordance with the present disclosure.

FIG. 51 is pictorial diagram illustrating an exploded view of a robot end effector compatibility with a lid handle operation in accordance with the present disclosure.

FIG. 52 is a system diagram illustrating the different sizes of containers inside the robotic kitchen system refrigerator in accordance with the present disclosure.

FIG. 53 is a block diagram illustrating overall architecture of the refrigerator system in accordance with the present disclosure.

FIG. 54 is a system diagram illustrating a generic storage space with inventory tracking, position allocation and automatic sterilization functionality, with an automatic hand sterilization procedure, in accordance with the present disclosure.

FIG. 55 is a system diagram illustrating a robotic kitchen environment sterilization equipment, with an automatic hand sterilization procedure in accordance with the present disclosure.

FIG. 56 is a visual diagram illustrating a robotic kitchen in which one or more robotic kitchen equipment are placed inside and under refrigerator storage in accordance with the present disclosure.

FIG. 57 is a visual diagram illustrating a human user operating a graphical user interface (“GUI”) screen in accordance with the present disclosure.

FIG. 58 is a visual diagram illustrating a robotic kitchen in which one or more robotic kitchen equipment are placed inside and under refrigerator storage in accordance with the present disclosure.

FIG. 59 is a visual diagram illustrating a human user operating a graphical user interface (“GUI”) screen in accordance with the present disclosure.

FIG. 60 is a visual diagram illustrating a system with an automated safeguard opened position (of a robotic kitchen) in accordance with the present disclosure.

FIG. 61 is a block diagram illustrating a smart ventilation system inside of a robotics system environment in accordance with the present disclosure.

FIG. 62A is a block diagram illustrating a top view of a fire safety system along with the indications of nozzles and fire detect tube in accordance with the present disclosure; and FIG. 62B is a block diagram illustrating a dimeric view of a fire safety system along with the indications of nozzles and fire detect tube in accordance with the present disclosure.

FIG. 63 system diagram illustrating mobile robot manipulator interacting with the kitchen in accordance with the present disclosure.

FIG. 64A is a flow diagram illustrating the repositioning a robotic apparatus by using actuators for compensating the difference of an environment in accordance with the present disclosure; FIG. 64B is a flow diagram illustrating the recalculation each robotic apparatus joint state for trajectory execution with x-y-z and rotational axes for compensating the difference of an environment in accordance with the present disclosure; and FIG. 64C is flow diagram illustrating cartesian trajectory planning for environment adjustment in accordance with the present disclosure.

FIG. 65 is a flow diagram illustrating the process of placement for reconfiguration with a joint state in accordance with the present disclosure.

FIGS. 66A-H are table diagrams illustrating one embodiment of a manipulations system for a robotic kitchen in accordance with the present disclosure.

FIGS. 67A-B are tables (intended as one table) illustrating one example of a stir manipulation to action primitive in accordance with the present disclosure.

FIG. 68 is a block diagram illustrating a robotic kitchen manufacturing environment with an etalon unit production phase, an additional unit production phase, and all units life duration adjustment phase in accordance with the present disclosure.

FIG. 69 is a block diagram illustrating an example of a computer device on which computer-executable instructions to perform the robotic methodologies discussed herein may be installed and executed in accordance with the present disclosure.

### DETAILED DESCRIPTION

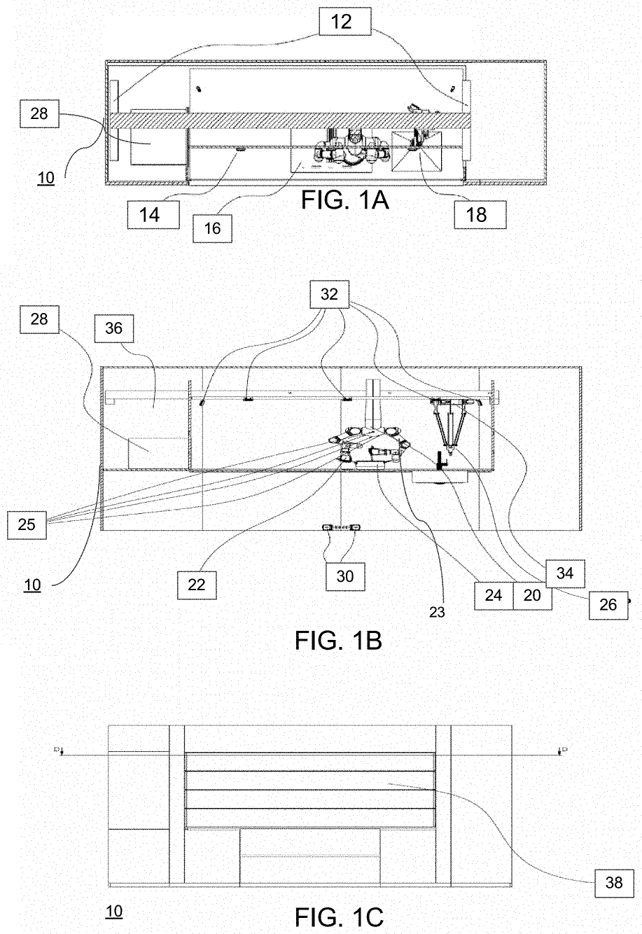

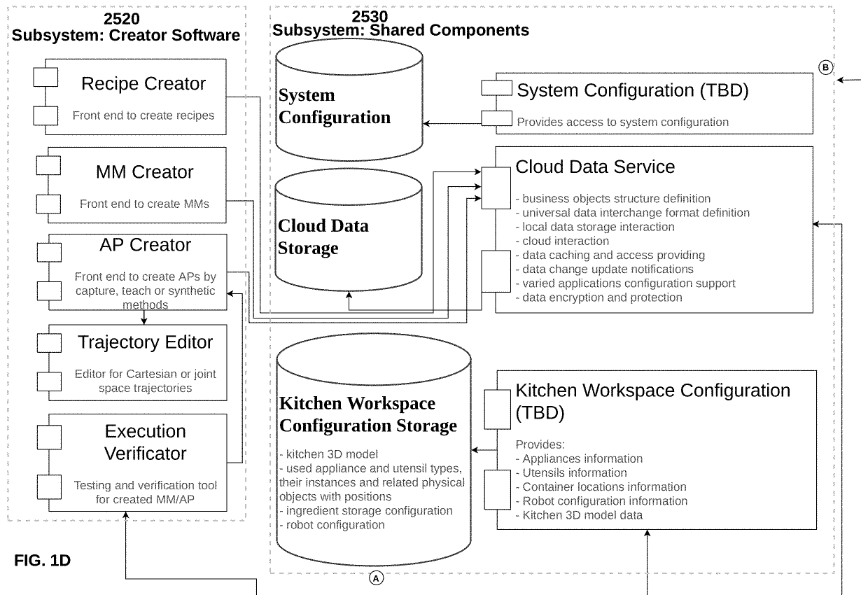

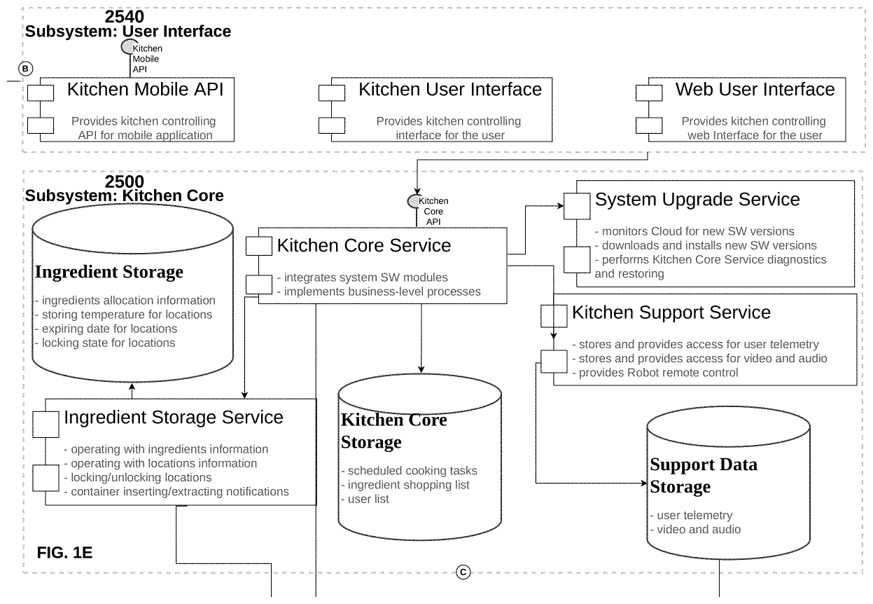

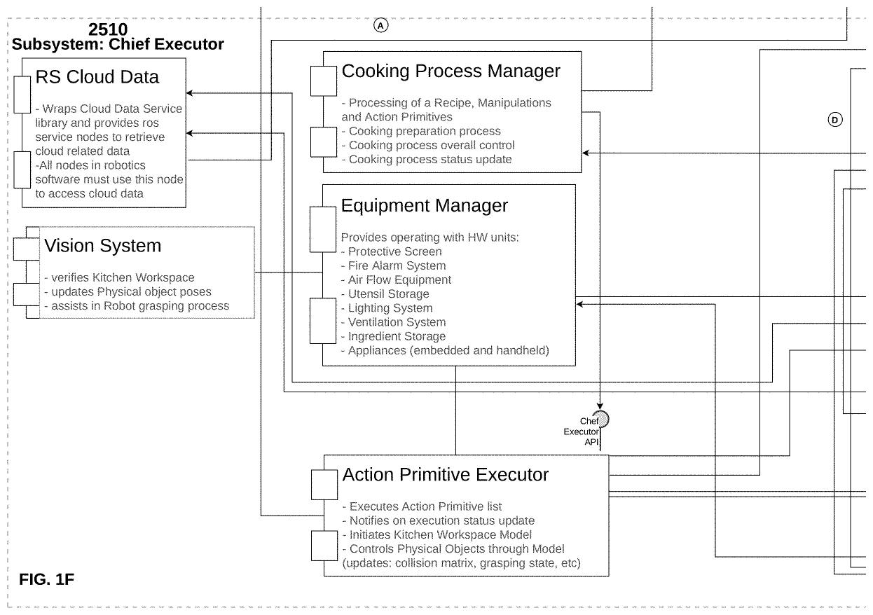

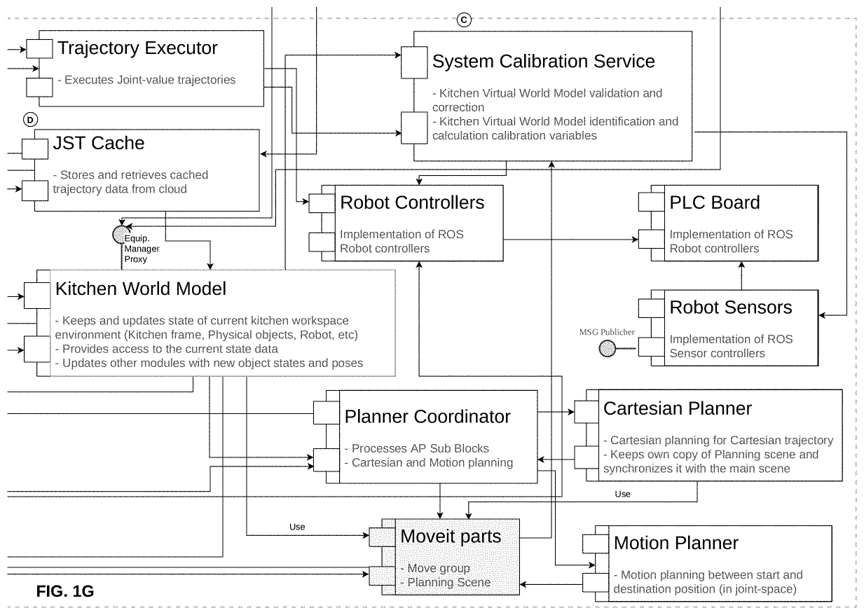

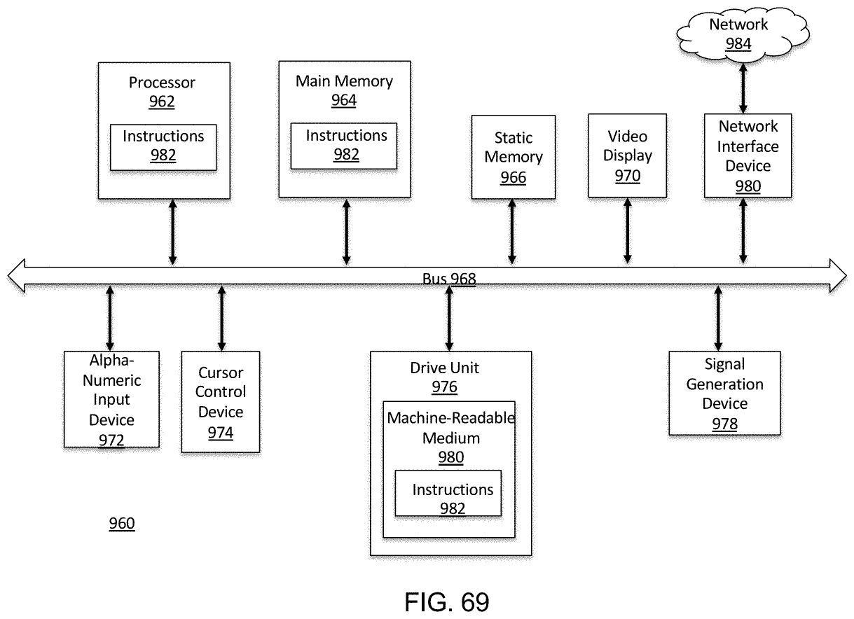

A description of structural embodiments and methods of the present disclosure is provided with reference to FIGS. 1-69. It is to be understood that there is no intention to limit the invention to the specifically disclosed embodiments but that the invention may be practiced using other features, elements, methods, and embodiments. Like elements in various embodiments are commonly referred to with like reference numerals.

The following definitions apply to the elements and steps described herein. These terms may likewise be expanded upon.

Accuracy—refers to how closely a robot can reach a commanded position. Accuracy is determined by the difference between the absolute positions of the robot compared to the commanded position. Accuracy can be improved, adjusted, or calibrated with external sensing, such as sensors on a robotic hand or a real-time three-dimensional model using multiple (multi-mode) sensors.

Action Primitive (AP)—refers to the smallest functional operation executable by the robot. An action primitive starts and ends with a Default Posture. In one embodiment, action primative refers to an indivisible robotic action, such as moving the robotic apparatus from location X1 to location X2, or sensing the distance from an object (for food preparation) without necessarily obtaining a functional outcome. In another embodiment, the term refers to an indivisible robotic action in a sequence of one or more such units for accomplishing a minimanipulation. These are two aspects of the same definition. (smallest functional subblock—lower level minimanpualtion

Cartesian plan—refers to a process which calculates a joint trajectory from an existing cartesian trajectory.

Cartesian trajectory—refers to a sequence of timed samples (each sample comprises of an xyz position and an 3-axis orientation expressed as a quaternion or euler angles) in the kitchen space, defined for a specific frame (object or hand frame) and related to another reference frame (kitchen or object frame).

Collaborative mode—refers to one of the multiple modes of the robotic kitchen (other modes include a robot mode and a user mode) where the robot executes a food preparation recipe in conjunction with a human user, where the execution of a food preparation recipe may divide up the tasks between the robot and the human user.

Dedicated—refers to hardware elements such as processors, sensors, actuators and buses, that are solely used by a particular element or subsystem. In particular, each subsystem within the macro- and micro-manipulation systems, contain elements that utilize their own processors and sensor and actuators that re solely responsible for the movements of the hardware element (shoulder, arm-joint, wrist, finger, etc.) they are associated with.

Default Posture—refers to a predefined robot posture, associated with a specific held object or empty hand for each arm.

Joint State—refers to a configuration for a set of robot joints, expressed as a set of values, one for each joint.

Joint Trajectory (aka Joint Space Trajectory or JST)—refers to a timed sequence of joint states.

Kitchen Module (or Kitchen Volume)—a standardized full-kitchen module with standardized sets of kitchen equipment, standardized sets of kitchen tools, standardized sets of kitchen handles, and standardized sets of kitchen containers, with predefined space and dimensions for storing, accessing, and operating each kitchen element in the standardized full-kitchen module. One objective of a kitchen module is to predefine as much of the kitchen equipment, tools, handles, containers, etc. as possible, so as to provide a relatively fixed kitchen platform for the movements of robotic arms and hands. Both a chef in the chef kitchen studio and a person at home with a robotic kitchen (or a person at a restaurant) uses the standardized kitchen module, so as to maximize the predictability of the kitchen hardware, while minimizing the risks of differentiations, variations, and deviations between the chef kitchen studio and a home robotic kitchen. Different embodiments of the kitchen module are possible, including a standalone kitchen module and an integrated kitchen module. The integrated kitchen module is fitted into a conventional kitchen area of a typical house. The kitchen module operates in at least two modes, a robotic mode and a normal (manual) mode.

Machine Learning—refers to the technology wherein a software component or program improves its performance based on experience and feedback. One kind of machine learning often used in robotics is reinforcement learning, where desirable actions are rewarded and undesirable ones are penalized. Another kind is case-based learning, where previous solutions, e.g. sequences of actions by a human teacher or by the robot itself are remembered, together with any constraints or reasons for the solutions, and then are applied or reused in new settings. There are also additional kinds of machine learning, such as inductive and transductive methods.

Minimanipulation (MM)—generally, MM refers to one or more behaviors or task-executions in any number or combinations and at various levels of descriptive abstraction, by a robotic apparatus that executes commanded motion-sequences under sensor-driven computer-control, acting through one or more hardware-based elements and guided by one or more software-controllers at multiple levels, to achieve a required task-execution performance level to arrive at an outcome approaching an optimal level within an acceptable execution fidelity threshold. The acceptable fidelity threshold is task-dependent and therefore defined for each task (also referred to as “domain-specific application”). In the absence of a task-specific threshold, a typical threshold would be 0.001 (0.1%) of optimal performance.
In one embodiment from a robotic technology perspective, the term MM refers to a well-defined pre-programmed sequence of actuator actions and collection of sensory feedback in a robot's task-execution behavior, as defined by performance and execution parameters (variables, constants, controller-type and -behaviors, etc.), used in one or more low-to-high level control-loops to achieve desired motion/interaction behavior for one or more actuators ranging from individual actuations to a sequence of serial and/or parallel multi-actuator coordinated motions (position and velocity)/interactions (force and torque) to achieve a specific task with desirable performance metrics. MMs can be combined in various ways by combining lower-level MM behaviors in serial and/or parallel to achieve ever-higher and higher-level more-and-more complex application-specific task behaviors with an ever higher level of (task-descriptive) abstraction.
In another embodiment from a software/mathematical perspective, the term MM refers to a combination (or a sequence) of one or more steps that accomplish a basic functional outcome within a threshold value of the optimal outcome (examples of threshold value as within 0.1, 0.01, 0.001, or 0.0001 of the optimal value with 0.001 as the preferred default). Each step can be an action primitive, corresponding to a sensing operation or an actuator movement, or another (smaller) MM, similar to a computer program comprised of basic coding steps and other computer programs that may stand alone or serve as sub-routines. For instance, a MM can be grasping an egg, comprised of the motor actions required to sense the location and orientation of the egg, then reaching out a robotic arm, moving the robotic fingers into the right configuration, and applying the correct delicate amount of force for grasping: all primitive actions. Another MM can be breaking-an-egg-with-a-knife, including the grasping MM with one robotic hand, followed by grasping-a-knife MM with the other hand, followed by the primitive action of striking the egg with the knife using a predetermined force at a predetermined location.
In a further embodiment, manipulation refers to a high level robotic operation in which the robot manipulates an object using the bare hands or some utensil. A Manipulation comprises of (is composed by) Action Primitives.
High-Level Application-specific Task Behaviors—refers to behaviors that can be described in natural human-understandable language and are readily recognizable by a human as clear and necessary steps in accomplishing or achieving a high-level goal. It is understood that many other lower-level behaviors and actions/movements need to take place by a multitude of individually actuated and controlled degrees of freedom, some in serial and parallel or even cyclical fashion, in order to successfully achieve a higher-level task-specific goal. Higher-level behaviors are thus made up of multiple levels of low-level MMs in order to achieve more complex, task-specific behaviors. As an example, the command of playing on a harp the first note of the 1^{st} bar of a particular sheet of music, presumes the note is known (i.e., g-flat), but now lower-level MMs have to take place involving actions by a multitude of joints to curl a particular finger, move the whole hand or shape the palm so as to bring the finger into contact with the correct string, and then proceed with the proper speed and movement to achieve the correct sound by plucking/strumming the cord. All these individual MMs of the finger and/or hand/palm in isolation can all be considered MMs at various low levels, as they are unaware of the overall goal (extracting a particular note from a specific instrument). While the task-specific action of playing a particular note on a given instrument so as to achieve the necessary sound, is clearly a higher-level application-specific task, as it is aware of the overall goal and need to interplay between behaviors/motions and is in control of all the lower-level MMs required for a successful completion. One could even go as far as defining playing a particular musical note as a lower-level MM to the overall higher-level applications-specific task behavior or command, spelling out the playing of an entire piano-concerto, where playing individual notes could each be deemed as low-level MM behaviors structured by the sheet music as the composer intended.
Low-Level Minimanipulation Behaviors—refers to movements that are elementary and required as basic building blocks for achieving a higher-level task-specific motion/movement or behavior. The low-level behavioral blocks or elements can be combined in one or more serial or parallel fashion to achieve a more complex medium or a higher-level behavior. As an example, curling a single finger at each finger joint is a low-level behavior, as it can be combined with curling each of the other fingers on the same hand in a certain sequence and triggered to start/stop based on contact/force-thresholds to achieve the higher-level behavior of grasping, whether this be a tool or a utensil. Hence, the higher-level task-specific behavior of grasping is made up of a serial/parallel combination of sensory-data driven low-level behaviors by each of the five fingers on a hand. All behaviors can thus be broken down into rudimentary lower levels of motions/movements, which when combined in certain fashion achieve a higher-level task behavior. The breakdown or boundary between low-level and high-level behaviors can be somewhat arbitrary, but one way to think of it is that movements or actions or behaviors that humans tend to carry out without much conscious thinking (such as curling ones fingers around a tool/utensil until contact is made and enough contact-force is achieved) as part of a more human-language task-action (such as “grab the tool”), can and should be considered low-level. In terms of a machine-language execution language, all actuator-specific commands, which are devoid of higher-level task awareness, are certainly considered low-level behaviors.

Minimanipulation library adaptation—refers to a particular minimanipulation library is adapted (or modified) to custom fit a specific kitchen module due to the differences (or deviations from the reference parameters of a master kitchen) identified between a master kitchen module and the particular kitchen module.

Minimanipulation library transformation—refers to transforming a cartesian coordinate environment to a different operating environment tailored to a specific type of robot. Repositioning the actuators to compensate for a greater flexibility for the robotic arms and effectors to reach a particular location

Macro/Micro minimanipulations—refers to a combination of macro mininmanipulations and micro minimanipulations for executing a complete or a portion of the food preparation recipe. The term macro minimanipulations and micro minimanipulations can have a different types of relationship between macro minimanipulations and micro minimanipulations. For example, in one embodiment, macro/micro minimanipulations refers to one macro minimanipulation comprises one or more micro minimanipulations. To phrase it another way, each micro minimanipulation serves as a subset of a macro minimanipulation. In another embodiment, a macro-micro minimanipulation subsystem refers to a separation at the logical and physical level that is to bound the computational load on planners and controllers, particularly for the required inverse kinematic computation, to a level that allows the system to operate in real-time. The term “macro minimanipulation” is also referred to as macro manipulation, or macro-manipulation. The term “micro minimanipulation” is also referred to as micro manipulation, or micro-minimanipulation.

Motion Plan—refers to a process which calculates a joint trajectory from a start joint state and an end joint state.

Motion Primitives—refers to motion actions that define different levels/domains of detailed action steps, e.g. a high-level motion primitive would be to grab a cup, and a low-level motion primitive would be to rotate a wrist by five degrees.

Parameter Adjustment—refers to the process of changing the values of parameters based on inputs. For instance changes in the parameters of instructions to the robotic device can be based on the properties (e.g. size, shape, orientation) of, but not limited to, the ingredients, position/orientation of kitchen tools, equipment, appliances, speed, and time duration of a minimanipulation.

Pre-planned JST (aka Cached JST)—refers to a pre-planned JST, saved inside a cache and retrieved when required for execution.

Recipe—refers to a sequence of manipulations.

Reconfiguration—refers to an operation which can move the robot from the current joint state to a unique pre-defined joint state, used typically when the object to manipulate was moved from it's expected pre-defined placement.

Robotic Apparatus—refers one or more robotic arms and one or more robotic end effectors. The robotic apparatus may include a set of robotic sensors, such as cameras, range sensors, and force sensors (haptic sensors) that transmit their information to the processor or set of processors that control the effectors.

Robot mode—refers to one of the multiple modes of the robotic kitchen where the robot completely or primarily executes a food preparation recipe.

User mode—refers to one of the multiple modes of the robotic kitchen where the robot may serve to aid or facilitate a human in food preparation recipe.

FIG. 1A is a visual diagram depicting robotic system operating in a robot mode with an axis system, robot carriage 20 34, which comprise of one or more robotic arms 23 coupled with or more end effectors 22. In one embodiment, the robot 10 is operating with an instrumented environment of a robotic kitchen. The axis 12 can be actuated using various different types of linear and rotary actuators, e.g. pneumatic actuators, hydraulic actuators, electric actuators etc. A robot system comprises of a multiple axis (e.g., x-y-z axes, x-y-z and rotational, multiple rotational and linear axes, the entire robot can rotate around one axis system, etc.) system allowing a carriage 20 carrying one or more arms 23 to reach to any point within the workspace (or an instrumented environment of the robotic kitchen), such as to adjust for any orientation as required to execute a robotic operation. In one embodiment, the robotic system 10 comprises a centralized control system for controlling and interacting with each of the subsystems in the robotic kitchen system. Each subsystem serves to provide one or more cooking functions involved during the execution of a food recipe by the robot system alongside others subsystems on the figure there is a sink and a tap 18, hob 16, oven 28 and worktop area which is constantly monitored by vision system 32.

FIG. 1B is a visual diagram depicting a different kind of robotic system that can be used inside the system 26, and robots can work in collaboration with each other like shown on figure. Different sensor and camera 32 environment monitoring system works inside the system. Safety sensors to scan environment around the robot are visible on the figure. Robot 20 using its end-effector 22 to hold a cooking tool 24 is visible on the figure.

FIG. 1C is a visual diagram depicting In a robot mode (or “a robotic mode), prior to execution of the recipe, the robot system begin execution of safety operations sequence, one of them is safeguard (or “a protective screen”) 38 actuating and interlocking to provide a protection shield from humans. After the protective screen is closed and interlocked, then the centralized control system in the robotic kitchen would permit the robot to operate. While the safeguard is being actuated to a down position, required safeguard position for robot mode, one or more safety sensors 30 is monitoring the instrumented environment (or “a confined workspace) around robotic kitchen 10 to ensure that safeguard actuation would be cause potential hazards, preventing harming a human, e.g. children, or an animal. The robotic kitchen 10 includes a vision system 32 that provides vision and feedback capabilities to support and complement robot execution. The robot 20 operates with kitchen tools, kitchen appliances, kitchen equipment and kitchen smart appliances.

FIGS. 1D, 1E, 1F, 1G are flow diagrams, which form one large diagram, illustrating a software system of the robotic kitchen with several subsystems, including a kitchen core 2500, a chief executor 2510, a creator software 2520, shared components 2530, and a user interface 2540. The subsystem of kitchen core 2500 is designed to implement the main business-level processes and to integrate all other modules into the system. The kitchen core 2500 is responsible for controlling and updating the status of the whole system, scheduling cooking tasks, controlling active cooking task, working with ingredients, ingredient storage, managing recipes and user accounts. The subsystem comprises of (1) kitchen core service: integrates system software modules, implements business level processes; (2) system upgrade service: checks for new system version, performing system updates and subsystem diagnostics; and (3) ingredient storage service: managing ingredients and ingredients storage. The kitchen core subsystem 2500 processes requests from user interface subsystem, such as cooking and cleaning requests, and then depending on the request saves some data modifications done by user such as adding or removing ingredients or requests execution from a chief executor subsystem 2510 by Cooking Process Manager.

The subsystem of the chief executor 2510 performs recipe execution, storing and updating kitchen environment status and managing all hardware kitchen components. The chief executor subsystem 2510 comprises of:
cooking process manager: processes recipe and controls cooking process
action primitive executor: executes and controls robot manipulations, updates robot state and execution status
kitchen world model: stores and updates kitchen environment status such as object locations and states, provides environment status to other modules
planner coordinator: performs Cartesian and motion planning
cartesian planner: performs planning in Cartesian space
motion planner: performs planning in joint space
jst cache: saves and loads planned manipulation joint state trajectories
trajectory executor: performs joint state trajectory execution
robot controllers: implements robot drivers
robot sensors: collecting all available data from all sensors and providing it to other modules
PLC Board: performs communication between high-level software components and low-level hardware controllers
equipment manager: executes appliance commands, stores and updates appliance statuses
vision system: updates kitchen object positions and orientations, verifies robot manipulations execution
rs cloud data: provides interface between chief executor subsystem and shared components subsystem, converting data structures
system calibration service: identifies and calculates calibration variables for given physical model, checks, validates and corrects kitchen virtual world model based on provided calibration data

The chief executor subsystem 2510 receives execution requests from Kitchen Core subsystem such as a recipe, requests execution data from Shared Components subsystem such as Action Primitive and its associated robotics data and performs trajectories execution, which are can be planned or requested by cache module from cloud data service. Before the execution subsystem is capable of checking the environment and perform calibration if needed, which can modify executable joint state trajectory or request re-plan of Cartesian trajectory.

The subsystem of shared components 2520 includes mainly storage components used in other software subsystems or components. The shared components subsystem 2520 includes (1) system configuration: stores configurations for kitchen core subsystem; (2) cloud data service: stores all business data such as recipes, manipulations etc.; and (3) kitchen workspace configuration storage: stores kitchen 3D model and robot configurations.

Since the shared components subsystem stores all the data, which can be used by creator subsystem to get recipes, Minimanipulations, Action Primitives, trajectories and associated data for editing or saving, by Chief Executor subsystem 2510 to get executable robotics data such as trajectories inside Action Primitives and robot configuration associated data to set up virtual world and robot model and by kitchen core subsystem to get recipes associated data.

The subsystem of a creator software 2530 provides applications for creation and editing both business and robotics data. The subsystem comprises of:
recipe creator: application for creating and editing high-level recipes with functionality of precise definition of each recipe step including timings, ingredient amounts and videos
mm creator: application for creating and editing minimanipulations with functionality of creating manipulation trees and creating and editing manipulation parameters
ap creator: application for creating action primitives, action primitive sub blocks using synthetic, teach and capture methods of creation
trajectory editor: application for editing cartesian and joint state trajectories with functionality of shifting joints, translating and rotating points in trajectories and modifying trajectory speed
execution verificator: application for automated testing and verification of correct execution of created Minimanipulation/AP based on available sensors data and pre-selected verification control points

Creation process starts from chief, who creates recipes, which are then used as an input for creation Action Primitives with given manipulation parameters, from which are then created cartesian and joint state trajectories. This data is saved in cloud data service in Shared Components subsystem 2520 and later used for execution by Action Primitive Executor in Chief Executor subsystem. After data is created, it should be tested and verified by Execution Verificator to ensure that this data can be executed reliably.

The subsystem of a user interface 2540 implements user interface for interaction with the whole system of a robotic platform. The user interface subsystem 2540 comprises from:
kitchen user interface: provides graphical interface for controlling the whole system which comes together with the kitchen
kitchen mobile API: provides control of the whole system for mobile applications
web user interface: provides control of the whole system using web applications
   It is used as an entry point for user to the whole system, from which starts recipe selection, ingredient management and recipe cooking, which is then communicates with Kitchen Core subsystem to process all user requests.

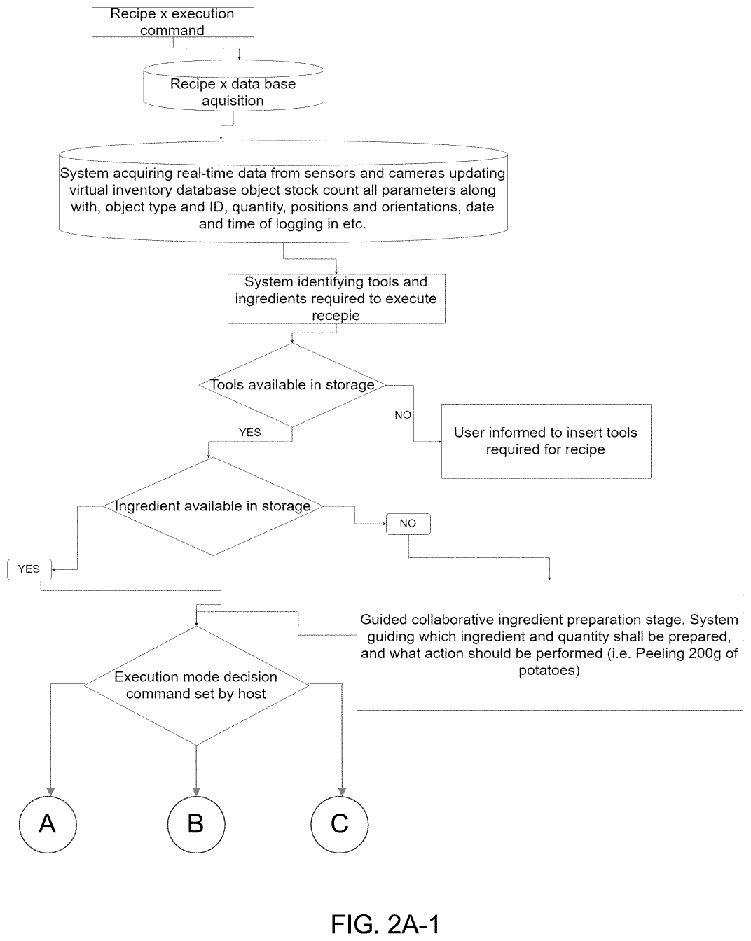

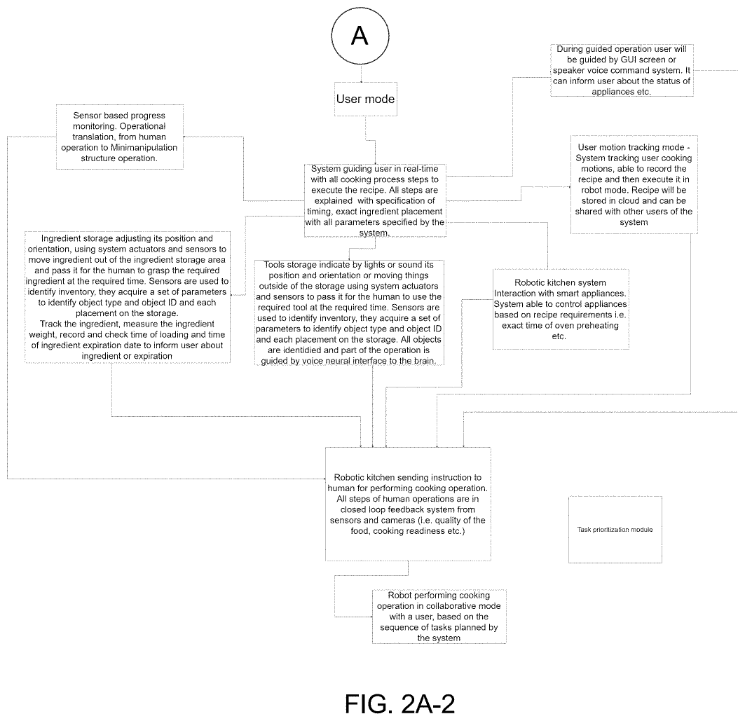

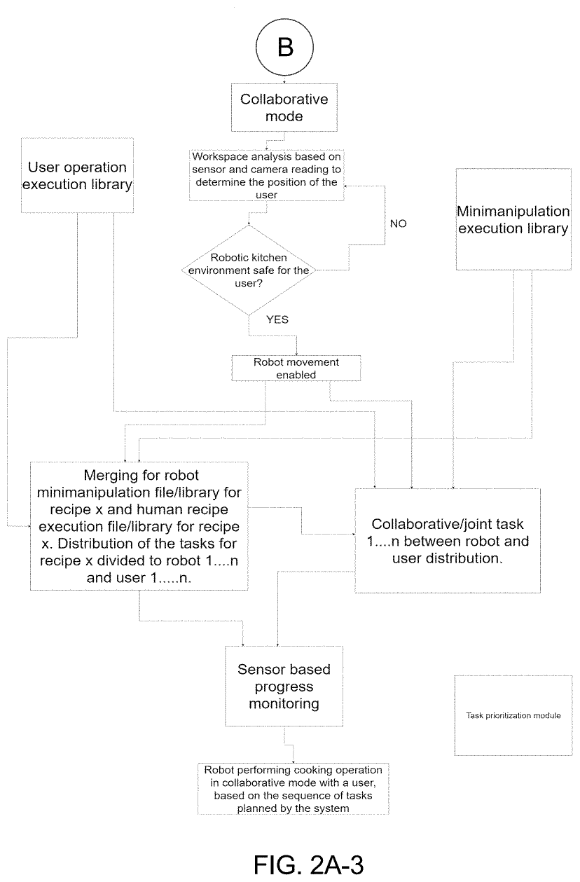

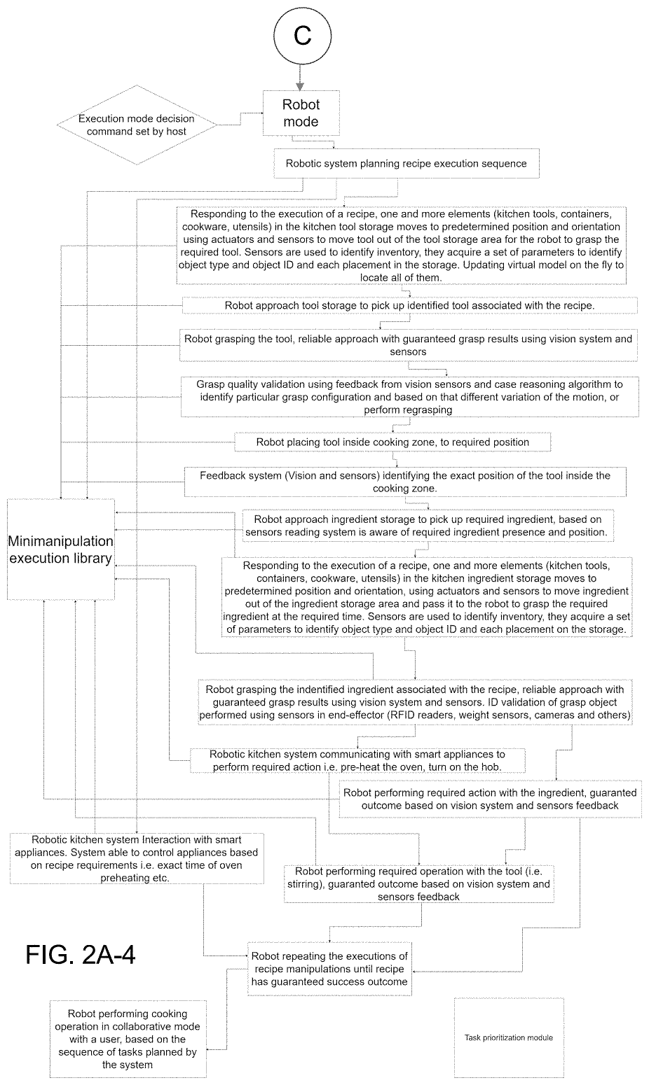

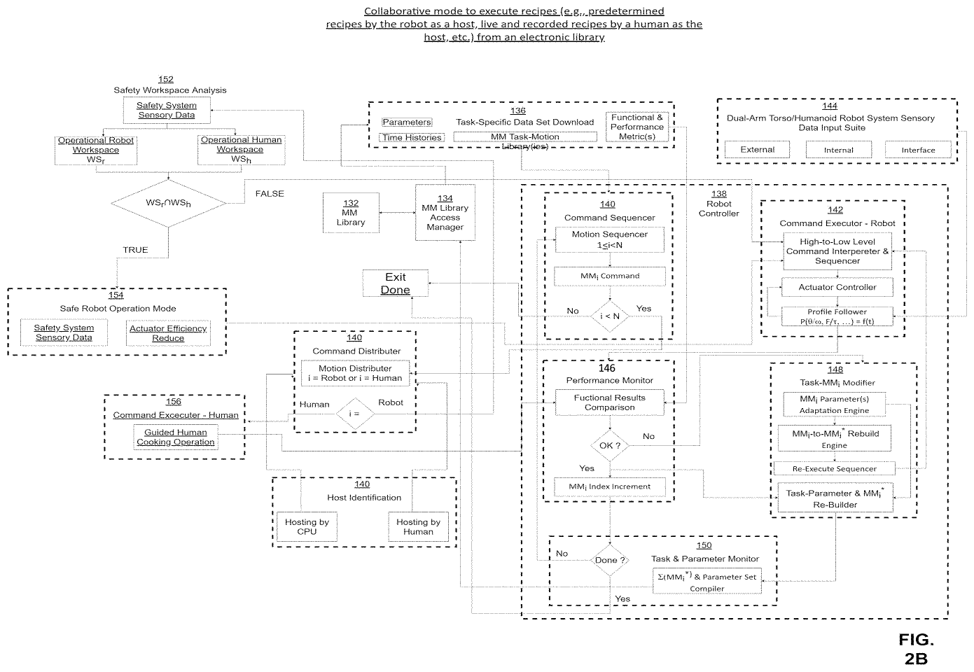

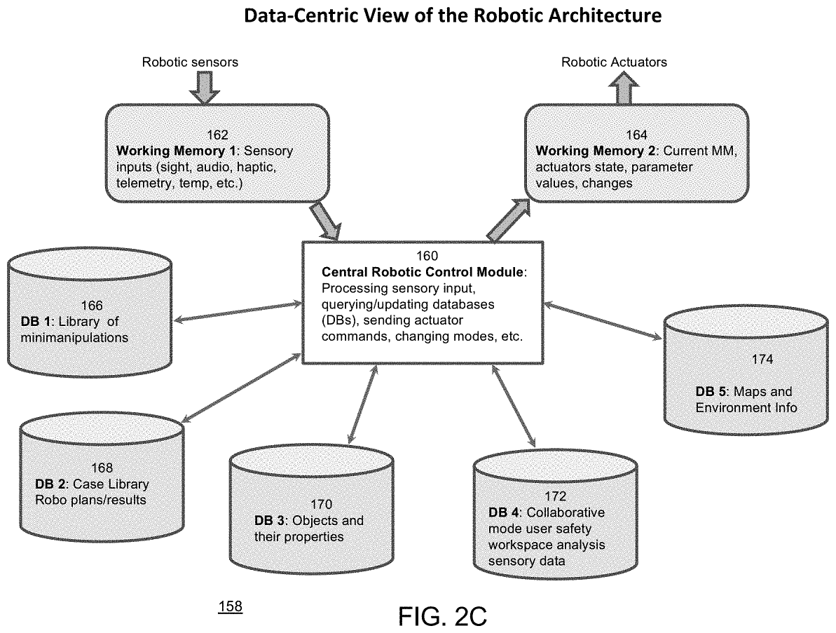

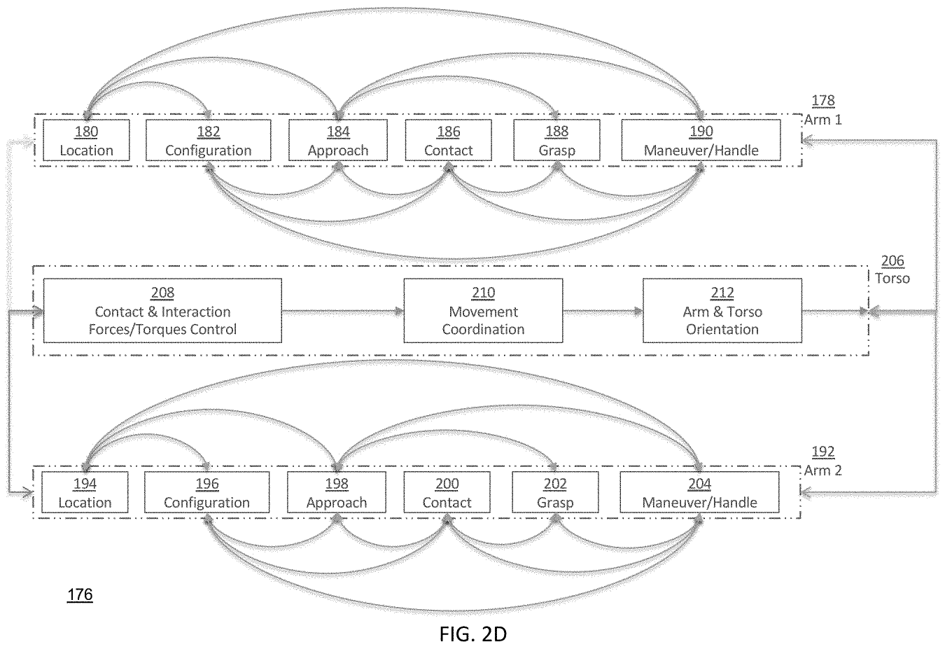

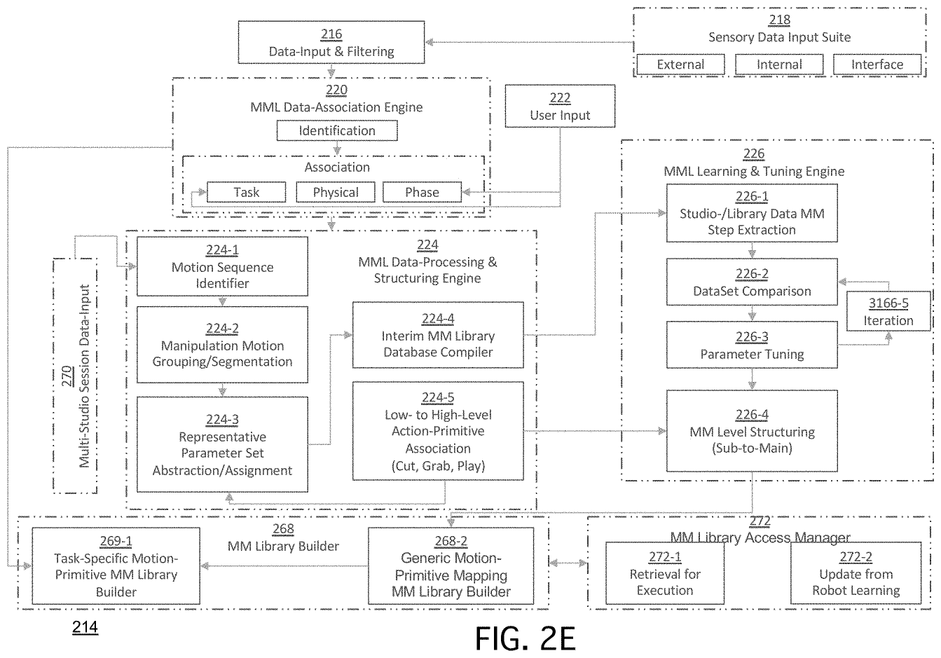

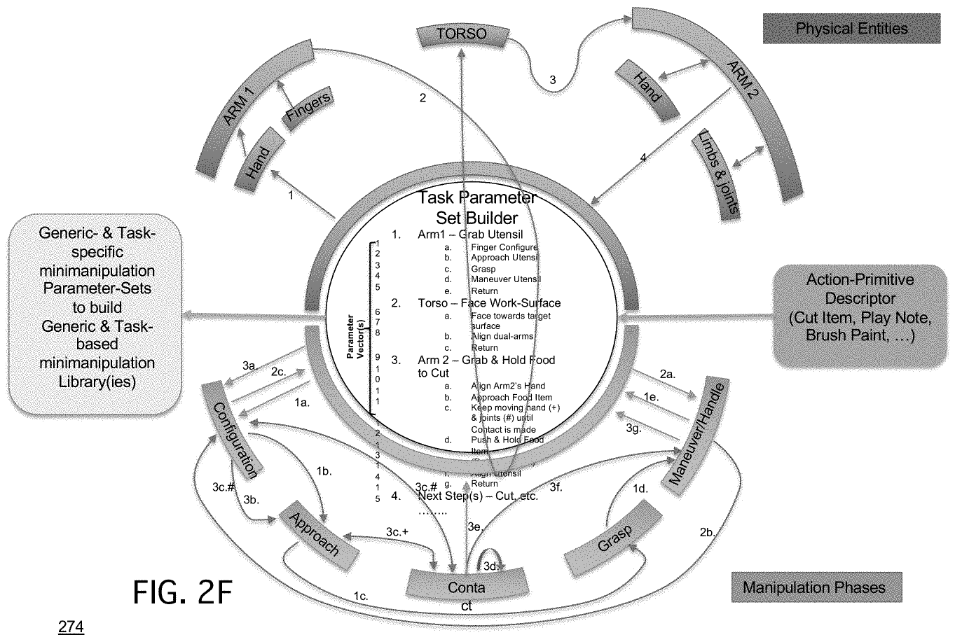

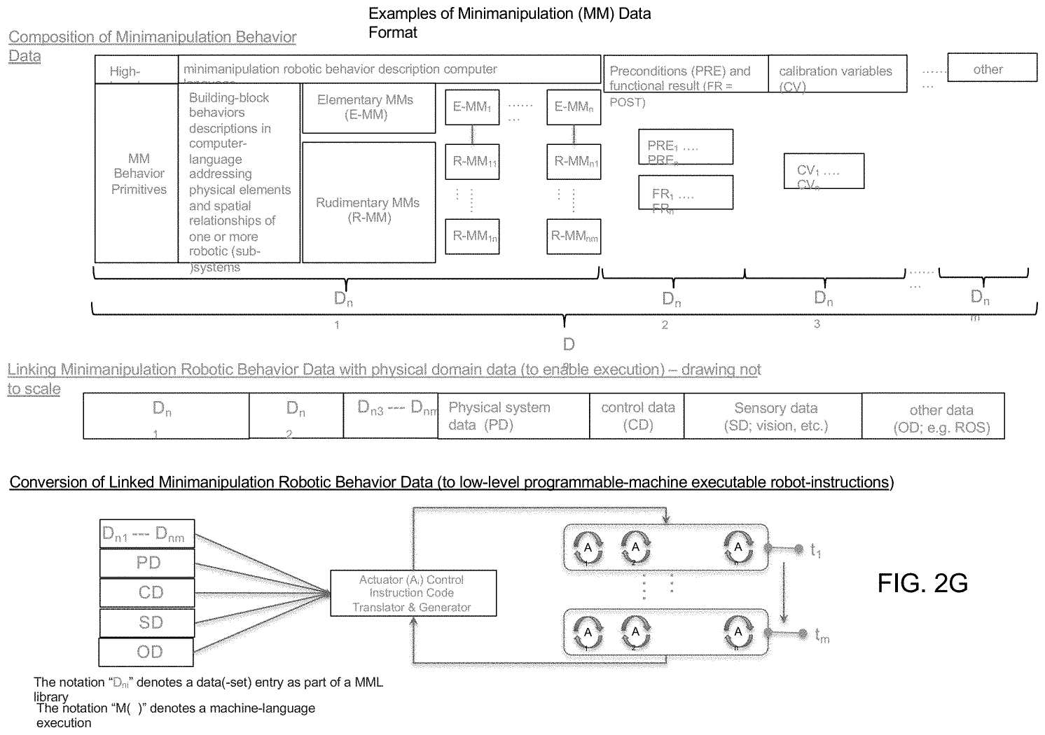

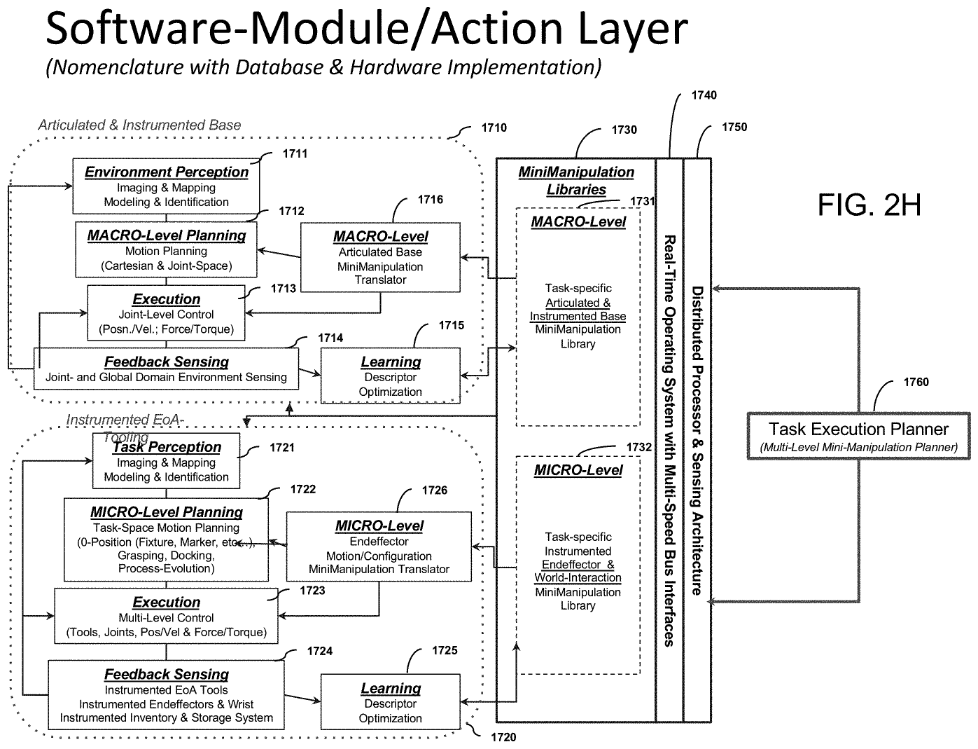

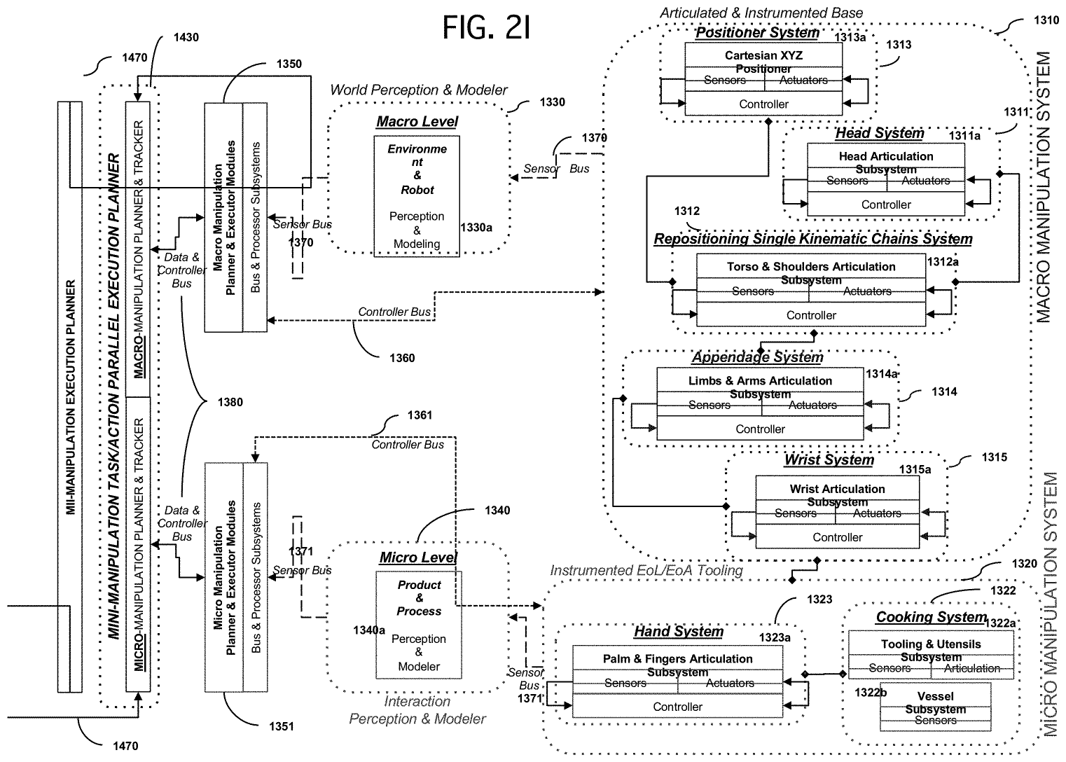

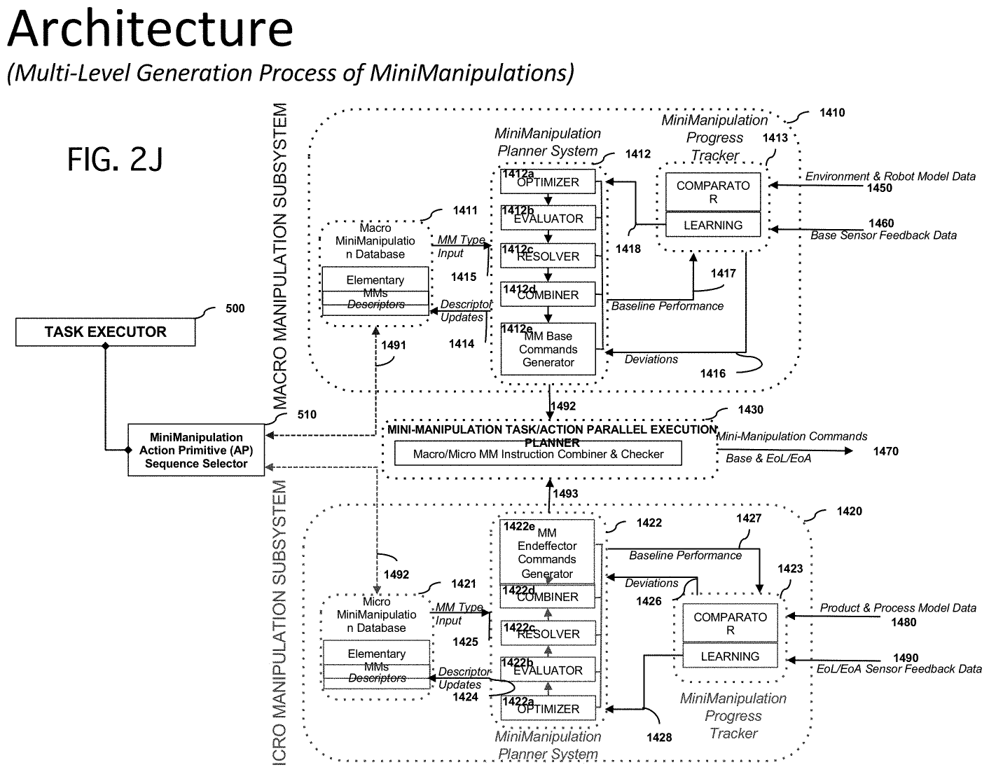

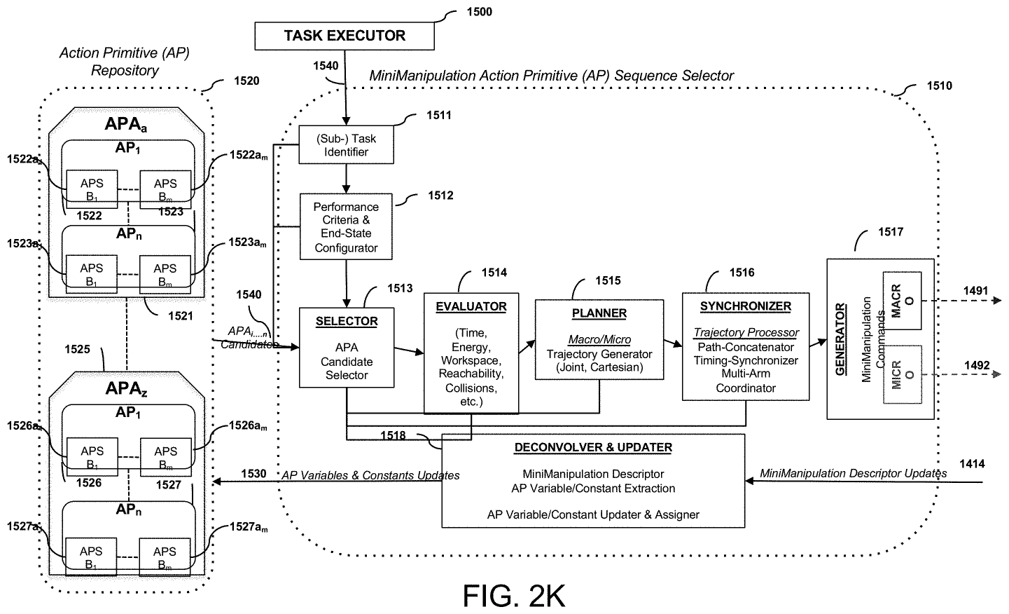

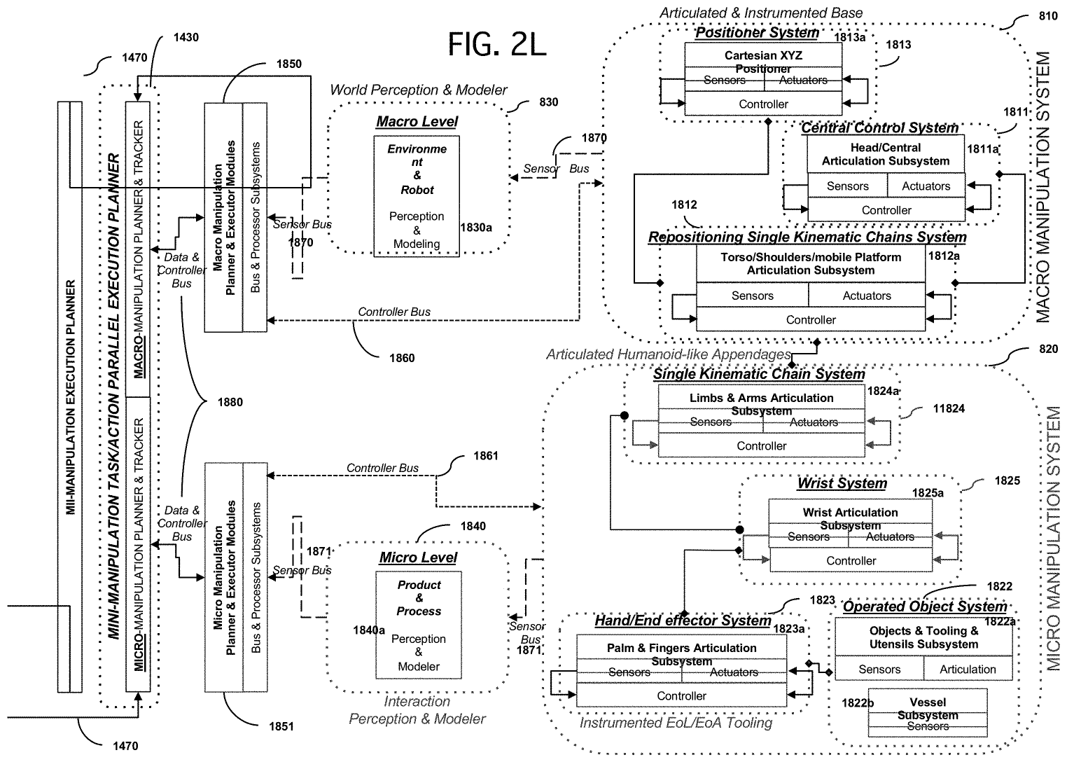

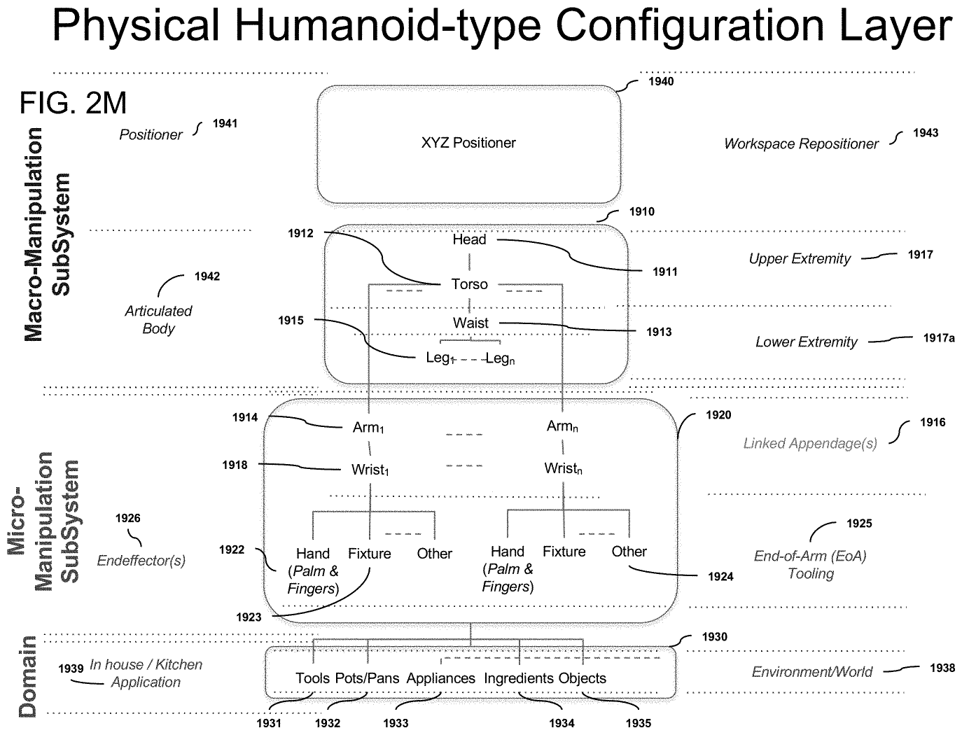

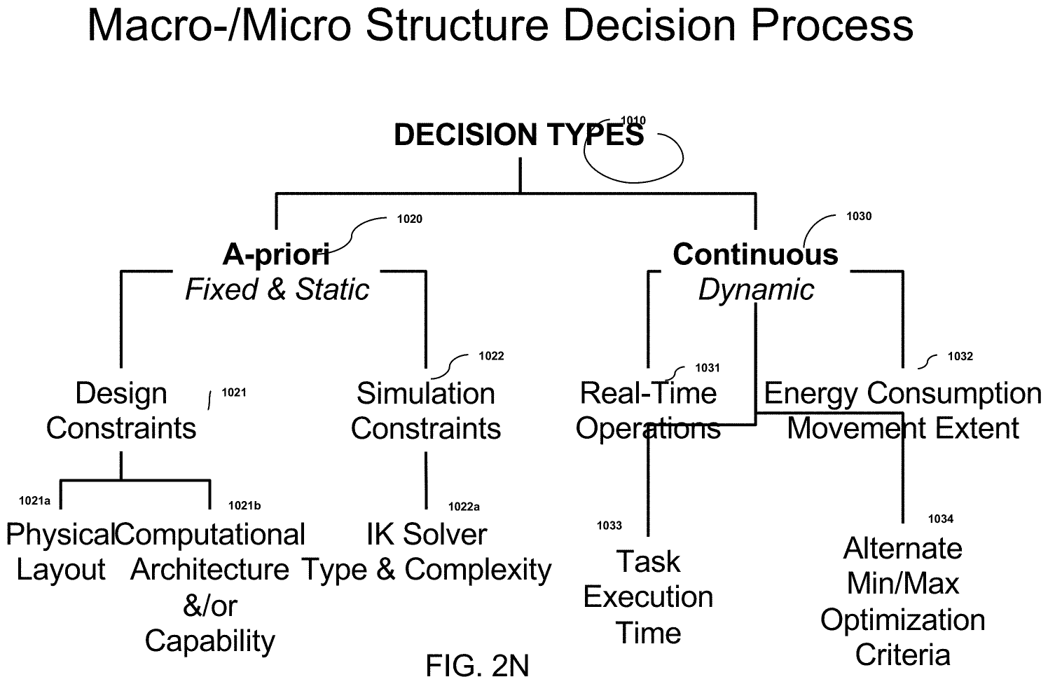

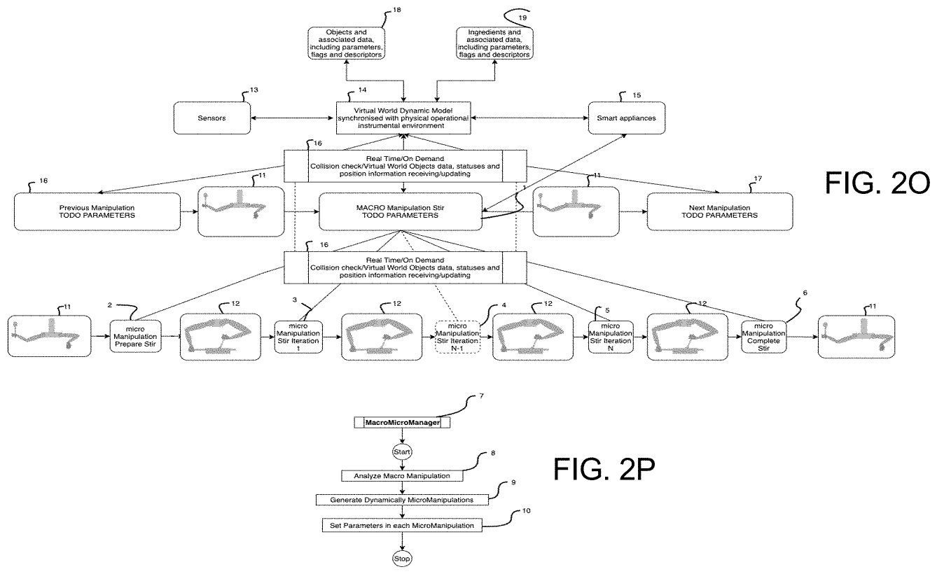

FIGS. 2A-1 to 2A-4 collectively represent one complete flow diagram illustrating a process for different modes of operations, including a robot mode, a collaborative mode and a user mode, in a robotic kitchen. FIG. 2A-1 is a system diagram illustrating initial robotic kitchen operation sequences while entering different robot modes. The system is triggered when user starts the operation when user commands the execution 1000. The system acquires data about execution recipe, understands all parameters, tools, equipment required to execute the recipe 1001. The system gathers the information about current state of the kitchen, it is able to compare with the requirements 1002. Tools, ingredients required to complete the recipe needs to be inside the kitchen before start of the execution 1004. In case certain objects are not present in the system, user is guided to feed the system with the required objects 1005. The decision of the execution mode 1006 is done by the user based on his preferences, recipe can be executed in user, collaborative and robot state.

FIG. 2A-2 is a system diagram is illustrating user operating mode. After choosing user execution mode, system start real-time guidance process 1007. System is guiding the user with GUI screen or voice commands 1012 until completion of the recipe with every single step of the recipe creation process, with exact timing. This functionality is the key to perfectly prepared dish 1007. Tool storage system is interacting with the user throughout recipe execution process. The system understand positions of the tools and can pass the exact tool to the user on the exact required time 1008. This functionality makes cooking process much easier. Ingredient storage system is interacting with the user throughout recipe execution process. The system understand positions of the exact ingredient and can pass the ingredient tool to the user on the exact required time 1009. Ingredient storage system also has ability to understand many parameters of the ingredients such as, expiry date visual appearance, type, ID, amount, weight etc. Robotic kitchen has centralized control over smart appliances, user is able to interact with all appliances in kitchen, using one centralized kitchen robotic system interface. This functionality is also crucial in recipe execution process. System can for instance preheat the oven, set it to ideal temperature in the exact time along many other things, based on the recipe requirements 1010. User has ability to record his cooking execution process to create a execution library recipe from it. After recording the recipe, it can be saved, and used by the robot, human or in collaborative mode 1011. All cooking steps are have guaranteed results, robotic kitchen system has many sensors, to understand if the recipe was successful or not. This closed loop feedback system is making sure all cooking steps along the process are successful, in case they are not, system is guiding user again to execute successful operation. Quality of ingredients, readiness of the food etc. are all validated in real-time by many sensors inside the system 1013. User is guided with all recipe execution steps with feedback on each step until full recipe is finished 1014. All operations in user mode are coming together to form user operation execution library 1030. Task execution sequence is planned based on data from task prioritization module 1038.

FIG. 2A-4 is a system diagram is illustrating robot execution mode inside robotic kitchen. Robotic kitchen is planning execution sequence 1015. Based on the execution sequence it can plan exact time when tools or ingredients and tools needs to be passed to use them for recipe execution 1016. Ingredient and tool storage systems are passing the ingredients to the robot in such a manner it is easy for the robot to grasp it with its end-effector 1017. Sensory data feedback inside the system guarantees successful outcome of all operations. Making sure that grasping operations are successful and the equipment desired position is also up to the requirements 1018. As mentioned in user operating mode description, robot has ability to interface to smart cooking appliances, in this case, the system controls the cooking process with all its parameters fully autonomous 1019. All operations in the recipes are coming together to minimanupulation execution library 1020. Task execution sequence is planned based on data from task prioritization module 1038.

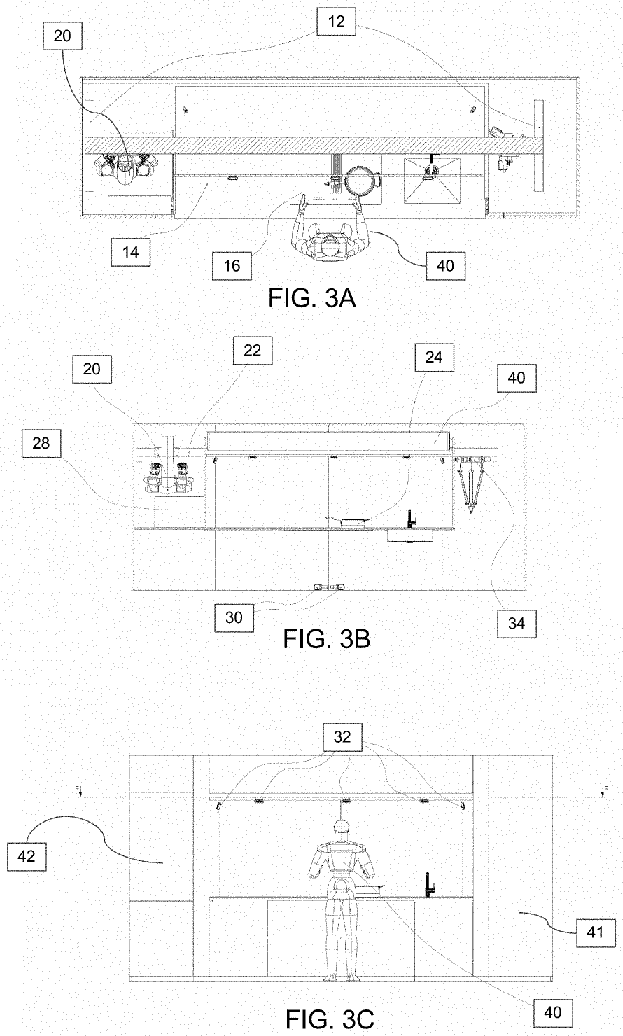

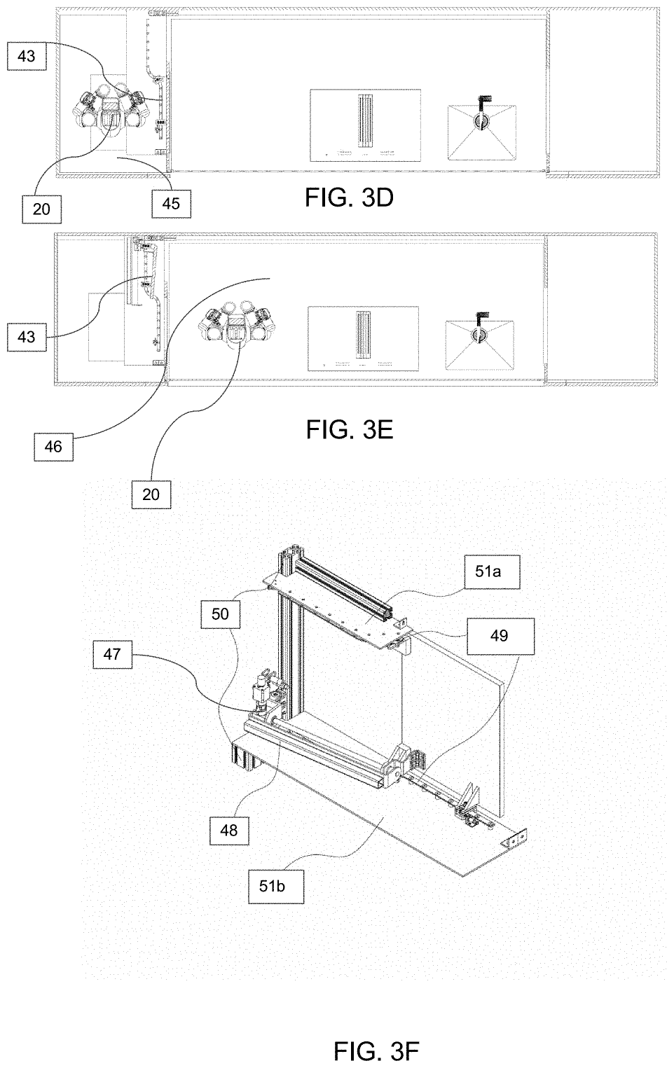

FIG. 2A-3 is a system diagram is illustrating collaborative mode execution mode inside robotic kitchen. Robotic kitchen has been designed for human and user compatibility, all subsystems and equipment inside is for both scenarios usage. Collaborative mode execution architecture is based on the current host situation. The host assignment depends on the recipe mode. In case the recipe is preprogrammed and replayed by the system, robotic kitchen is the host and it is distributing the tasks to human and to itself, in case of dynamic recipe creation by the user, user is the host, and robot follows given tasks. The most crucial factor in collaborative mode is user safety. The first step before each robot execution is analysis of sensory real-time data and risk mitigation 1035. Only when environment is safe for the user, each motion command can be enabled 1036. Recipe execution sequencer 1037 is created from merging both user 1030 and robot 1020 execution libraries, also depending on the host situation. It is distributing the tasks based on task prioritization module. Sensory data 1035 is constantly monitoring the safety for the user inside the operational environment. It is also monitoring outcome of cooking operation and makes sure it is on track. User and robot can also share single task in collaboration, for instance both chop the tomatoes.

FIG. 2B is a flow diagram illustrating robotic task-execution via one or more minimanipulation library data sets to execute recipes from an electronic library database in a collaborative mode with a safety function and as to how a remote robotic system would utilize the minimanipulation (MM) library(ies) to carry out a remote replication of a particular task (cooking, painting, etc.), which can be carried out by an expert in a studio-setting, where the expert's actions were recorded, analyzed and translated into machine-executable sets of hierarchically-structured minimanipulation datasets (commands, parameters, metrics, time-histories, etc.) which when downloaded and properly parsed, allow for a robotic system (in this case a dual-arm torso/humanoid system) to faithfully replicate the actions of the expert with sufficient fidelity to achieve substantially the same end-result as that of the expert in the studio-setting.

At a high level, this is achieved by downloading the task-descriptive libraries containing the complete set of minimanipulation datasets required by the robotic system, and providing them to a robot controller for execution. The robot controller generates the required command and motion sequences that the execution module interprets and carries out, while receiving feedback from the entire system to allow it to follow profiles established for joint and limb positions and velocities as well as (internal and external) forces and torques. A parallel performance monitoring process uses task-descriptive functional and performance metrics to track and process the robot's actions to ensure the required task-fidelity. A minimanipulation learning-and-adaptation process is allowed to take any minimanipulation parameter-set and modify it should a particular functional result not be satisfactory, to allow the robot to successfully complete each task or motion-primitive. Updated parameter data is then used to rebuild the modified minimanipulation parameter set for re-execution as well as for updating/rebuilding a particular minimanipulation routine, which is provided back to the original library routines as a modified/re-tuned library for future use by other robotic systems. The system monitors all minimanipulation steps until the final result is achieved and once completed, exits the robotic execution loop to await further commands or human input.

In specific detail the process outlined above, can be detailed as the sequences described below. The MM library 3170, containing both the generic and task-specific MM-libraries, is accessed via the MM library access manager 3171, which ensures all the required task-specific data sets 3172 required for the execution and verification of interim/end-result for a particular task are available. The data set includes at least, but is not limited to, all necessary kinematic/dynamic and control parameters, time-histories of pertinent variables, functional and performance metrics and values for performance validation and all the MM motion libraries relevant to the particular task at hand.

All task-specific datasets 3172 are fed to the robot controller 3173. A command sequencer 3174 creates the proper sequential/parallel motion sequences with an assigned index-value ‘I’, for a total of ‘i=N’ steps, feeding each sequential/parallel motion command (and data) sequence to the command executor 3175. The command executor 3175 takes each motion-sequence and in turn parses it into a set of high-to-low command signals to actuation and sensing systems, allowing the controllers for each of these systems to ensure motion-profiles with required position/velocity and force/torque profiles are correctly executed as a function of time. Sensory feedback data 3176 from the (robotic) dual-arm torso/humanoid system is used by the profile-following function to ensure actual values track desired/commanded values as close as possible.

A separate and parallel performance monitoring process 3177 measures the functional performance results at all times during the execution of each of the individual minimanipulation actions, and compares these to the performance metrics associated with each minimanipulation action and provided in the task-specific minimanipulation data set provided in 3172. Should the functional result be within acceptable tolerance limits to the required metric value(s), the robotic execution is allowed to continue, by way of incrementing the minimanipulation index value to ‘i++’, and feeding the value and returning control back to the command-sequencer process 3174, allowing the entire process to continue in a repeating loop. Should however the performance metrics differ, resulting in a discrepancy of the functional result value(s), a separate task-modifier process 3178 is enacted.

The minimanipulation task-modifier process 3178 is used to allow for the modification of parameters describing any one task-specific minimanipulation, thereby ensuring that a modification of the task-execution steps will arrive at an acceptable performance and functional result. This is achieved by taking the parameter-set from the ‘offending’ minimanipulation action-step and using one or more of multiple techniques for parameter-optimization common in the field of machine-learning, to rebuild a specific minimanipulation step or sequence MMᵢ into a revised minimanipulation step or sequence MMᵢ*. The revised step or sequence MMᵢ* is then used to rebuild a new command-0sequence that is passed back to the command executor 3175 for re-execution. The revised minimanipulation step or sequence MMᵢ* is then fed to a re-build function that re-assembles the final version of the minimanipulation dataset, that led to the successful achievement of the required functional result, so it may be passed to the task- and parameter monitoring process 3179.

The task- and parameter monitoring process 3179 is responsible for checking for both the successful completion of each minimanipulation step or sequence, as well as the final/proper minimanipulation dataset considered responsible for achieving the required performance-levels and functional result. As long as the task execution is not completed, control is passed back to the command sequencer 3174. Once the entire sequences have been successfully executed, implying ‘i=N’, the process exits (and presumably awaits further commands or user input. For each sequence-counter value ‘I’, the monitoring task 3179 also forwards the sum of all rebuilt minimanipulation parameter sets Σ(MMᵢ*) back to the MM library access manager 3171 to allow it to update the task-specific library(ies) in the remote MM library 3170 shown in FIG. 111. The remote library then updates its own internal task-specific minimanipulation representation [setting Σ(MM_{i,new})=Σ(MMᵢ*)], thereby making an optimized minimanipulation library available for all future robotic system usage.

The host identification 160 is responsible for identification the host in collaborative execution mode. Hosting can be done by human, in this case recipe is no preprogrammed, or can be done by CPU, in this case recipe library is preprogrammed. Host is identified by the user. This impacts further execution, because all commands will be distributed by the host.

Next stage is the Command distributor 161. The block is responsible for assigning minimanipulation to the execution party, human or the robotic system

In case of distributing the task to human user, sequence goes to command executor—human 156. In this scenario, user is performing cooking operation with robotic kitchen guidance and performance monitor 146 feedback.

In case of distributing the command to the robot program jumps into safety workspace analysis block. This block main function is to analyse the operational workspace and assess if it is safe for the robot to perform motion commands. The system is analysing if the next motion planned for the robot is intersecting in any matter with human operational workspace. In case it is not, robot is jumping straight to Command executor—robot 142, in case two workspaces are intersecting, robot is jumping into safe robot operational mode 154, in which case actuators efficiency are reduced, and safety sensory data is analyzed ever more carefully.

FIG. 2C is a block diagram illustrating a data-centric view of the robotic architecture 158 (or robotic system), with a central robotic control module contained in the central box, in order to focus on the data repositories. The central robotic control module 160 contains working memory needed by all the processes. In particular the Central Robotic Control establishes the mode of operation of the Robot, for instance whether it is observing and learning new minimanipulations, from an external teacher, or executing a task or in yet a different processing mode.

A working memory 1 162 contains all the sensor readings for a period of time until the present: a few seconds to a few hours—depending on how much physical memory, typical would be about 60 seconds. The sensor readings come from the on-board or off-board robotic sensors and may include video from cameras, ladar, sonar, force and pressure sensors (haptic), audio, and/or any other sensors. Sensor readings are implicitly or explicitly time-tagged or sequence-tagged (the latter means the order in which the sensor readings were received).

A working memory 2 164 contains all of the actuator commands generated by the Central Robotic Control and either passed to the actuators, or queued to be passed to same at a given point in time or based on a triggering event (e.g. the robot completing the previous motion). These include all the necessary parameter values (e.g. how far to move, how much force to apply, etc.).

A first database (database 1) 166 contains the library of all minimanipulations (MM) known to the robot, including for each MM, a triple <PRE, ACT, POST>, where is a set of items in the world state that must be true before the actions can take place, and result in a set of changes to the world state denoted as. In a preferred embodiment, the MMs are index by purpose, by sensors and actuators they involved, and by any other factor that facilitates access and application. In a preferred embodiment each POST result is associated with a probability of obtaining the desired result if the MM is executed. The Central Robotic Control both accesses the MM library to retrieve and execute MM's and updates it, e.g. in learning mode to add new MMs.

A second database (database 2) 168 contains the case library, each case being a sequence of minimanipulations to perform a give task, such as preparing a given dish, or fetching an item from a different room. Each case contains variables (e.g. what to fetch, how far to travel, etc.) and outcomes (e.g. whether the particular case obtained the desired result and how close to optimal—how fast, with or without side-effects etc.). The Central Robotic Control both accesses the Case Library to determine if has a known sequence of actions for a current task, and updates the Case Library with outcome information upon executing the task. If in learning mode, the Central Robotic Control adds new cases to the case library, or alternately deletes cases found to be ineffective.

A third database (database 3) 170 contains the object store, essentially what the robot knows about external objects in the world, listing the objects, their types and their properties. For instance, an knife is of type “tool” and “utensil” it is typically in a drawer or countertop, it has a certain size range, it can tolerate any gripping force, etc. An egg is of type “food”, it has a certain size range, it is typically found in the refrigerator, it can tolerate only a certain amount of force in gripping without breaking, etc. The object information is queried while forming new robotic action plans, to determine properties of objects, to recognize objects, and so on. The object store can also be updated when new objects introduce and it can update its information about existing objects and their parameters or parameter ranges.

A fourth database (database 4) contains information about the user interaction with the robot system. Data about safe operational space while the user is present in certain operational cooking zone, how robot has to behave around user in certain listed scenarios velocity data, acceleration data, maximum safe operational space volume data, tools that are allowed to operate by the robot in collaborative mode, potential hazardous situations that robot has to avoid or mitigate while operating in collaborative mode, operational restrictions is collaborative mode, collaborative mode environmental parameters, smart appliances data, safety sensory data (environment scanners, zoning sensors, vision system along more sensors). Essentially, all information about the environment and operations that are potential hazard for the user are cross checked with the sensory data from the system, hazard mitigation libraries. Robotic systems can make operational parameters decisions based on this data. For instance, limit the velocities while the user is in a certain position in the kitchen regarding the robot. Prevent from using certain tools or perform certain hazardous operations while the user is in a certain position in the kitchen (using a knife, moving a pot with hot water along other potential hazardous situations in the kitchen environment. It is storing libraries for interaction with the user, for instance it can ask the user to perform certain tasks, move out of the environment for certain time if required by a safety mitigation library etc.

A fifth database (database 4) 174 contains information about the environment in which the robot is operating, including the location of the robot, the extent of the environment (e.g. the rooms in a house), their physical layout, and the locations and quantities of specific objects within that environment. Database 4 is queried whenever the robot needs to update object parameters (e.g. locations, orientations), or needs to navigate within the environment. It is updated frequently, as objects are moved, consumed, or new objects brought in from the outside (e.g. when the human returns form the store or supermarket).

FIG. 2D depicts a dual-arm torso humanoid robot system 176 as a set of manipulation function phases associated with any manipulation activity, regardless of the task to be accomplished, for MM library manipulation-phase combinations and transitions for task-specific action-sequences 176.

Hence in order to build an ever more complex and higher level set of minimanipulation (MM) motion-primitive routines form a set of generic sub-routines, a high-level minimanipulation (MM) can be thought of as a transition between various phases of any manipulation, thereby allowing for a simple concatenation of minimanipulation (MM) sub-routines to develop a higher-level minimanipulation routine (motion-primitive). Note that each phase of a manipulation (approach, grasp, maneuver, etc.) is itself its own low-level minimanipulation described by a set of parameters involved in controlling motions and forces/torques (internal, external as well as interface variables) involving one or more of the physical domain entities [finger(s), palm, wrist, limbs, joints (elbow, shoulder, etc.), torso, etc.].

Arm 1 180 of a dual-arm system, can be thought of as using external and internal sensors, to achieve a particular location 180 of the end effector, with a given configuration 182 prior to approaching a particular target (tool, utensil, surface, etc.), using interface-sensors to guide the system during the approach-phase 184, and during any grasping-phase 188 (if required); a subsequent handling-/maneuvering-phase 190 allows for the end effector to wield an instrument in it grasp (to stir, draw, etc.). The same description applies to an Arm 2 192, which could perform similar actions and sequences.

Note that should a minimanipulation (MM) sub-routine action fail (such as needing to re-grasp), all the minimanipulation sequencer has to do is to jump back backwards to a prior phase and repeat the same actions (possibly with a modified set of parameters to ensure success, if needed). More complex sets of actions, such playing a sequence of piano-keys with different fingers, involves a repetitive jumping-loops between the Approach 184, 186 and the Contact 186, 200 phases, allowing for different keys to be struck in different intervals and with different effect (soft/hard, short/long, etc.); moving to different octaves on the piano key-scale would simply require a phase-backwards to the configuration-phase 182 to reposition the arm, or possibly even the entire torso 3140 through translation and/or rotation to achieve a different arm and torso orientation 208.

Arm 2 192 could perform similar activities in parallel and independent of Arm 178, or in conjunction and coordination with Arm 178 and Torso 206, guided by the movement-coordination phase (such as during the motions of arms and torso of a conductor wielding a baton), and/or the contact and interaction control phase 208, such as during the actions of dual-arm kneading of dough on a table.

Minimanipulations (MM) ranging from the lowest-level sub-routine to the more higher level motion-primitives or more complex minimanipulation (MM) motions and abstraction sequences, can be generated from a set of different motions associated with a particular phase which in turn have a clear and well-defined parameter-set (to measure, control and optimize through learning). Smaller parameter-sets allow for easier debugging and sub-routines that be guaranteed to work, allowing for a higher-level MM routines to be based completely on well-defined and successful lower-level MM sub-routines.

Notice that coupling a minimanipulation (sub-) routine to a not only a set of parameters required to be monitored and controlled during a particular phase of a task-motion, but also associated further with a particular physical (set of) units, allows for a very powerful set of representations to allow for intuitive minimanipulation (MM) motion-primitives to be generated and compiled into a set of generic and task-specific minimanipulation (MM) motion/action libraries.

FIG. 2E depicts a flow diagram illustrating the process 214 of minimanipulation Library(ies) generation, for both generic and task-specific motion-primitives as part of the studio-data generation, collection and analysis process. This figure depicts how sensory-data is processed through a set of software engines to create a set of minimanipulation libraries containing datasets with parameter-values, time-histories, command-sequences, performance-measures and—metrics, etc. to ensure low- and higher-level minimanipulation motion primitives result in a successful completion of low-to-complex remote robotic task-executions.

In a more detailed view, it is shown how sensory data is filtered and input into a sequence of processing engines to arrive at a set of generic and task-specific minimanipulation motion primitive libraries. The processing of the sensory data 218 involves its filtering-step 216 and grouping it through an association engine 220, where the data is associated with the physical system elements as well as manipulation-phases, potentially even allowing for user input 222, after which they are processed through two MM software engines.

The MM data-processing and structuring engine 224 creates an interim library of motion-primitives based on identification of motion-sequences 224-1, segmented groupings of manipulation steps 224-2 and then an abstraction-step 224-3 of the same into a dataset of parameter-values for each minimanipulation step, where motion-primitives are associated with a set of pre-defined low- to high-level action-primitives 224-5 and stored in an interim library 224-4. As an example, process 224-1 might identify a motion-sequence through a dataset that indicates object-grasping and repetitive back-and-forth motion related to a studio-chef grabbing a knife and proceeding to cut a food item into slices. The motion-sequence is then broken down in 224-2 into associated actions of several physical elements (fingers and limbs/joints) with a set of transitions between multiple manipulation phases for one or more arm(s) and torso (such as controlling the fingers to grasp the knife, orienting it properly, translating arms and hands to line up the knife for the cut, controlling contact and associated forces during cutting along a cut-plane, re-setting the knife to the beginning of the cut along a free-space trajectory and then repeating the contact/force-control/trajectory-following process of cutting the food-item indexed for achieving a different slice width/angle). The parameters associated with each portion of the manipulation-phase are then extracted and assigned numerical values in 224-3, and associated with a particular action-primitive offered by 224-5 with mnemonic descriptors such as ‘grab’, ‘align utensil’, ‘cut’, ‘index-over’, etc.

The interim library data 224-4 is fed into a learning-and-tuning engine 226, where data from other multiple studio-sessions 270 is used to extract similar minimanipulation actions and their outcomes 226-1 and comparing their data sets 226-2, allowing for parameter-tuning 226-3 within each minimanipulation group using one or more of standard machine-learning/-parameter-tuning techniques in an iterative fashion 3166-5. A further level-structuring process 226-4 decides on breaking the minimanipulation motion-primitives into generic low-level sub-routines and higher-level minimanipulations made up of a sequence (serial and parallel combinations) of sub-routine action-primitives.

A following library builder 268 then organizes all generic minimanipulation routines into a set of generic multi-level minimanipulation action-primitives with all associated data (commands, parameter-sets and expected/required performance metrics) as part of a single generic minimanipulation library 268-2. A separate and distinct library is then also built as a task-specific library 268-1 that allows for assigning any sequence of generic minimanipulation action-primitives to a specific task (cooking, painting, etc.), allowing for the inclusion of task-specific datasets which only pertain to the task (such as kitchen data and parameters, instrument-specific parameters, etc.) which are required to replicate the studio-performance by a remote robotic system.

A separate MM library access manager 272 is responsible for checking-out proper libraries and their associated datasets (parameters, time-histories, performance metrics, etc.) 272-1 to pass onto a remote robotic replication system, as well as checking back in updated minimanipulation motion primitives (parameters, performance metrics, etc.) 272-2 based on learned and optimized minimanipulation executions by one or more same/different remote robotic systems. This ensures the library continually grows and is optimized by a growing number of remote robotic execution platforms.

FIG. 2F depicts a block diagram illustrating an automated minimanipulation parameter-set building engine 274 for a minimanipulation task-motion primitive associated with a particular task. It provides a graphical representation of how the process of building (a) (sub-) routine for a particular minimanipulation of a particular task is accomplished based on using the physical system groupings and different manipulation-phases, where a higher-level minimanipulation routine can be built up using multiple low-level minimanipulation primitives (essentially sub-routines comprised of small and simple motions and closed-loop controlled actions) such as grasp, grasp the tool, etc. This process results in a sequence (basically task- and time-indexed matrices) of parameter values stored in multi-dimensional vectors (arrays) that are applied in a stepwise fashion based on sequences of simple maneuvers and steps/actions. In essence this figure depicts an example for the generation of a sequence of minimanipulation actions and their associated parameters, reflective of the actions encapsulated in the MM Library Processing & Structuring Engine 214 from FIG. 2E.

The example depicted in FIG. 2F shows a portion of how a software engine proceeds to analyze sensory-data to extract multiple steps from a particular studio data set. In this case it is the process of grabbing a utensil (a knife for instance) and proceeding to a cutting-station to grab or hold a particular food-item (such as a loaf of bread) and aligning the knife to proceed with cutting (slices). The system focuses on Arm 1 in Step 1., which involves the grabbing of a utensil (knife), by configuring the hand for grabbing (1.a.), approaching the utensil in a holder or on a surface (1.b.), performing a pre-determined set of grasping-motions (including contact-detection and—force control not shown but incorporated in the GRASP minimanipulation step 1.c.) to acquire the utensil and then move the hand in free-space to properly align the hand/wrist for cutting operations. The system thereby is able to populate the parameter-vectors (1 thru 5) for later robotic control. The system returns to the next step that involves the torso in Step 2., which comprises a sequence of lower-level minimanipulations to face the work (cutting) surface (2.a.), align the dual-arm system (2.b.) and return for the next step (2.c.). In the next Step 3., the Arm2 (the one not holding the utensil/knife), is commanded to align its hand (3.a.) for a larger-object grasp, approach the food item (3.b.; involves possibly moving all limbs and joints and wrist; 3.c.), and then move until contact is made (3.c.) and then push to hold the item with sufficient force (3.d.), prior to aligning the utensil (3.f.) to allow for cutting operations after a return (3.g.) and proceeding to the next step(s) (4. and so on).

The above example illustrates the process of building a minimanipulation routine based on simple sub-routine motions (themselves also minimanipulations) using both a physical entity mapping and a manipulation-phase approach which the computer can readily distinguish and parameterize using external/internal/interface sensory feedback data from the studio-recording process. This minimanipulation library building-process for process-parameters generates ‘parameter-vectors’ which fully describe a (set of) successful minimanipulation action(s), as the parameter vectors include sensory-data, time-histories for key variables as well as performance data and metrics, allowing a remote robotic replication system to faithfully execute the required task(s). The process is also generic in that it is agnostic to the task at hand (cooking, painting, etc.), as it simply builds minimanipulation actions based on a set of generic motion- and action-primitives. Simple user input and other pre-determined action-primitive descriptors can be added at any level to more generically describe a particular motion-sequence and to allow it to be made generic for future use, or task-specific for a particular application. Having minimanipulation datasets comprised of parameter vectors, also allows for continuous optimization through learning, where adaptions to parameters are possible to improve the fidelity of a particular minimanipulation based on field-data generated during robotic replication operations involving the application (and evaluation) of minimanipulation routines in one or more generic and/or task-specific libraries.

FIG. 2G is a block diagram illustrating examples of various minimanipulation data formats in the composition, linking and conversion of minimanipulation robotic behavior data. In composition, high-level MM behavior descriptions in a dedicated/abstraction computer programming language are based on the use of elementary MM primitives which themselves may be described by even more rudimentary MM in order to allow for building behaviors from ever-more complex behaviors.

An example of a very rudimentary behavior might be ‘finger-curl’, with a motion primitive related to ‘grasp’ that has all 5 fingers curl around an object, with a high-level behavior termed ‘fetch utensil’ that would involve arm movements to the respective location and then grasping the utensil with all five fingers. Each of the elementary behaviors (incl. the more rudimentary ones as well) have a correlated functional result and associated calibration variables describing and controlling each.

Linking allows for behavioral data to be linked with the physical world data, which includes data related to the physical system (robot parameters and environmental geometry, etc.), the controller (type and gains/parameters) used to effect movements, as well as the sensory-data (vision, dynamic/static measures, etc.) needed for monitoring and control, as well as other software-loop execution-related processes (communications, error-handling, etc.).

Conversion takes all linked MM data, from one or more databases, and by way of a software engine, termed the Actuator Control Instruction Code Translator & Generator, thereby creating machine-executable (low-level) instruction code for each actuator (A₁ thru Aₙ) controller (which themselves run a high-bandwidth control loop in position/velocity and/or force/torque) for each time-period (t₁ thru tₘ), allowing for the robot system to execute commanded instruction in a continuous set of nested loops.

FIG. 2H depicts a logical diagram of main action blocks in the software-module/action layer within the macro-manipulation and micro-manipulation subsystems and the associated minimanipulation libraries dedicated to each. The architecture of the software-module/action layer provides a framework that allows the inclusion of: (1) refined End effector sensing (for refined and more accurate real-world interface sensing); (2) introduction of the macro- (overall sensing by and from the articulated base) and micro- (local task-specific sensing between the end effectors and the task-/cooking-specific elements) tiers to allow continuous minimanipulation libraries to be used and updated (via learning) based on a physical split between coarse and fine manipulation (and thus positioning, force/torque control, product-handling and process monitoring); (3) distributed multi-processor architecture at the macro- and micro-levels; (4) introduction of the “0-Position” concept for handling any environment elements (tools, appliances, pans, etc.); (5) use of aids such as fixturing-elements and markers (structured targets, template-matching, virtual markers, RFID/IR/NFC markers, etc.) to increase speed and fidelity of docking/handling and improve minimanipulations; and (6) electronic inventorying system for tools and pots/pans as well as Utensil/Container/Ingredient storage and access.

The macro-/micro-distinctions provide differentiations on the types of minimanipulation libraries and their relative descriptors and improved and higher-fidelity learning results based on more localized and higher-accuracy sensory elements contained within the end effectors, rather than relying on sensors that are typically part of (and mounted on) the articulated base (for larger FoV, but thereby also lower resolution and fidelity when it comes to monitoring finer movements at the “product-interface” (where the cooking tasks mostly take place when it comes to decision-making).

The overall structure in FIG. 2H illustrates (a) using sensing elements to image/map the surroundings and then (b) create motion-plans based on primitives stored in minimanipulation libraries which are (c) translated into actionable (machine-executable) joint-/actuator-level commands (of position/velocity and/or force/torque), with (d) a feedback loop of sensors used to monitor and proceed in the assigned task, while (e) also learning from its execution-state to improve existing minimanipulation descriptors and thus the associated libraries. The elaboration on having macro- and micro-level actions based on macro- and micro-level sensory systems, at the articulated base and end effectors, respectively. The sensory systems then perform identical functions, but create and optimize descriptors and minimanipulations in separate minimanipulation databases, which are all merged into a single database that the respective systems draw from.

The macro-/micro-level split also allows: (1) presence and integration of sensing systems at the macro (base) and micro (end effector) levels (not to speak of the varied sensory elements one could list, such as cameras, lasers, haptics, any EM-spectrum based elements, etc.); (2) application of varied learning techniques at the macro- and micro levels to apply to different minimanipulation libraries suitable to different levels of manipulation (such as coarser movements and posturing of the articulated base using macro-minimanipulation databases, and finer and higher-fidelity configurations and interaction forces/torques of the respective end effectors using micro-minimanipulation databases), and each thus with descriptors and sensors better suited to execute/monitor/optimize said descriptors and their respective databases; (3) need and application of distributed and embedded processors and sensory architecture, as well as the real-time operating system and multi-speed buses and storage elements; (4) use of the “0-Position” method, whether aided by markers or fixtures, to aid in acquiring and handling (reliably and accurately) any needed tool or appliance/pot/pan or other elements; and (5) interfacing of an instrumented inventory system (for tools, ingredients, etc.) and a smart Utensil/Container/Ingredient storage system.

A multi-level robotic operational system, in this case one of a two-level macro- and micro-manipulation subsystem, comprising of a macro-level articulated and instrumented large workspace coarse-motion articulated and instrumented base 1710, connected to a micro-level fine-motion high-fidelity environment interaction instrumented EoA-tooling subsystem 1720, allows for position and velocity motion planners to provide task-specific motion commands through minimanipulation libraries 1730 at both the macro- and micro-levels (1731 and 1732, respectively). The ability to share feedback data and send and receive motion commands is only possible through the use of a distributed processor and sensing architecture 1750, implemented via a (distributed) real-time operating system interacting over multiple varied-speed bus interfaces 1740, taking in high-level task-execution commands from a high-level planner 1760, which are in turn broken down into separate yet coordinated trajectories for both the macro and micro manipulation subsystems.

The macro-manipulation subsystem instantiated by an instrumented articulated and controller-actuated articulated instrumented base 1710 requires a multi-element linked set of operational blocks 1711 thru 1716 to function properly. Said operational blocks rely on a separate and distinct set of processing and communication bus hardware responsible for the macro-level sensing and control tasks at the macro-level. In a typical macro-level subsystem said operational blocks require the presence of a macro-level command translator 1716, that takes in minimanipulation commands from a library 730 and its macro-level minimanipulation sublibrary 1731, and generates a set of properly sequenced machine-readable commands to a macro-level planning module 1712, where the motions required for each of the instrumented and actuated elements are calculated in at least the joint- and Cartesian-space. Said motion commands are sequentially fed to an execution block 1713, which controls all instrumented articulated and actuated joints in at least joint- or Cartesian space to ensure the movements track the commanded trajectories in position/velocity and/or torque/force. A feedback sensing block 1714 provides feedback data from all sensors to the execution block 1713 as well as an environment perception block/module 1711 for further processing. Feedback is not only provided to allow tracking the internal state of variables, but also sensory data from sensor measuring the surrounding environment and geometries. Feedback data from said module 1714 is used by the execution module 1713 to ensure actual values track their commanded setpoints, as well as an environment perception module 1711 to image and map, model and identify the state of each articulated element, the overall configuration of the robot as well as the state of the surrounding environment the robot is operating in. Additionally, said feedback data is also provided to a learning module 1715 responsible for tracking the overall performance of the system and comparing it to known required performance metrics, allowing one or more learning methods to develop a continuously updated set of descriptors that define all minimanipulations contained within their respective minimanipulation library 730, in this case the macro-level minimanipulation sublibrary 1731.

In the case of the micro-manipulation system instantiated by an instrumented articulated and controller-actuated articulated instrumented EoA-tooling subsystem 1720, the logical operational blocks described above are similar except that operations are targeted and executed only for those elements that form part of the micro-manipulation subsystem 620. Said instrumented articulated and controller-actuated articulated instrumented EoA-tooling subsystem 1720, requires a multi-element linked set of operational blocks 1721 thru 1726 to function properly. Said operational blocks rely on a separate and distinct set of processing and communication bus hardware responsible for the micro-level sensing and control tasks at the micro-level. In a typical micro-level subsystem said operational blocks require the presence of a micro-level command translator 1726, that takes in minimanipulation commands from a library 1730 and its micro-level minimanipulation sublibrary 1732, and generates a set of properly sequenced machine-readable commands to a micro-level planning module 1722, where the motions required for each of the instrumented and actuated elements are calculated in at least the joint- and Cartesian-space. Said motion commands are sequentially fed to an execution block 1723, which controls all instrumented articulated and actuated joints in at least joint- or Cartesian space to ensure the movements track the commanded trajectories in position/velocity and/or torque/force. A feedback-sensing block 1724 provides feedback data from all sensors to the execution block 1723 as well as a task perception block/module 1721 for further processing. Feedback is not only provided to allow tracking the internal state of variables, but also sensory data from sensors measuring the immediate EoA configuration/geometry as well as the measured process and product variables such as contact force, friction, interaction product sate, etc. Feedback data from said module 1724 is used by the execution module 1723 to ensure actual values track their commanded setpoints, as well as a task perception module 1721 to image and map, model and identify the state of each articulated element, the overall configuration of the EoA-tooling as well as the type and state of the environment interaction variables the robot is operating in, as well as the particular variables of interest of the element/product being interacted with (as an example a paintbrush bristle width during painting or a the consistency and of egg whites being beaten or the cooking-state of a fried egg). Additionally, said feedback data is also provided to a learning module 1725 responsible for tracking the overall performance of the system and comparing it to known required performance metrics for each task and its associated minimanipulation commands, allowing one or more learning methods to develop a continuously updated set of descriptors that define all minimanipulations contained within their respective minimanipulation library 730, in this case the micro-level minimanipulation sublibrary 1732.

FIG. 2I depicts a block diagram illustrating the macro-manipulation and micro-manipulation physical subsystems and their associated sensors, actuators and controllers with their interconnections to their respective high-level and subsystem planners and controllers as well as world and interaction perception and modelling systems for minimanipulation planning and execution process. The hardware systems innate within each the macro- and micro-manipulation subsystems are reflected at both the macro-manipulation subsystem level through the instrumented articulated and controller-actuated articulated base 1310, and the micro-manipulation level through the instrumented articulated and controller-actuated end-of-arm (EoA) tooling 1320 subsystems. Both are connected to their perception and modelling systems 1330 and 1340, respectively.

In the case of the macro-manipulation subsystem 1310, a connection is made to the world perception and modelling subsystem 1330 through a dedicated sensor bus 1370, with the sensors associated with said subsystem responsible for sensing, modelling and identifying the world around the entire robot system and the latter itself, within said world. The raw and processed macro-manipulation subsystem sensor data is then forwarded over the same sensor bus 1370 to the macro-manipulation planning and execution module 1350, where a set of separate processors are responsible for executing task-commands received from the task minimanipulation parallel task execution planner 1430, which in turn receives its task commands from the high-level minimanipulation planner 1470 over a data and controller bus 1380, and controlling the macro-manipulation subsystem 1310 to complete said tasks based on the feedback it receives from the world perception and modelling module 1330, by sending commands over a dedicated controller bus 1360. Commands received through this controller bus 1360, are executed by each of the respective hardware modules within the articulated and instrumented base subsystem 1310, including the positioner system 1313, the repositioning single kinematic chain system 1312, to which are attached the head system 1311 as well as the appendage system 1314 and the thereto attached wrist system 1315.

The positioner system 1313 reacts to repositioning movement commands to its Cartesian XYZ positioner 1313a, where an integral and dedicated processor-based controller executes said commands by controlling actuators in a high-speed closed loop based on feedback data from its integral sensors, allowing for the repositioning of the entire robotic system to the required workspace location. The repositioning single kinematic chain system 1312 attached to the positioner system 1313, with the appendage system 1314 attached to the repositioning single kinematic chain system 1312 and the wrist system 1315 attached to the ends of the arms articulation system 1314a, uses the same architecture described above, where each of their articulation subsystems 1312a, 1314a and 1315a, receive separate commands to their respective dedicated processor-based controllers to command their respective actuators and ensure proper command-following through monitoring built-in integral sensors to ensure tracking fidelity. The head system 1311 receives movement commands to the head articulation subsystem 311a, where an integral and dedicated processor-based controller executes said commands by controlling actuators in a high-speed closed loop based on feedback data from its integral sensors.

The architecture is similar for the micro-manipulation subsystem. The micro-manipulation subsystem 1320, communicates with the product and process modelling subsystem 1340 through a dedicated sensor bus 1371, with the sensors associated with said subsystem responsible for sensing, modelling and identifying the immediate vicinity at the EoA, including the process of interaction and the state and progression of any product being handled or manipulated. The raw and processed micro-manipulation subsystem sensor data is then forwarded over its own sensor bus 1371 to the micro-manipulation planning and execution module 351, where a set of separate processors are responsible for executing task-commands received from the minimanipulation parallel task execution planner 1430, which in turn receives its task commands from the high-level minimanipulation planner 1470 over a data and controller bus 1380, and controlling the micro-manipulation subsystem 11320 to complete said tasks based on the feedback it receives from the product and process perception and modelling module 340, by sending commands over a dedicated controller bus 1361. Commands received through this controller bus 1361, are executed by each of the respective hardware modules within the instrumented EoA tooling subsystem 1320, including the hand system 1323 and the cooking-system 1322. The hand system 1323 receives movement commands to its palm and fingers articulation subsystem 1323a with its respective dedicated processor-based controllers commanding their respective actuators to ensure proper command-following through monitoring built-in integral sensors to ensure tracking fidelity. The cooking system 1322, which encompasses specialized tooling and utensils 1322a (which may be completely passive and devoid of any sensors or actuators or contain simply sensing elements without any actuation elements), is responsible for executing commands addressed to it, through a similar dedicated processor-based controller executing a high-speed control-loop based on sensor-feedback, by sending motion commands to its integral actuators. Furthermore, a vessel subsystem 1322b representing containers and processing pots/pans, which may be instrumented through built-in dedicated sensors for various purposes, can also be controlled over a common bus spanning between the hand system 1323 and the cooking system 1322.

FIG. 2J depicts a block diagram illustrating one embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems.

A high-level task executor 1500 provides a task description to the minimanipulation sequence selector 1510, that selects candidate action-primitives (elemental motions and controls) separately to the separate macro- and micro-manipulation subsystems 1410 and 1420 respectively, where said components are processed to yield a separate stack of commands to the minimanipulation parallel task execution planner 1430 that combines and checks them for proper functionality and synchronicity through simulation, and then forwards them to each of the respective macro- and micro-manipulation planner and executor modules 1350 and 1351, respectively.

In the case of the macro-manipulation subsystem, input data used to generate the respective minimanipulation command stack sequence, includes raw and processed sensor feedback data 460 from the instrumented base, environment perception and modelling data 1450 from the world perception modeller 1330. The incoming minimanipulation component candidates 1491 are provided to the macro minimanipulation database 1411 with its respective integral descriptors, which organizes them by type and sequence 1415, before they are processed further by its dedicated minimanipulation planner 1412; additional input to said database 1411 occurs by way of minimanipulation candidate descriptor updates 1414 provided by a separate learning process described later. Said macro manipulation subsystem planner 1412 also receives input from the minimanipulation progress tracker 1413, which is responsible to provide progress information on task execution variables and status, as well as observed deviations, to said planning system 1412. The progress tracker 1413 carries out its tracking process by comparing inputs comprising of the required baseline performance 1417 for each task-execution element with sensory feedback data 1460 (raw & processed) from the instrumented base as well as environment perception and modelling data 1450 in a comparator, which generates deviation data 1416 and process improvement data 1418 comprising of performance increases through descriptor variable and constant modifications developed by an integral learning system, back to the planner system 1412.

The minimanipulation planner system 1412 takes in all these input data streams 1416, 1418 and 415, and performs a series of steps on this data, in order to arrive at a set of sequential command stacks for task execution commands 1492 developed for the macro-manipulation subsystem, which are fed to the minimanipulation parallel task execution planner 1430 for additional checking and combining before being converted into machine-readable minimanipulation commands 1470 provided to each macro- and micro-manipulation subsystem separately for execution. The minimanipulation planner system 1412 generates said command sequence 1492, through a set of steps, including but not limited to nor necessarily in this sequence but also with possible internal looping, passing the data through: (i) an optimizer to remove any redundant or overlapping task-execution timelines, (ii) a feasibility evaluator to verify that each sub-task is completed according a to a given set of metrics associated with each subtask, before proceeding to the next subtask, (iii) a resolver to ensure no gaps in execution-time or task-steps exist, and finally (iv) a combiner to verify proper task execution order and end-result, prior to forwarding all command arguments to (v) the minimanipulation command generator that maps them to the physical configuration of the macro-manipulation subsystem hardware.

The process is similar for the generation of the command-stack sequence of the minimanipulation subsystem 1420, with a few notable differences identified in the description below. As above, input data used to generate the respective minimanipulation command stack sequence for the micro-manipulation subsystem, includes raw and processed sensor feedback data 1490 from the EoA tooling, product process and modelling data 1480 from the interaction perception modeller 340. The incoming minimanipulation component candidates 1492 are provided to the micro minimanipulation database 1421 with its respective integral descriptors, which organizes them by type and sequence 1425, before they are processed further by its dedicated minimanipulation planner 1422; additional input to said database 1421 occurs by way of minimanipulation candidate descriptor updates 1424 provided by a separate learning process described previously and again below. Said micro manipulation subsystem planner 1422 also receives input from the minimanipulation progress tracker 1423, which is responsible to provide progress information on task execution variables and status, as well as observed deviations, to said planning system 1422. The progress tracker 1423 carries out its tracking process by comparing inputs comprising of the required baseline performance 1427 for each task-execution element with sensory feedback data 1490 (raw & processed) from the instrumented EoA-tooling as well as product and process perception and modelling data 1480 in a comparator, which generates deviation data 1426 and process improvement data 1428 comprising of performance increases through descriptor variable and constant modifications, developed by an integral learning system, back to the planner system 1422.

The minimanipulation planner system 1422 takes in all these input data streams 1426, 1428 and 1425, and performs a series of steps on this data, in order to arrive at a set of sequential command stacks for task execution commands 1493 developed for the micro-manipulation subsystem, which are fed to the minimanipulation parallel task execution planner 1430 for additional checking and combining before being converted into machine-readable minimanipulation commands 1470 provided to each macro- and micro-manipulation subsystem separately for execution. AS for the macro-manipulation subsystem planning process outlined for 1412 before, the minimanipulation planner system 11422 generates said command sequence 1493, through a set of steps, including but not limited to nor necessarily in this sequence but also with possible internal looping, passing the data through: (i) an optimizer to remove any redundant or overlapping task-execution timelines, (ii) a feasibility evaluator to verify that each sub-task is completed according a to a given set of metrics associated with each subtask, before proceeding to the next subtask, (iii) a resolver to ensure no gaps in execution-time or task-steps exist, and finally (iv) a combiner to verify proper task execution order and end-result, prior to forwarding all command arguments to (v) the minimanipulation command generator that maps them to the physical configuration of the macro-manipulation subsystem hardware.

FIG. 2K depicts the process by which minimanipulation command-stack sequences are generated for any robotic system, in this case deconstructed to generate two such command sequences for a single robotic system that has been physically and logically split into a macro- and micro-manipulation subsystem, which provides an alternate approach to FIG. 2J. The process of generating minimanipulation command-stack sequences for any robotic system, in this case a physically and logically split macro- and micro-manipulation subsystem receiving dedicated macro- and micro-manipulation subsystem command sequences 1491 and 1492, respectively, requires multiple processing steps be executed, by a minimanipulation action-primitive (AP) components selector module 1510, on high-level task-executor commands 1550, combined with input utilizing all available action-primitive alternative (APA) candidates 1540 from an AP-repository 1520.

The AP-repository is akin to a relational database, where each AP described as AP₁ through APₙ (1522, 1523, 1526, 1527) associated with a separate task, regardless of the level of abstraction by which the task is described, comprises of a set of elemental APᵢ-subblocks (APSB₁ through APSBₘ; 1522a_{1->m}, 1523a_{1->m}, 1526a_{1->m}, 1527a_{1->m}) which can be combined and concatenated in order to satisfy task-performance criteria or metrics describing task-completion in terms of any individual or combination of such physical variables as time, energy, taste, color, consistency, etc. Hence any complexity of task can be described through a combination of any number of AP-alternatives (APAₐ through APA_{z}; 1521, 1525), which could result in the successful completion of a specific task, well understanding that there is more than a single APAᵢ that satisfies the baseline performance requirements of a task, however they may be described.

The minimanipulation AP components sequence selector 1510 hence uses a specific APA selection process 1513 to develop a number of potential APA_{a thru z} candidates from the AP repository 520, by taking in the high-level task executor task-directive 1540, processing it to identify a sequence of necessary and sufficient sub-tasks in module 1511, and extracting a set of overall and subtask performance criteria and en-states for each sub-task in step 1512, before forwarding said set of potentially viable APs for evaluation. The evaluation process 1514 compares each APAᵢ for overall performance and en-states along any of multiple stand-alone or combined metrics developed previously in 1512, including such metrics as time required, energy-expended, workspace required, component reachability, potential collisions, etc. Only the one APAᵢ that meets a pre-determined set of performance metrics is forwarded to the planner 1515, where the required movement profiles for the macro- and micro manipulation subsystems are generated in one or more movement spaces, such as joint- or Cartesian-space. Said trajectories are then forwarded to the synchronization module 1516, where said trajectories are processed further by concatenating individual trajectories into a single overall movement profile, each actuated movement s synchronized in the overall timeline of execution as well as with its preceding and following movements, and combined further to allow for coordinated movements of multi-arm/-limb robotic appendage architectures. The final set of trajectories are then passed to a final step of minimanipulation generation 1517, where said movements are transformed into machine-executable command-stack sequences that define the minimanipulation sequences for a robotic system. In the case of a physical or logical separation, command-stack sequences are generated for each subsystem separately, such as in this case for the macro-manipulation subsystem command-stack sequence 491 and the micro-manipulation subsystem command-stack sequence 1492.

FIG. 2L depicts a block diagram illustrating another embodiment of the physical layer structured as a macro-manipulation/micro-manipulation.

The hardware systems innate within each the macro- and micro-manipulation subsystems are reflected at both the macro-manipulation subsystem level through the instrumented articulated and controller-actuated articulated base 1810, and the micro-manipulation level through the instrumented articulated and controller-actuated humanoid-like appendages 1820 subsystems. Both are connected to their perception and modelling systems 1830 and 1840, respectively.

In the case of the macro-manipulation subsystem 1810, a connection is made to the world perception and modelling subsystem 1830 through a dedicated sensor bus 1870, with the sensors associated with said subsystem responsible for sensing, modelling and identifying the world around the entire robot system and the latter itself, within said world. The raw and processed macro-manipulation subsystem sensor data is then forwarded over the same sensor bus 1870 to the macro-manipulation planning and execution module 1850, where a set of separate processors are responsible for executing task-commands received from the task minimanipulation parallel task execution planner 1430, which in turn receives its task commands from the high-level minimanipulation task/action parallel execution planner 1470 over a data and controller bus 1880, and controlling the macro-manipulation subsystem 1810 to complete said tasks based on the feedback it receives from the world perception and modelling module 1830, by sending commands over a dedicated controller bus 1860. Commands received through this controller bus 1860, are executed by each of the respective hardware modules within the articulated and instrumented base subsystem 1810, including the positioner system 1813, the repositioning single kinematic chain system 1812, to which is attached the central control system 1811.

The positioner system 1813 reacts to repositioning movement commands to its Cartesian XYZ positioner 1813a, where an integral and dedicated processor-based controller executes said commands by controlling actuators in a high-speed closed loop based on feedback data from its integral sensors, allowing for the repositioning of the entire robotic system to the required workspace location. The repositioning single kinematic chain system 1812 attached to the positioner system 1813, uses the same architecture described above, where each of their articulation subsystems 1812a and 1813a, receive separate commands to their respective dedicated processor-based controllers to command their respective actuators and ensure proper command-following through monitoring built-in integral sensors to ensure tracking fidelity. The central control system 1811 receives movement commands to the head articulation subsystem 1811a, where an integral and dedicated processor-based controller executes said commands by controlling actuators in a high-speed closed loop based on feedback data from its integral sensors.

The architecture is similar for the micro-manipulation subsystem. The micro-manipulation subsystem 1820, communicates with the interaction perception and modeller subsystem 1840 responsible for product and process perception and modelling, through a dedicated sensor bus 1871, with the sensors associated with said subsystem responsible for sensing, modelling and identifying the immediate vicinity at the EoA, including the process of interaction and the state and progression of any product being handled or manipulated. The raw and processed micro-manipulation subsystem sensor data is then forwarded over its own sensor bus 1871 to the micro-manipulation planning and execution module 1851, where a set of separate processors are responsible for executing task-commands received from the minimanipulation parallel task execution planner 1430, which in turn receives its task commands from the high-level minimanipulation planner 1470 over a data and controller bus 1880, and controlling the micro-manipulation subsystem 1820 to complete said tasks based on the feedback it receives from the interaction perception and modelling module 1840, by sending commands over a dedicated controller bus 1861. Commands received through this controller bus 1861, are executed by each of the respective hardware modules within the instrumented EoA tooling subsystem 1820, including the one or more single sinematic chain system 1823, to which is attached the wrist system 1825, to which in turn is attached the hand-/end-effector system 1823, allowing for the handling of the thereto attached cooking-system 1822. The single kinematic chain system contains such elements as one or more limbs/legs and/or arms subsystems 1824a, which receive commands to their respective elements each with their respective dedicated processor-based controllers commanding their respective actuators to ensure proper command-following through monitoring built-in integral sensors to ensure tracking fidelity. The wrist system 1825 receives commands passed through the single kinematic chain system 1824 which are forwarded to its wrist articulation subsystem 1825a with its respective dedicated processor-based controllers commanding their respective actuators to ensure proper command-following through monitoring built-in integral sensors to ensure tracking fidelity. The hand system 1823 which is attached to the wrist system 1825, receives movement commands to its palm and fingers articulation subsystem 1823a with its respective dedicated processor-based controllers commanding their respective actuators to ensure proper command-following through monitoring built-in integral sensors to ensure tracking fidelity. The cooking system 1822, which encompasses specialized tooling and utensil subsystem 1822a (which may be completely passive and devoid of any sensors or actuators or contain simply sensing elements without any actuation elements), is responsible for executing commands addressed to it, through a similar dedicated processor-based controller executing a high-speed control-loop based on sensor-feedback, by sending motion commands to its integral actuators. Furthermore, a vessel subsystem 822b representing containers and processing pots/pans, which may be instrumented through built-in dedicated sensors for various purposes, can also be controlled over a common bus spanning from the single kinematic chain system 1824, through the wrist system 1825 and onwards through the hand/effector system 1823, terminating (whether through a hardwired or a wireless connection type) in the operated object system 1822.

FIG. 2M depicts a block diagram illustrating another embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems. As tends to be the case with manipulation system, particularly those requiring substantial mobility over larger workspaces while still needing appreciable endpoint motion accuracy, as is shown in this alternate embodiment in FIG. 2M, they can be physically and logically subdivided into a macro-manipulation subsystem comprising of a large workspace positioner 1940, coupled with an articulated body 1942 comprising multiple elements 1910 for coarse motion, and a micro-manipulation subsystem 1920 utilized for fine motions, physically joined and interacting with the environment 1938, which may contain multiple elements 1930.

For larger workspace applications, where the workspace exceeds that of a typical articulated robotic system, it is possible to increase the systems' reach and operational boundaries by adding a positioner, typically capable of movements in free-space, allowing movements in XYZ (three translational coordinates) space, as depicted by 1940 allowing for workspace repositioning 1943. Such a positioner could be a mobile wheeled or legged base, aerial platform, or simply a gantry-style orthogonal XYZ positioner, capable of positioning an articulated body 1942. Such an articulated body 1942 targeted at applications where a humanoid-type configuration is one of the possible physical robot instantiations, said articulated body 1942 would describe a physical set of interlinked elements 1910, comprising of upper-extremities 1917 and lower-extremities 1917a. Each of these interlinked elements within the macro-manipulation subsystem 1910 and 1940 would consist of an instrumented articulated and controller-actuated sub-elements, including a head 1911 replete with a variety of environment perception and modelling sensing elements, connected to an instrumented articulated and controller-actuated shouldered torso 1912 and an instrumented articulated and controller-actuated waist 1913. The waist 1913 may also have attached to its mobility elements such as one or more legs, or even articulated wheels, in order to allow the robotic system to operate in a much more expanded workspace. The shoulders in the torso can have attachment points for minimanipulation subsystem elements in a kinematic chain described further below.

A micro-manipulation subsystem 1920 physically attached to the macro-manipulation subsystem 1910 and 1940, is used in applications where fine position and/or velocity trajectory-motions and high-fidelity control of interaction forces/torques is required, that a macro-manipulation subsystem 1910, whether coupled to a positioner 1940 or not, would not be able to sense and/or control to the level required for a particular domain-application. The micro-manipulation subsystem 1920 comprises of shoulder-attached linked appendages 1916, such as one (typically two) or more instrumented articulated and controller-actuated jointed arms 1914 to each of which would be attached an instrumented articulated and controller-actuated wrist 1918. It is possible to attach a variety of instrumented articulated and controller-actuated end-of-arm (EoA) tooling 1925 to said mounting interface(s). While a wrist 1918 itself can be an instrumented articulated and controller-actuated multi-degree-of-freedom (DoF; such as a typical three-DoF rotation configuration in roll/pitch/yaw) element, it is also the mounting platform to which one may choose to attach a highly dexterous instrumented articulated and controller-actuated multi-fingered hand including fingers with a palm 1922. Other options could also include a passive or actively controllable fixturing-interface 1923 to allow the grasping of particularly designed devices meant to mate to the same, many times allowing for a rigid mechanical and also electrical (data, power, etc.) interface between the robot and the device. The depicted concept need not be limited to the ability to attach fingered hands 1922 or fixturing devices 1923, but potentially other devices 924, through a process which may include rigidly anchoring them to the surface, or even other devices.

The variety of end effectors 1926 that can form part of the micro-manipulation subsystem 920 allow for high-fidelity interactions between the robotic system and the environment/world 1938 by way of a variety of devices 1930. The types of interactions depend on the domain application 1939. In the case of the domain application being that of a robotic kitchen with a robotic cooking system, the interactions would occur with such elements as cooking tools 1931 (whisks, knives, forks, spoons, whisks, etc.), vessels including pots and pans 1932 among many others, appliances 1933 such as toasters, electric-beater or -knife, etc., cooking ingredients 1934 to be handled and dispensed (such as spices, etc.), and even potential live interactions with a user 1935 in case of required human-robot interactions called for in the recipe or due to other operational considerations.

FIG. 2N depicts one of a myriad number of possible decision trees that may be used to decide on a macro-/micro-logical and physical breakdown of a system for the purpose of high fidelity control. Potential decision types 1010 in diagram 1000, can include the a-priori type 1020 which are made before or during the design of the hardware and software of the system and are thus by default fixed and static and can not be changed during the operation of the system, or the continuous type 1030, where a supervisory software module monitoring various criteria could make decisions as to where the changing demarcation line of macro-vs-micro structure should be drawn.

In the case of the a-priori method 1020, the decision could be based on design constraints 1021, which may be dictated by the physical layout or configuration 1021a of a robotic system, or the computation architecture and capability 1021b of the processing system responsible for its planning and control tasks. Rather or better yet in addition to basing a decision on design constraints 1021, the decision could be reached through a simulation system, which would allow the study of its constraints 1022 off-line and beforehand, in order to decide on the macro-vs-micro boundaries location based on the capabilities of various inverse kinematic (IK) solvers or algorithms and their associated complexity 1022a, as the ultimate goal is to have the system planner and controller operate in real time using deterministic solutions at each time-step.

The use of a dynamic decision process 1030 capable of re-drawing the logical separation of the macro and micro manipulation subsystems, potentially ranging from each domain application to each task or even down to every time-step, would allow for as-optimal as possible a solution to operate a complex robotic system consisting of multiple kinematic elements arranged individually or as chains, in as effective a manner as possible. Such processes could include evaluation of criteria such as real-time operations 1031, energy consumption or extent of required movements 1032 at each time-step or (sub-)task, the expected (sub-)task execution time 1033, or other alternate criteria subjected to a real-time minimization/maximization technique 1034.

Real-time operations 1031 could be based on a software module looking ahead one or more time-steps or even at the sub-task or complete-task level, to evaluate which logical macro-/micro boundary configuration is capable to rune in real-time and specifically, which boundary configuration or dynamically configured boundary lines minimize real-time computations and guarantee real-time operations. Another approach, whether run as a stand-alone or in combination with any of the processes 1031, 1033 or 1034, could evaluate the required energy or movement extent (as measured by total distance travelled by each articulated element) at various levels such as at each time-step or at the s-task or full-task level in a look-ahead manner, to again decide which potentially continually altered sequence of macro-/micro-manipulation logical boundary should be utilized to minimize total energy expended and/or minimiaze overall motions. Yet another approach, whether run as a stand-alone or in combination with any of the processes 1031, 1032 or 1034, could evaluate also in a look-ahead manner, which of a subset of feasible macro-/micro-boundary configurations could minimize overall (sub-)task execution times, and deciding on the one or combinations of boundary configurations, that minimize sub-task or overall task execution time. And another possible approach, whether run as a stand-alone or in combination with any of the processes 1031, 1032 or 1033, could maximize or minimize any single or combination of criteria of importance to the application domain and its dedicated tasks, in order to decide on which potentially changeable macro-/micro-manipulation boundary to implement to allow for the most optimal operation of the robotic system.

FIG. 2O is a block diagram illustrating an example of a macro manipulation (also referred to as macro minimanipulation) of a stir process with todo parameters divided into (or composed of) multiple micro manipulations. FIG. 2P is a flow diagram illustrating the process of a macro/micro manager in allocating one or more macro manipulations and one or more micro manipulations. In this example, there are five manipulations: 2, 3, 4, 5, 6. When the macro manipulation is sent to the execution module, all the micro manipulations contained are executed in sequence. The micro manipulations 2 and 6 are hardcoded in the macro manipulation: they are always present. The micro-manipulations 3, 4, 5 are dynamically generated by the software module MacroMicroManager 7. First, the MacroMicroManager, analyzes (8) the incoming manipulation. Next, the MacroMicroManager generates (9) all dynamic micro manipulations based on the previous analysis. Then, the MacroMicroManager sets (10) the parameters for each micro manipulation, based on the macro manipulation parameters. The dynamically generated micro manipulations can be of any number N, in this example N=3. Before the execution the robot posture 11 is with the spoon in one hand and any other hand empty. In the micro manipulation (also referred to as micro minimanipulation) 2, the robot moves to a specific pre-defined posture (Robotic multi-joints apparatus Joint State Pose) 12 positioning the utensil inside the cookware. In each of the dynamically generated micro manipulations (3, 4, 5, 6) the robot starts from the posture 12, stirs with spoon inside the cookware, performing a trajectory which ends exactly at the same pre-stored posture 12. In the micro manipulation 6, the robot starts with the posture 12, moves the spoon away from the cookware configuring itself to the macro ap posture 11. Before the execution of the macro-manipulation, the system checks the area of operation, defined inside the macro-manipulation, to ensure only the expected objects are in this area and also in the correct position wrt a specific robot part (usually the robot base or the arm base, depending on the instrumental environment (kitchen embodiment). In one embodiment the micro-manipulation 2 moves the robot from posture 11 to posture 12 using a pre-stored joint trajectory, which moves one arm to bring the spoon in the cookware and the other arm and hand to grasp the cookware and hold it firmly, the micro-manipulation 3 moves the robot from posture 2 to the same posture 2 using a pre-stored joint trajectory (for example stirring trajectory cycle, as a round stirring, forward/backward stirring cycle, fast/slow stirring cycle), by moving mostly the arm which holds the spoon. Starting and ending in the same posture 2 allows the robot to execute again next joint trajectory (same or different) which starting and ending by predefined posture 2 multiple times without discontinuities between each trajectory, without requiring a motion planning between them, so all the micro-manipulations generated dynamically (3,4,5) in this stirring example use the same pre-stored joint trajectory. The last micro-manipulation 6 moves the robot from posture 12 to posture 11, using a pre-stored joint trajectory which moves the spoon with one arm and releases the cookware with the other arm and hand. So the overall macro manipulation execution starts and ends with the defined or same robot posture 11 if the robot holds the same object by the same end effector. To make robotics control system more robust and reliable, the structure of manipulations is simplified by defining each initial and final posture of the robot for associated manipulation as a one or limited numbers predefined postures with the held objects combination. As an example for two arm robotic arms and corresponding two end effectors with shared shoulder joint, the following can be defined: one posture for two empty end effectors, one posture for spatula held in right end effector and empty left end effector, one posture of held pasta pot cookware by left and right end effectors, etc. In this case each minimanipulation starts and finishes by only one (or limited numbers) of robotic apparatus postures that give the opportunity to execute a sequence of minimanipulations without additional robotic apparatus risky reconfiguration procedure. Before each macro or micro minimanipulation execution processor checks the potential collisions with regards of robotic apparatus minimanipulation motion versus current Virtual World state. In case, a processor finds the collision, another version of the same macro or micro minimanipulation should be applied or new motion and cartesian plan could be generated and validated. As a simple example, the MicroMacroManager 7 generated only 3 stirring mini-manipulations (3,4,5) based on the parameters in the macro-manipulations (example parameter: stirring duration) but in other executions, with different parameters, the number of stir iterations could have been less or more.

During all macro/micro manipulations, the system can get and store real time data 16 automatically or on demand (by user request). These data may contain information about robot status, executed macro-manipulations 16, 1, 17, execute micro-manipulations 2, 3, 4, 5, 6, objects 18, ingredients 19, sensors 13, smart appliances 15, and any other parameters to store in retrieve from Virtual World model 14. For each object or ingredient the data processed includes shape, size, weight, smell, temperature, texture, colour, dimension, position and orientation wrt robot or the kitchen structure. For each manipulation the data stored or retrieved may include: execution start time, duration, delay before/after manipulation, meta-parameters which customize the specific manipulation, level of success of the particular operation. The system continuously updates the virtual world model 14 based on the outcome of each manipulation, example: when executing a manipulation called ‘pour completely the ingredient I from the container X into the cookware Y’, the system stores that ingredient I is now located inside cookware Y and the container X is empty. Some objects in Virtual World can have also additional descriptors and flags, for example object can have list of ingredients inside, or been dirty/clean, or empty/half empty/full, or appliance battery can have low energy, or oven can have aspecific error during operation execution, or object and be covered by lid. Any of these additional objects specific parameters regularly updated in the virtual instrumented environment (kitchen or other) world in accordance with their current state in the corresponded physical instrumental environment world.

FIG. 3A depicts robotic kitchen 10 in user operating mode which is completely compatible with human user. Gantry system 12 and robot 20 is not powered and in resting position. User 40 operating cooking zone, hob 16 particularly.

FIG. 3A depicts safeguard 40 in upper position, compatible with user.

FIG. 3C depicts different subsystems which are enabling user to user the kitchen in guided recipe execution. Vision system 32 which has multiple function in user mode. For instance, it is monitoring the state of the ingredient while cooking, it can perform recipe recording action, enabling user to record his movements and save it as the recipe for further execution. GUI touchscreen 41 is central part of user interaction with robotic kitchen, he is enabled to control and observe virtual kitchen model, program the recipes and more. There is a tool storage 42 in the robotic kitchen which is responsible for storing cooking equipment.

FIG. 3D depicts robot 20 is safely parked inside robot storage area 45, behind automated doors 43 which are opening and closing automatically by system command.

FIG. 3E depicts situation when robot 20 is activated, doors 43 are opening to allow it to travel inside the kitchen workspace 46.

FIG. 3E depicts the automated robot doors mechanism. When robot is not active, the doors are interlocked 47, making sure that user is not able to open those doors. Linear actuators 48 which can be of any type (hydraulic, pneumatic, electric etc.) are providing the required motion for moving the doors along the guide systems 49 which have specific shape and type to make sure doors are flushed with the panel structure after closing. Profile supports 50 and sheet metal supports 51a 51b are creating the structure

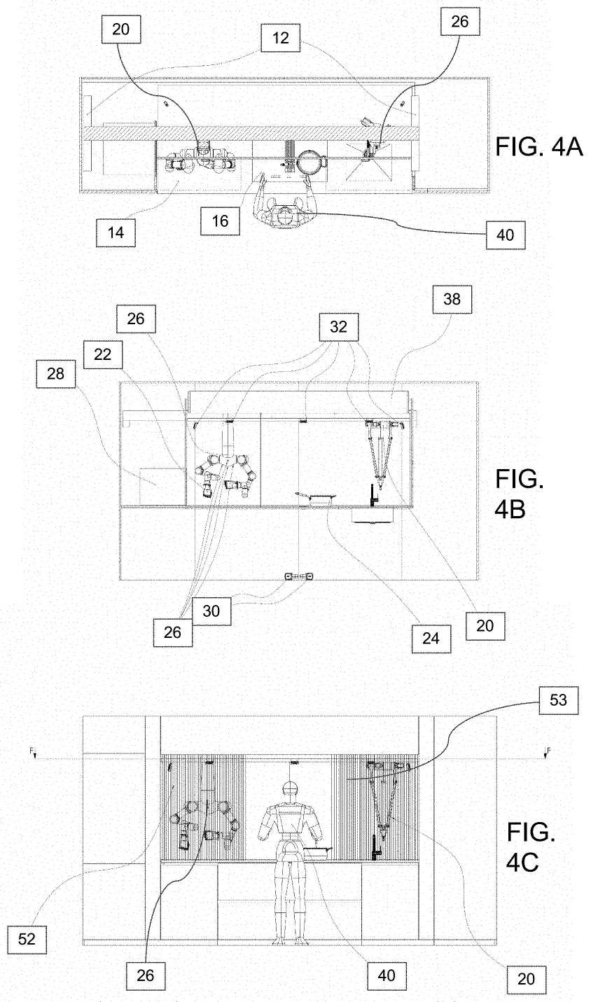

FIG. 4A depict robotics kitchen in collaborative operating mode “robot 1” 20, example “robot n” 26 are working with human user 40 in collaboration, user is visible operating the hob 16. gantry systems 12 are enabled, however they are running in a special safety mode.

FIG. 4B depict safeguard 38 is in upper position and there are number of sensors 30 which are indicating user position in the kitchen so robots are not able to harm him. A There are cameras 32 which are also acquiring the position of the user and feeding back to robot control system. Sensors in the feet level of the system 30 can be different types i.e. laser scanners, radar technology-based scanners or any type of other sensor able to indicate user position are acquiring the position of the human user and feeding back to the system to ensure safety operation.

FIG. 4C depicts light curtains safety scanning system 52 53 which are enabling the system to zone operations between human user 40 and robots 20 26.

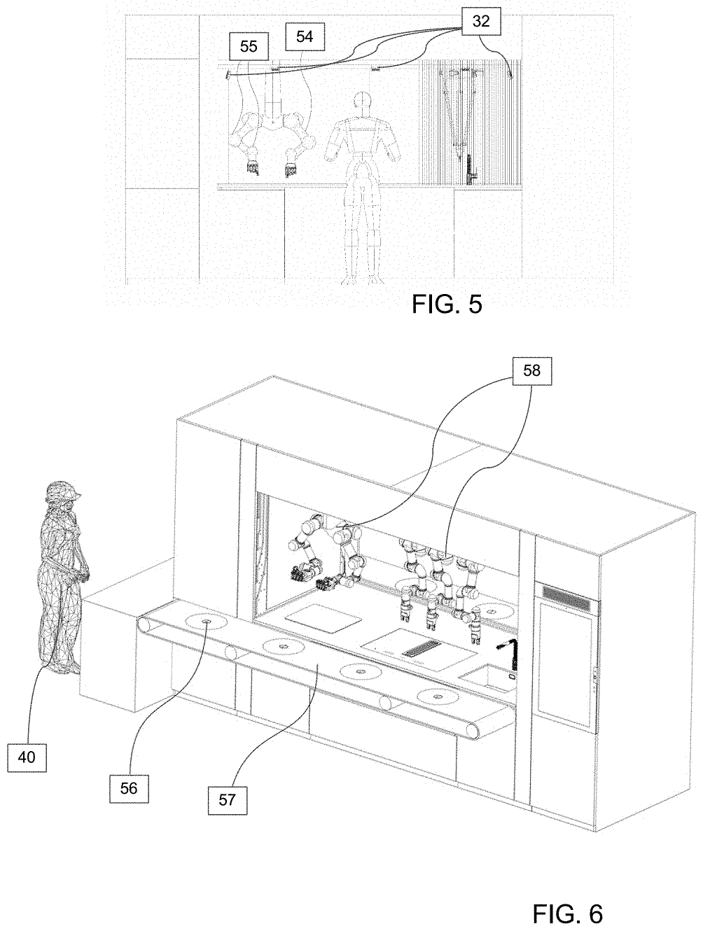

FIG. 5 depicts robot which is equipped with collaborative and sterile sleeves 54 and impact prevention bumpers 55. They are generating safety signal when they are in collision with any surface. Bumpers 55 also have soft cushioned impact safety mechanism, which is crucial in case of unlike failure mode crash. Sleeves are also made from clean room material and they are also sterile indicator, vision system 32 can detect if they are not sterile, they are also flexible and easy to exchange.

FIG. 6 depicts human robot collaborative station with autonomous conveyor belt system 57, with ability to transport prepared food to the human 40 or raw ingredients to the robotic system 58. Conveyor belt system has presence detection sensors 56 which indicates presence and type placed item and transports it accordingly to desired place using conveyor belt system 56.

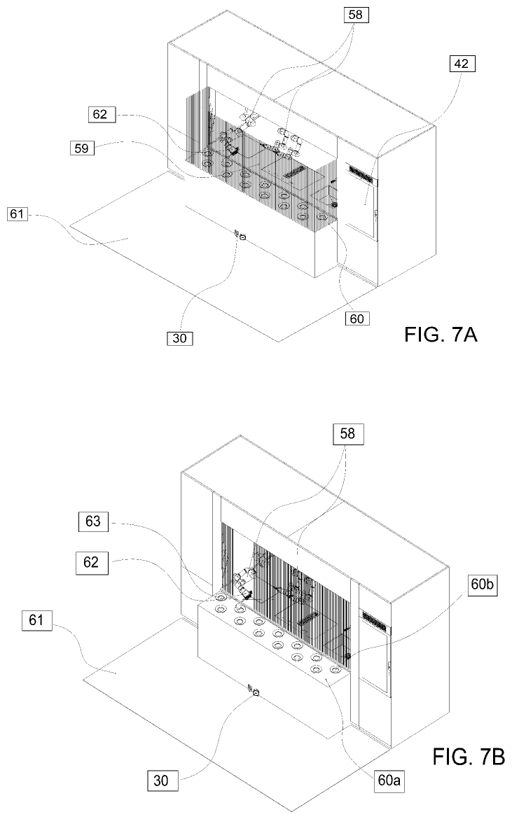

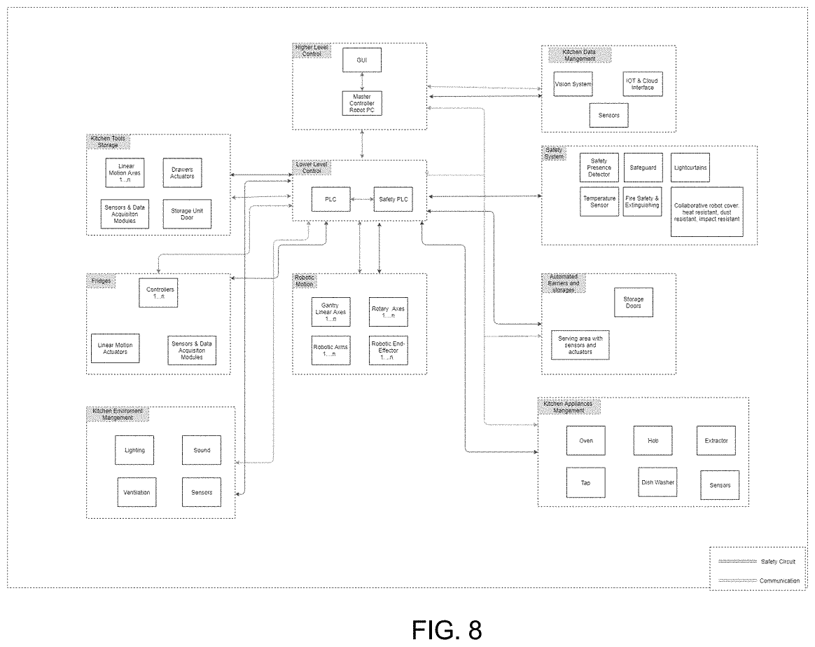

FIG. 7A depicts stationary collaborative station. The station has multiple sensors to ensure safety collaboration between human and robot 58. Among other there is safety scanner 30 which is able to detect position of the human, safety matt 61 which gets the signal once human steps to the potential hazardous environment and external light curtain zoning system 59, which automatically detects if user has entered potential dangerous environment, called common operating environment 60. The main collaborative feature in this setup is the fact, that robot is physically unable to reach human user, maximum extended position of the arms 62 is visible on the drawing. User can use GUI 42 to control the system.

FIG. 7B depicts stationary collaborative station. The station has multiple sensors to ensure safety collaboration between human and robot 58. Among other there is safety scanner 30 which is able to detect position of the human, safety matt 61 which gets the signal once human steps to the potential hazardous environment and internal light curtain zoning system 63, which automatically detects if robot has entered potential dangerous environment, called common operating environment 60. The main collaborative feature in this setup is the fact, that robot is physically unable to reach human user, maximum extended position of the arms 62 is visible on the drawing. User can use GUI 42 to control the system.

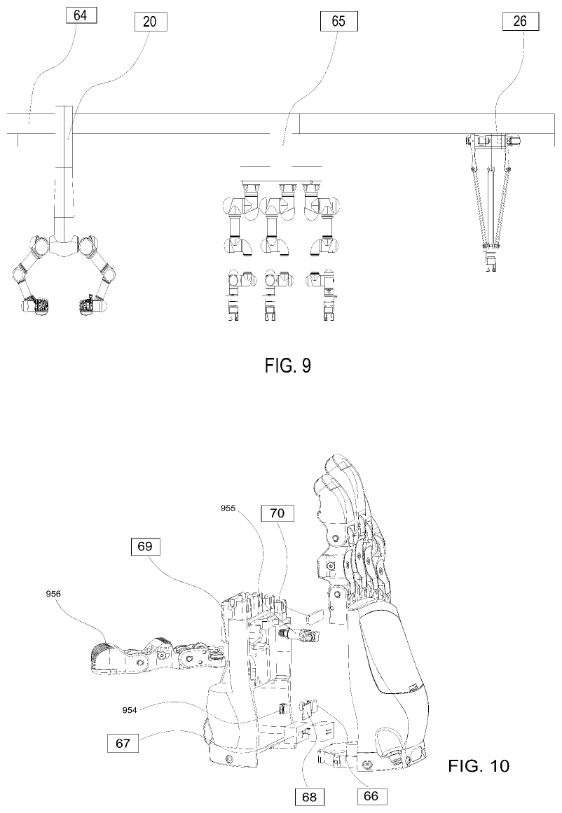

FIG. 9 depicts example robotic carriages systems. Carriages are mounted on linearly actuated gantry. Dual arms 20, multiple manipulator structure 65 or delta robot 26 are used as an example of robotic systems.

FIG. 10 depicts robotic hand comprised with vision system 66 and has the ability to perform visual surveying operations as well as visual object recognition operations. This allows the system to determine ID of object before grasping, another way of determining object type and ID is by using barcode scanner 67 and RFID tag reader 68, however, in this scenario objects needs to be tagged. Hand also comprises of LED light 69, which can enlighten the environment for the purpose of better performing vision system 66 if such operation would be required due to lightning conditions inside operating environment. Hands also compromises UV light 70 indicators which have ability to sterilize certain areas or objects precisely, with direct operational success feedback from vision system 66.

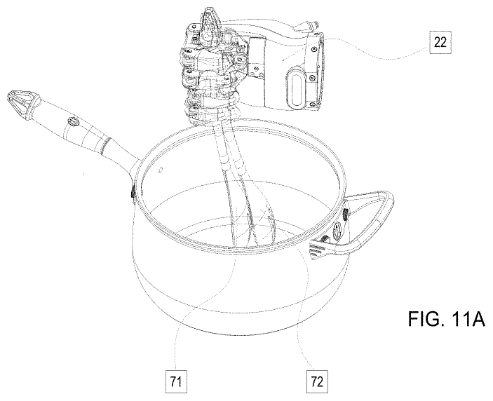

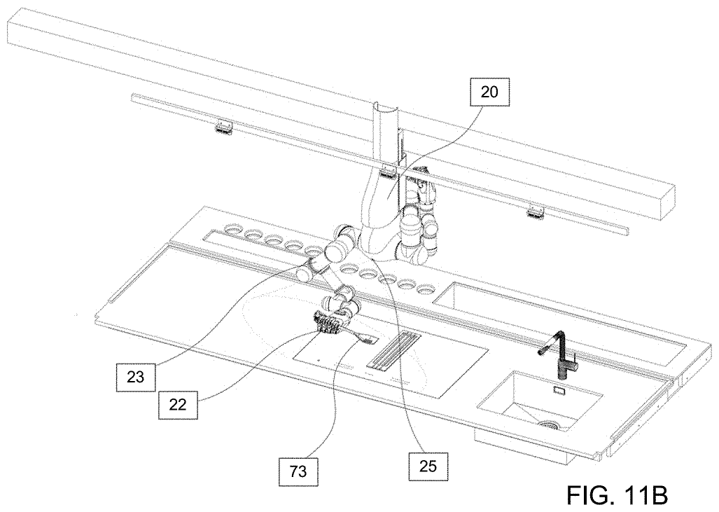

FIG. 11A depicts regrasping sequence procedure. Visible example robotic operation (stirring) which could potentially affect the initial position 71 of the operation tool. After performing the stirring operation object position is displaced 72 in regard to initial position 71. Each robotic hand finger has motors with constant position feedback. When object is displaced, finger position reading is affected. After receiving different reading, motors are automatically trying to reach initial commanded position. This way, displaced object 72 is coming back to initial position 71. Regrasping sequence outcome can be validated with vision system inside the kitchen.

FIG. 11B depicts essential part required for robot operation is a robot carriage 20 vision system 25 it is allowing to develop understanding about the environment around the carriage. Main functionality of this system is to do the object grasp validation. After the grasp operation is performed, robot would go to standard arm configuration 23 where the grasped object 73 would be visible to the camera 25. Then vision system would recognize grasped object and its exact position in relation to the hand 22. System acknowledges geometry of the grasp and cartesian position and orientation of the objects tip, which is crucial for the execution. In this scenario the system could recalculate the motion planning in cartesian library based on this data, and get rid of possible error, cause by slight grasp inaccuracy. It could also add the offset point to execution commands in joint state library execution. Shift on different axis and orientation would be compensated on different actuated axis.

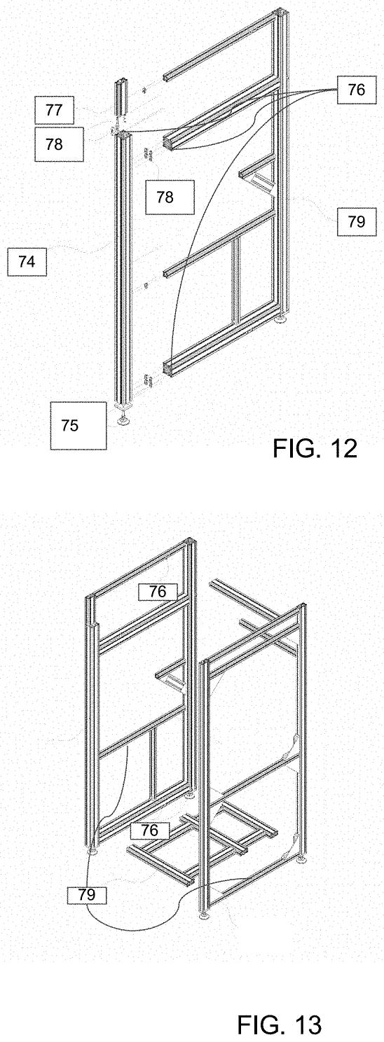

FIG. 12 depicts kitchen frame assembly procedure. Frame is the skeleton of the robotic kitchen system. Important factor of successful operation is the ability to rely on certain accuracy and repeatability of the physical model. Reliable and repeatable assembly process of the frame is crucial. Parts of the frame 74 are interfaced to another elements 77 with the help of the fasteners 78. There is in only one way to interface the elements one to another, through high precision machined inserts/drilled holes 76. There are feets 75 to adjust the height to required height.

FIG. 13 depicts how the pre assembled kits of the frames are assembled on the final stage one way of connecting the kits 79 with precision interfaces 76 using special fasteners enables reliable, repeatable and robust connection, with high accuracy that can be relied on. The main value in this assembly technique is the repeatability and ease of scaling up the product of the machines that have the same geometry. In this case pretested execution trajectory are valid in all units that have been manufactured and do not need to be retested on each kitchen.

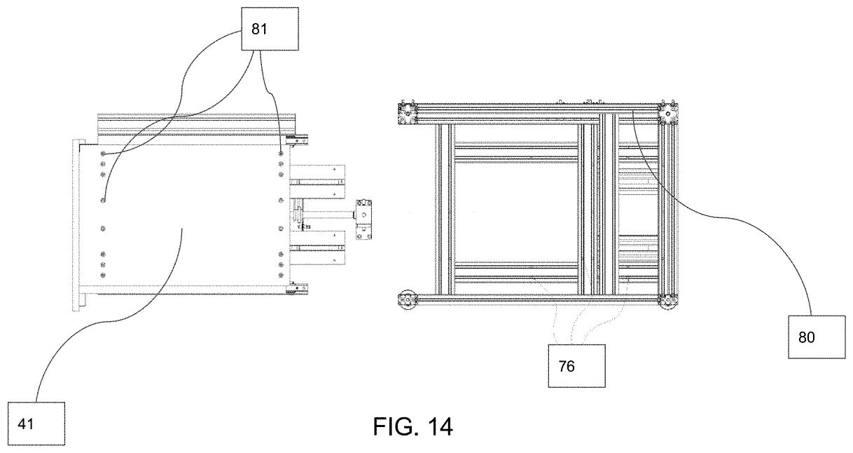

FIG. 14 depicts interfacing technique between the frame and subsystems. Frame 80 is the base for all subsystems like tool storage 41 inside the robotics kitchen. Interfaces of the subsystems 81 are always high precision machined, even if the entire construction of the subsystem is not (i.e. construction is a piece of furniture, however it would have metal mounting plate with high precision interface), and they are interfaced to high precision interfaces on the frame 76. High accuracy and repeatability inside the system is ensured, there is no chance of misplacing components and risking inaccuracy in the physical model.

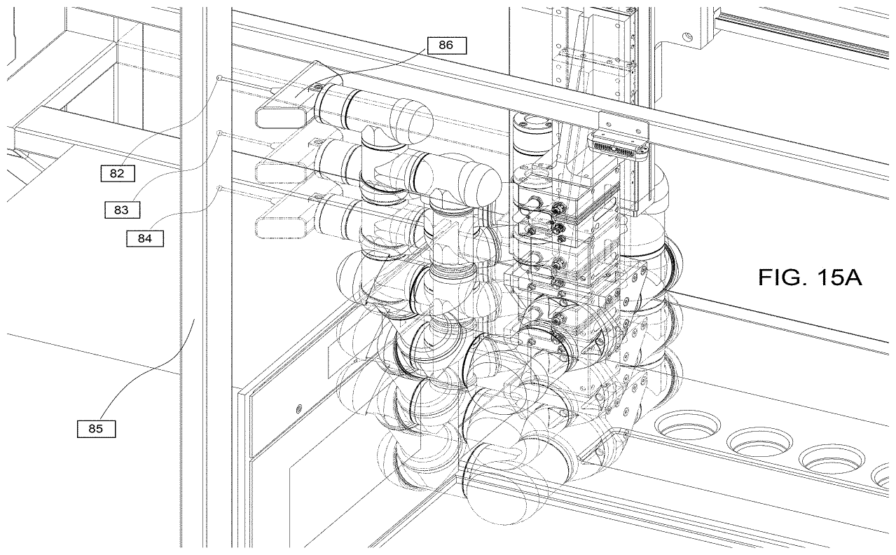

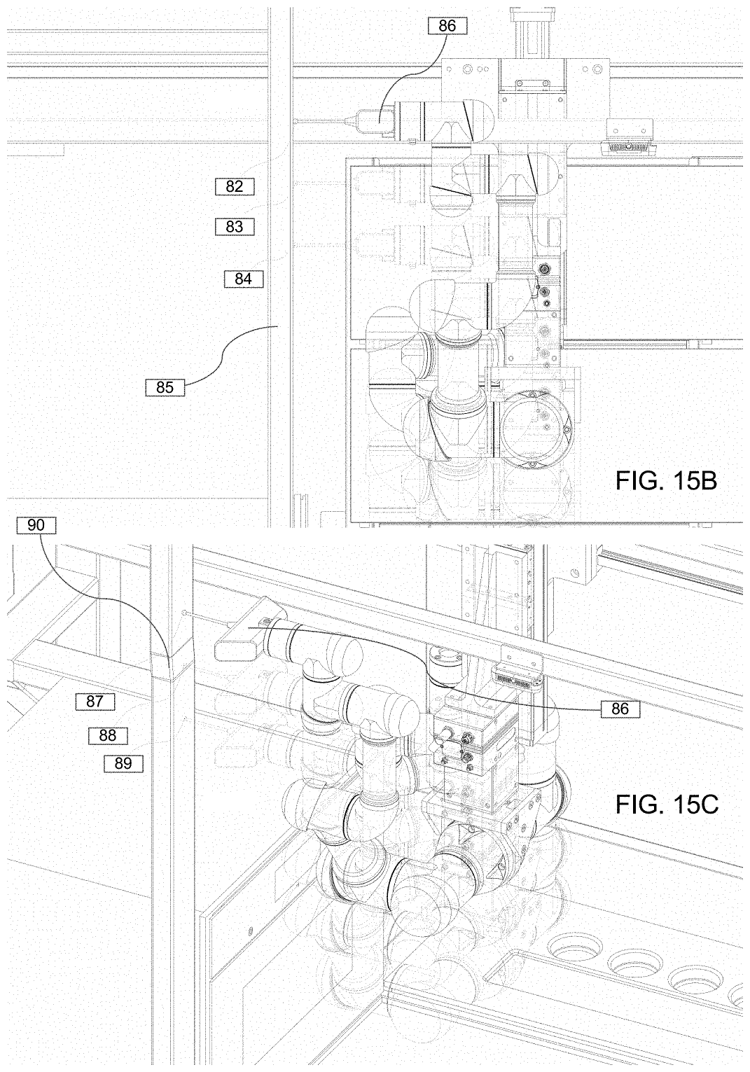

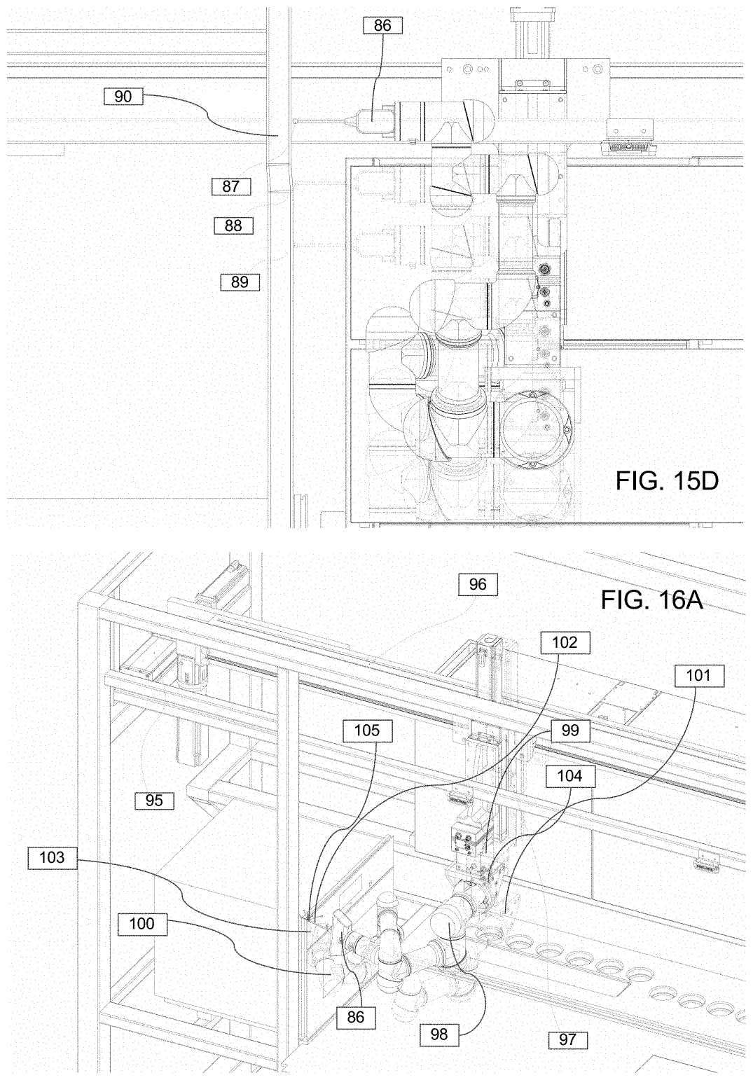

FIG. 15A depicts an isometric view of etalon model virtual model. Automatic adjustment procedure is visible on the drawing is a crucial procedure, ensuring reliable operation and scalability of the robotic kitchen system. The robot is probing several positions in a virtual model. The procedure is starting with comparing etalon model virtual model geometry with physical model. Probe 86 is represented on the virtual model measuring robotic system geometry. The geometry observed on the drawing is the reference geometry from the virtual model. Probe 86 has several sensors inside able to acquire data about the environment: point cloud sensor, high precision IR sensor, high precision proximity sensor, high precision physical limit switch/bumper along other sensors. The probe is approaching the certain point in virtual model kitchen 82, which is the reference point. After that it is moving to point 83, and point 84.

FIG. 15B depicts a side view of etalon model virtual model. Automatic adjustment procedure is visible on the drawing and is a crucial procedure, ensuring reliable operation and scalability of the robotic kitchen system. The robot is probing several positions in a virtual model. The procedure is starting with comparing etalon model virtual model geometry with physical model. Probe 86 is represented on the virtual model measuring robotic system geometry. The geometry observed on the drawing is the reference geometry from the virtual model. Probe 86 has several sensors inside able to acquire data about the environment: point cloud sensor, high precision IR sensor, high precision proximity sensor, high precision physical limit switch/bumper along other sensors. The probe is approaching the certain point in virtual model kitchen 82, which is the first reference point. After that it is moving to point 83, and point 84.

FIG. 15C depicts an isometric view of the etalon model physical model. Automatic adjustment procedure is visible on the drawing and is a crucial procedure, ensuring reliable operation and scalability of the robotic kitchen system. The robot is probing several positions in a virtual model. The procedure is starting with comparing etalon model virtual model geometry with physical model. Probe 86 is represented on the physical model measuring robotic system geometry. The geometry observed on the drawing is the reference geometry from the physical model. It is acquiring data from the sensors to determine what is the offset between physical system position in relation to the point from the virtual model, the result is then compared with the virtual model data. The probe is approaching the certain point in physical model kitchen 87, which is the first comparison point. After that it is moving to point 88, and point 89. Then cartesian position and orientation of probing points is compared with virtual model points 82, 83, 84. Several points are measured on one plane, in such a way, displacement patterns can be observed, torsion, bending, displacement are fed back to the system, assumption about the model 85 can be cross checked with reality 90. Physical model column 90 is flawed, virtual model column 85, has to be adapted to match the reality. Adaptation is done using the offset data from the probe 86.

FIG. 15D depicts a side view of the etalon model physical model. Automatic adjustment procedure is visible on the drawing and is a crucial procedure, ensuring reliable operation and scalability of the robotic kitchen system. The robot is probing several positions in a virtual model. The procedure is starting with comparing etalon model virtual model geometry with physical model. Probe 86 is represented on the physical model measuring robotic system geometry. The geometry observed on the drawing is the reference geometry from the physical model. It is acquiring data from the sensors to determine what is the offset between physical system position in relation to the point from the virtual model, the result is then compared with the virtual model data. The probe is approaching the certain point in physical model kitchen 87, which is the first comparison point. After that it is moving to point 88, and point 89. Then cartesian position and orientation of probing points is compared with virtual model points 82, 83, 84. Several points are measured on one plane, in such a way, displacement patterns can be observed, torsion, bending, displacement are fed back to the system, assumption about the model 85 can be cross checked with reality 90. Physical model column 90 is flawed, virtual model column 85, has to be adapted to match the reality. Adaptation is done using the offset data from the probe 86.

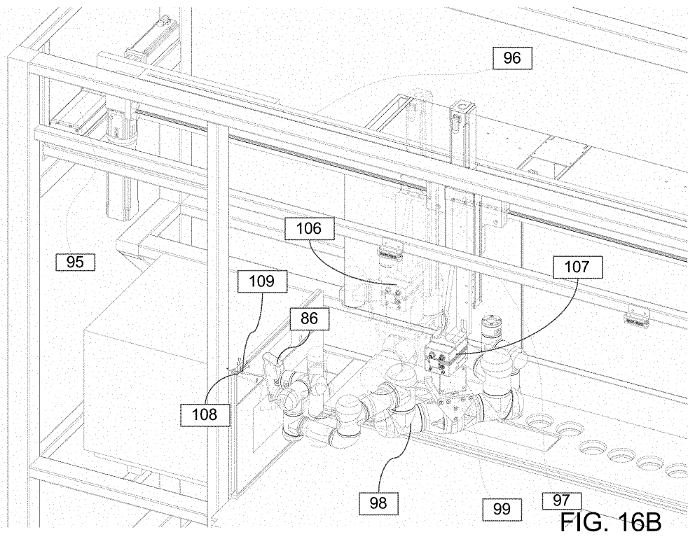

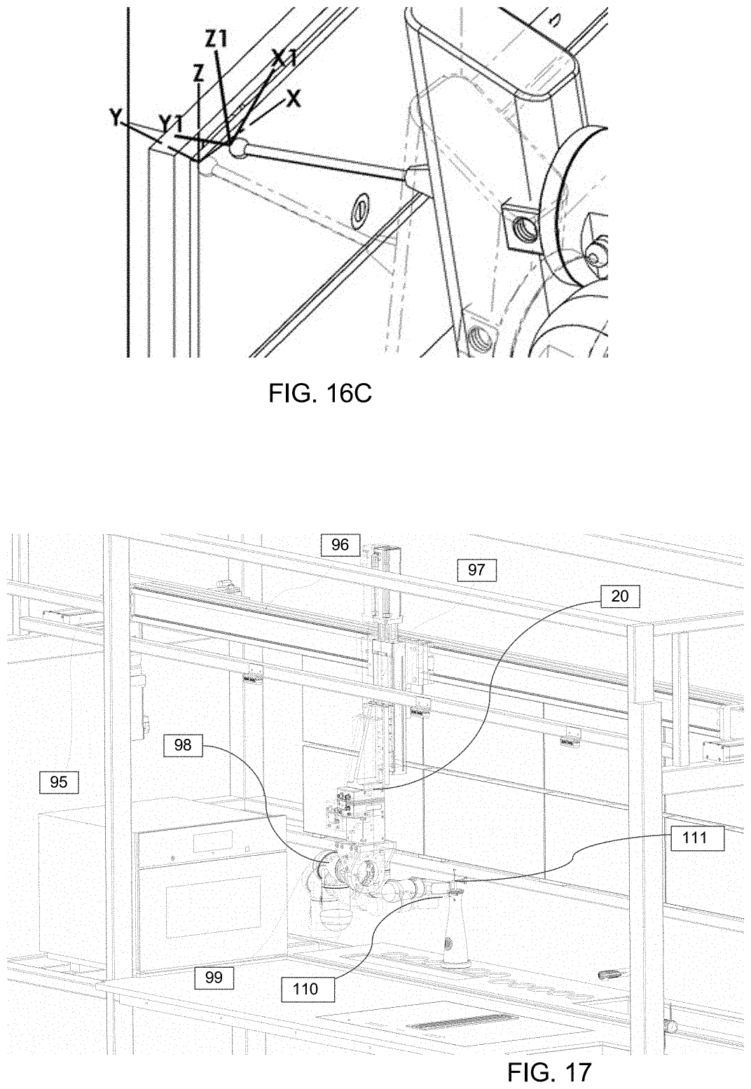

FIG. 16A depicts calibration of the robot automatic error tracking procedure. Every manufactured system can be flawed. The risk of inaccuracies in execution are eliminated using the following procedure. The robot is approaching a certain cartesian point in space 105 (X Y Z; R P Y), which is the robot configuration reference point, with certain robot joint state configuration 104. The feedback about the physical point positioning inside cartesian space comes from the probe 86. Then it is commanding different joint state values to all joints of the system to reconfigure robot joint state to the first probing robot configuration 101, with the certain probe position 102, Drawing identifies several axis and manipulators which are being reconfigured, X axis 96, Y axis 95, Z axis 97, rotational axis 99 and robot arm manipulator 98, however the procedure is applicable to different robot designs. Joints states are changing, however the goal is to keep the tip of the probe in the same cartesian space position. Desired position and orientation of the probe tip 103 (Xd Yd Zd; Rd Pd Yd) in first probing robot configuration 101 is known from the inverse kinematics. The physical position and orientation of the probe tip 103 (X1 Y1 Z1; R1 P1 Y1) is acquired from the sensors is then compared with the desired positions and orientation, which the X, Y, Z positions and the X1, Y1 and Z1 positions are illustrated in FIG. 16C. In case offset is present, the robot is not accurate, and has to be examined. In some cases offset of the position or orientation 103 can be planned, like it is visible on the drawing. Desired orientation shift is compared with the physical one based on the first. Automatic error procedure is excluding any reference model data, the robot is not accessing any etalon model points, it is calibrating itself automatically.

FIG. 16B depicts calibration of the robot automatic error tracking procedure, this time there is a planned position and orientation shift. The robot is approaching a certain cartesian point in space 108, (X Y Z; R P Y) and physical reference acquired by the probe 86 is saved. Cartesian position 108 is achieved with certain robot joint state configuration 106. Then it is commanding different joint state values to all joints of the system to reconfigure robot joint state to the first probing robot configuration 107, with the certain probe position 109 drawing identifies several axis and manipulators which are being reconfigured, X axis 96, Y axis 95, Z axis 97, rotational axis 99 and robot arm manipulator 98., however the procedure is applicable to different robots. Desired position and orientation of the probe tip 109 in first probing robot configuration 107 is known from the inverse kinematics. The physical position and orientation of the probe tip 109 is acquired from the sensors is then compared with the desired positions and orientation. Desired position and orientation shift is compared with the physical one based on the. Automatic error procedure is excluding any reference model data, the robot is not accessing any etalon model points, it is calibrating itself automatically.

FIG. 17 depicts calibration of the robot automatic position and orientation adjustment. Joint state positions in regards to all operational objects and crucial system fixtures has been recorded on etalon model kitchen. In etalon model referencing routing, in particular example visible on the figure robot 20 is approaching the bottle, so it is in “zero” position 110 (X Y Z; R P Y) in regards to the bottle. It is recording joint states of all joints in the system drawing identifies several axis and manipulators which are being recorded, X axis 96, Y axis 95, Z axis 97, rotational axis 99 and robot arm manipulator 98., however the procedure is applicable to different robots. After scaling the manufacturing, robot model n is produced. Automatic position and orientation adjustment procedure is then applied, the same joint state execution libraries recorded on the etalon model are compatible with robot model n. Robot 20 all joints are commanded with joint state position values previously recorded for bottle approach. The Cartesian position of the probe tip is then acquired 111 (X1 Y1 Z1; R1 P1 Y1). Offset between cartesian points in space between etalon model and robot n model is visible on the drawing. The shift is saved inside the system, positions and orientation shifts on each axis are applied to the actuators X axis 96, Y axis 95, Z axis 97, rotational axis 99 while the interaction with particular objects has been commanded by the system, in joint state execution mode in robot model n. Etalon model recorded and tested minimanipulations libraries can be executed in robotic system 1 . . . n. It is providing reliable scalability of the robotic system.

One of the most crucial parts of robotic kitchen are its storage areas. They work as tool changing stations. Cooking and cleaning the workspace are quite complicated processes with a lot of different objects involved, cookware, utensils, kitchen appliances such as hand blender, different types cleaning tools and the main one, cooking ingredients. Robotic kitchen has three storage areas providing the way to easily switch the tool while it is required for the operation. Each area has its specific functionality which allows the system to have more understanding of current situation inside. There are multiple types of storages, as an example three of them are listed in this document.

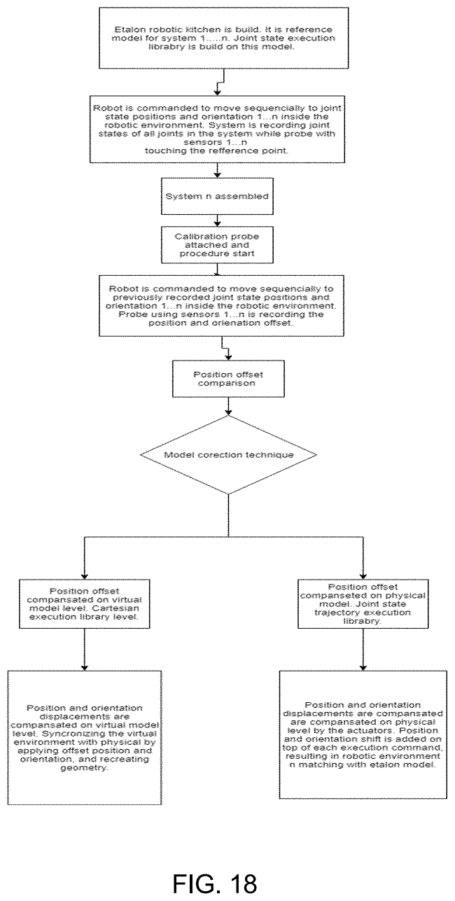

FIG. 18 is a calibration flow chart indicating sequence of operation during calibration in accordance with the present disclosure.

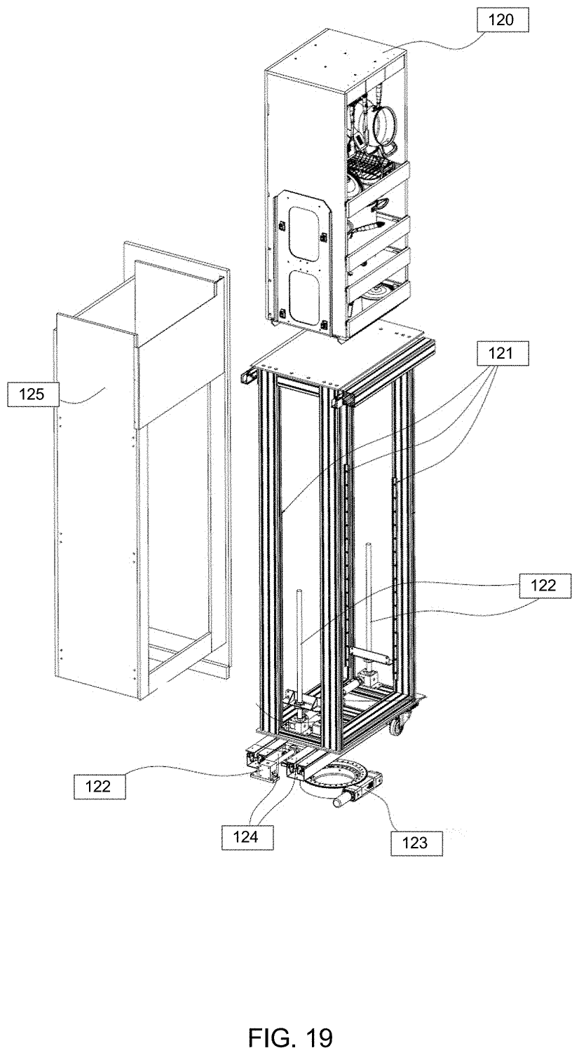

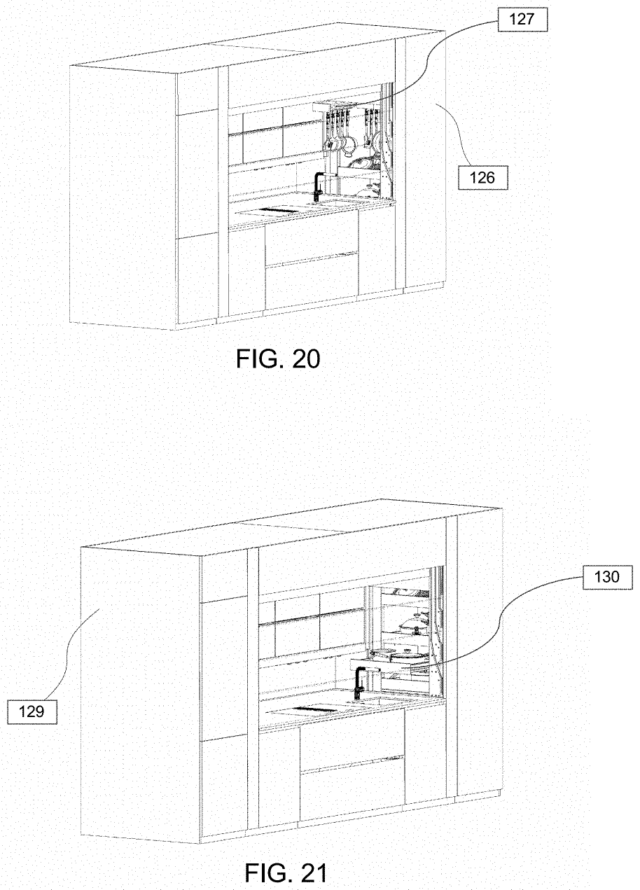

FIG. 19 depicts a tool storage is the place where all cooking manipulation equipment is stored 120. It is mounted on kitchen frame to ensure the high precision of the position. The drawing indicates actuator mechanisms, linear and rotary. Actuators can be of any types i.e., manual, pneumatic, hydraulic, and electric. Drawers, sensors, tool storage frame and panel body are visible. The tool storage comprises of many systems that supports the required functionality in robotic kitchen. There are many actuators to provide linear 122 and rotary 123 motion along or around many axes. Actuators can be of different types, along others pneumatic, hydraulic, and electric. To provide precise well supported movement of cabinetry with different velocities, guide systems 124 for all axes of motion has been incorporated inside. Frame 121 structure has been designed to support cabinetry 125 upon acting forces as well as system precision and repeatability. FIGS. 20 and 21 depict respectively a robotic kitchen system using motion systems which are allowing robot the access to grasping objects. The tool storage system is located in the lower position with the drawer extended into the kitchen cooking zone. In order to allow the system to be compact and maximize the functionality using minimum space tool storage has to be actuated in both directions horizontally in user mode and vertically in robot mode. Vertical actuators of any type i.e. hydraulic, pneumatic or electric allows up 126 and down 129 movement of the tool storage area. This motion is crucial for the robotic system as the dimensions of the tool changing station are more than the actual space accessible by the robot 127 128. By using this solution larger space of the utensil storage can be used. System is commanding to move up or down, to adjust itself before grasping operation. Robotic kitchen system is planning ahead which tool he needs to use, and system is then moved into accessible position, the space operable by robot is restricted, to maximize operational reliability adjustable cabinetry is introduced, commanding position depending on the tool that robot needs to use in certain scenario. In this way, system can use larger storage.

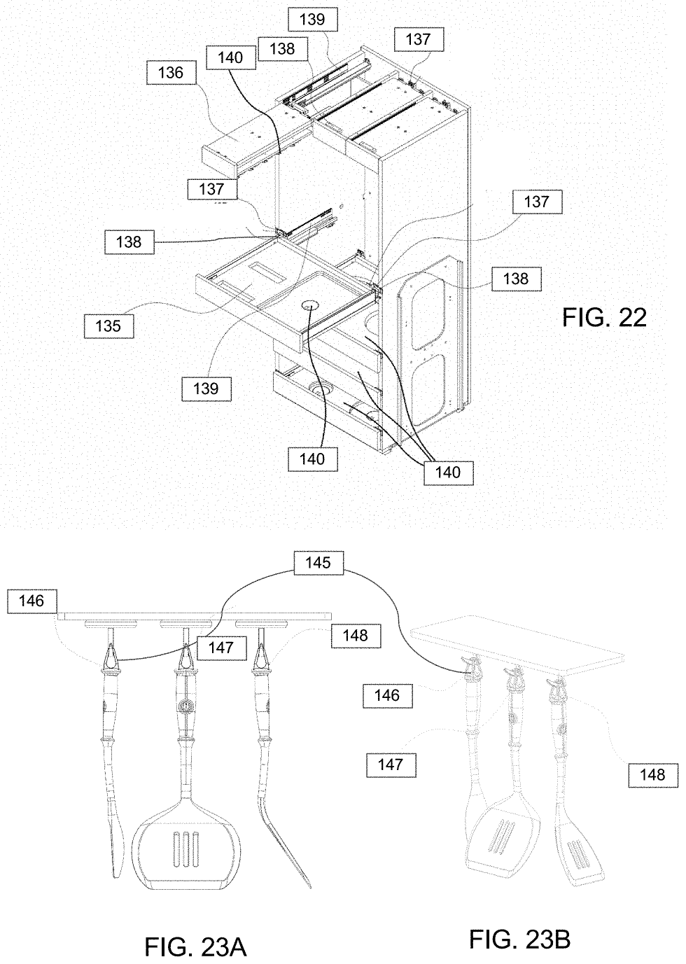

FIG. 22 depicts drawers where tools are stored 135 and hang on 136. Drawers are controlled automatically from the control system or manually. The tool storage inventory tracking and position allocation functionality is also visible. All drawers have automatic defined position systems using magnetic 137 or electromagnets with ferromagnetic interfaces 138. In case of using manual actuation, drawers need to have a defined position at the end of the stroke for the robot to rely on the Cartesian positioning of the objects inside the drawers to grasp them, the robot system can also use visual surveying to grasp objects reliably. Drawers also have limit switches integrated into the runners 139 to determine opened also closed position. Each drawer has linear actuator inbuilt into the runners 139 compatible with automatic and manual mode, it is able to extend the drawer to any position. Inventory inside tool storage system, and any other storage system inside robotic kitchen is being tracked by inventory tracking devices, each position inside the tool storage is defined 140.

FIGS. 23A and 23B depict a front view and an isometric view of a quadruple directional hook interface 145, respectively, designed to work with tools i.e. utensils and cookware. While the hook position and orientation may be stationary, orientation of a tool orientation can be changed easily due to the quadruple direction hook interface, which enables more reliable grasp in a challenging space restricted environment. This interface setup was designed to not restrict the robot and user from positioning the object in desired position and orientation, we can observe the object in different positions on the same hook, position 1 146, position 147, and position 3 148. It is essential for the robotic operation, as it is allowing the robot to access the tools from different orientation. It is especially important while operating in tight workspaces.

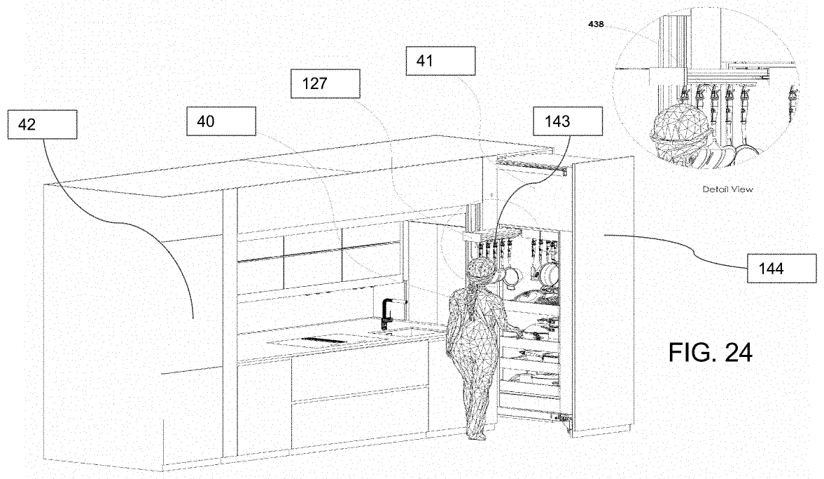

FIG. 24 depicts a user mode tool storage 41 in operation. The user mode tool storage 41 is acting as the piece of cabinetry; however, it has more functionality than the regular kitchen cabinet. The tool storage 41 is extended sideways using a linear actuation of any type: for example, pneumatic, electric, hydraulics or manual. A tool is passed to the user with the drawer position extended. The design of the tool storage area changes the way of cooking for a user 40. When the user requires the specific tool 143 to be used in the cooking process, he just informs the system about it using GUI 42 or voice command and system is passing this object to him 127, first it extends sideways 144 and then passing specific object using actuated drawers System is also passing automatically tools in recipe execution sequence, required tool is detected by inventory tracking system and then passed automatically based on recipe demand at exact required time. System is opening specific drawer 127 and indicating the pickup position 143 with light signal and voice command. Each drawer has its own opening actuating system. Signal is sent from the processing unit to trigger the opening of the drawer to allow the robot or human 40 user to grasp an object freely. Drawers can be opened both, automatically and manually.

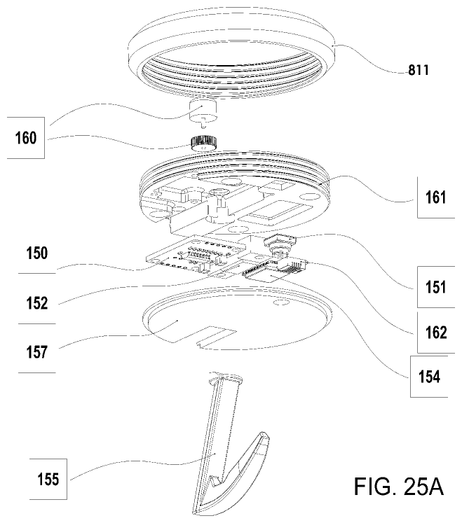

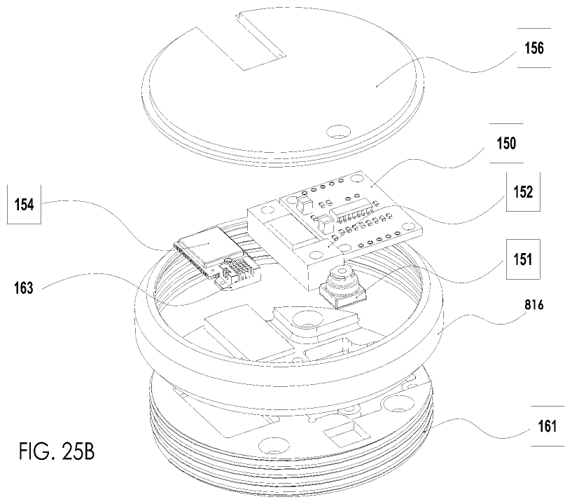

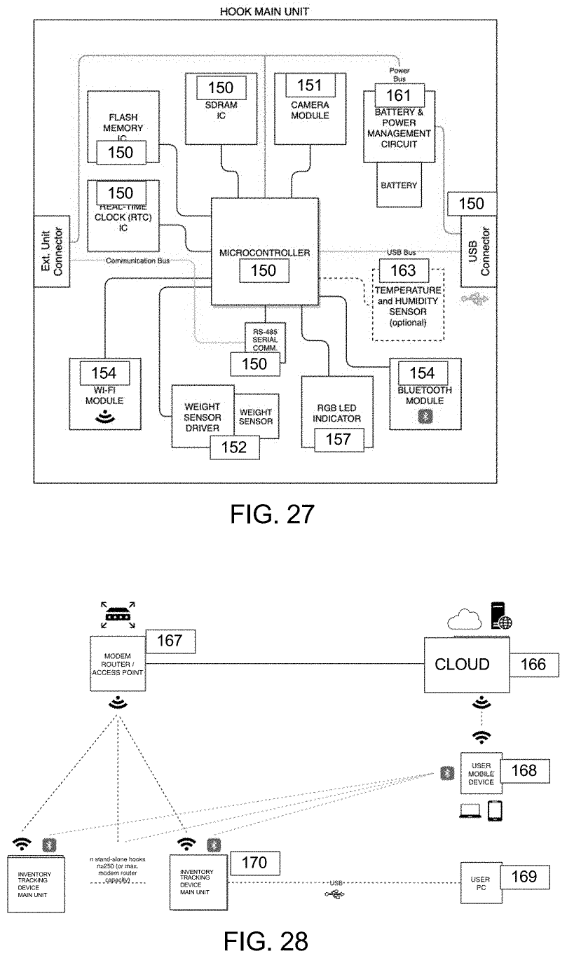

FIGS. 25A, 25B, and 27 depict an inventory tracking device system which is an automatic detection system for different type of objects. FIG. 25A is representing the inventory tracking device hook 155 and FIG. 25B is representing inventory tracking device base 156. System can understand multiple parameters about a given object such as its: ID, weight, colour, type etc. System is using multiple sensors to detect and determine those parameters, which are RFID readers 150, vision system 151, weight sensors 152 and more. Those sensors are placed inside specially designed base 161. The base is working as an attachment for the hook, worktop slots, refrigerator slots or any other type of defined placement. RFID tag reader integrated into 150, camera 151, weight sensor 152 among other sensors placed inside the base would recognize the ID of the object placed on the hook or on the base. Storage systems inside robotic kitchen comprises of multiple hooks and bases inside any system would be able to detect the presence and exact position and orientation of the object in the storage system. Human user or robot places the object on any desired hook in the storage area, and the system is automatically recognizing exact hook ID to determine the position. Each object will have a passive RFID tag, RFID tag reader would detect the object placed on inventory tracking device. The camera module 151 is located inside structure. The camera is tilted at an angle to observe the object hanging or placed on from the hook or base. Vision system will detect specific visual parameters such as: shape colour etc. and recognize the object type and ID. Camera system 151 comprises of smart camera processing unit. Using its functionality neural network is trained to recognize specific type of the object and output the specific object type that is currently present on the hook. The system can be trained with any object placed on the hook. Each object needs to be registered to the system with specific known weight. This information of the exact weight of a specific object with specific ID will be stored in the system internally or externally on data base. Once the object is placed on inventory tracking device it is detecting the object ID by comparing the current reading of the weight sensor 152 to the one stored in database. Described technologies, are integrated inside the inventory tracking device base with one PCB 150 environment, where CPU is also integrated, which is responsible for processing the signals from the sensors and for controlling the actuators and indicators. External communication modules i.e. Wireless (i.e. bluetooth or wifi) module 154 and USB module integrated onto PCB 150 for wired and wireless communication are passing data to external systems. LED light 157 acts as a indicator for the position. In case user have several objects on inventory tracking device and wants to locate the specific one, external system can communicate to all inventory tracking devices in the network that it is looking for the specific type of object. Inventory tracking device that holds this objects can activate the LED light. Lightning system can also be used for indicating that the weight currently on the inventory tracking device base is exeding the nominated weight. It can blink fast in red, as the led lights color can be controlled. UV light 157 is also integrated onto the system, it can sterilize the object that it holds when requested, or automatically, when vision system recognizes need to sterilization. Each inventory tracking device has an actuator 160 which can rotate the hook so it can adjust its position as requested with 360 degree motion, also lower the hook to desired position for the user. When external system commands the hook number and position actuation, CPU 150 is passing position requirements to the actuator 160. Changing of the hook orientation can be observed on. External system can access each inventory tracking device via communication module either wired 150 or wireless 154. In case of wired communication, the system is using cable interface, for power and data. In case of wireless communication, unit needs to be charged, it has a battery module 161 inside. Wired communication and charging can also be performed using USB interface 150. Inventory tracking device will include temperature and humidity 163 sensor. The different environment parameters can be tracked by the inventory tracking device reliably. This system can be applied to all storage types i.e. drawers, hooks, hanging rails.

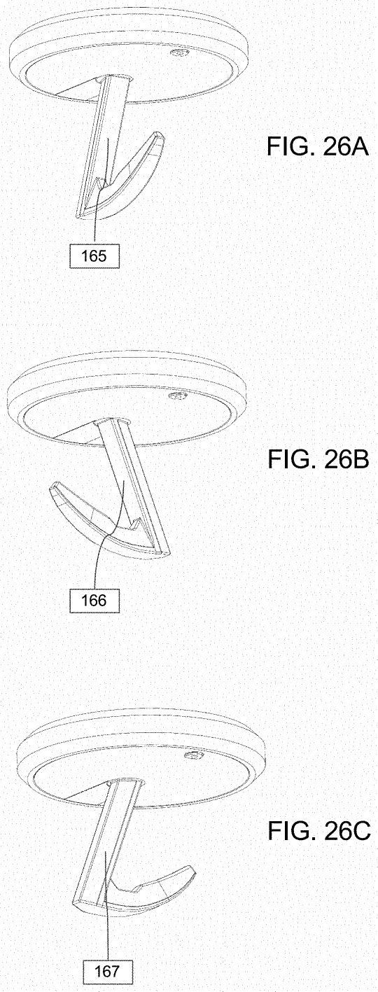

FIG. 26A, FIG. 26B, FIG. 26C, depicts actuated hook principles of operations. Hook can rotate or be linearly moved to the requested position. Rotary actuation from initial position 165, clockwise with 90 degree rotation 166 and counter clockwise with 90 degree rotation 167. The hook actuation is used to maximize ease of approach for the robot and human user.

FIG. 27 depicts the use case for the connection of inventory tracking device. There is a cloud server 166 which connects with modem or access point 167. Inventory tracking device 170 is connected wirelessly or wired to the access point. Inventory tracking device can be accessed through user PC 169 as well.

FIG. 28 is a system diagram illustrating inventory tracking device example communication architecture. Users are enabled to understand every single object position at his home in real or requested time. We can also understand and control and information parameters such: temperature sensors data, humidity sensors data, position sensors data, orientation sensors data, weight sensors data, camera sensors data, light control illumination for particular placement, electrical and mechanical Lock/Unlock storage units, time stamps of object placement/changing, multi modal devices sensors data, RFID/NFC sensors data, actuators control for each placement, other available sensors and control data. All these functions can be accessed via API's and can be integrated with any system 166. For example smart home systems.

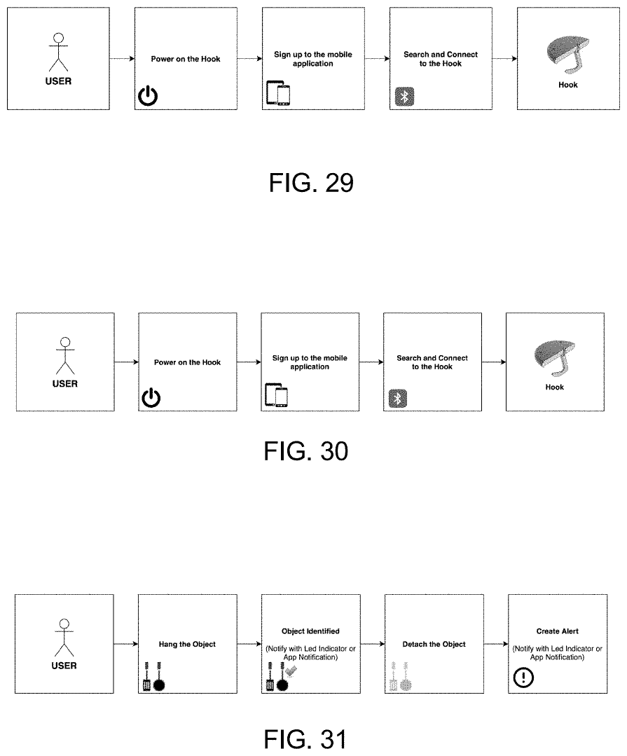

FIG. 29 is a system diagram illustrating one embodiment of an inventory tracking device for product installation in accordance with the present disclosure.

FIG. 30 is a system diagram illustrating one embodiment of an inventory tracking device for object training in accordance with the present disclosure.

FIG. 31 is a system diagram illustrating one embodiment of an inventory tracking device for object detection in accordance with the present disclosure.

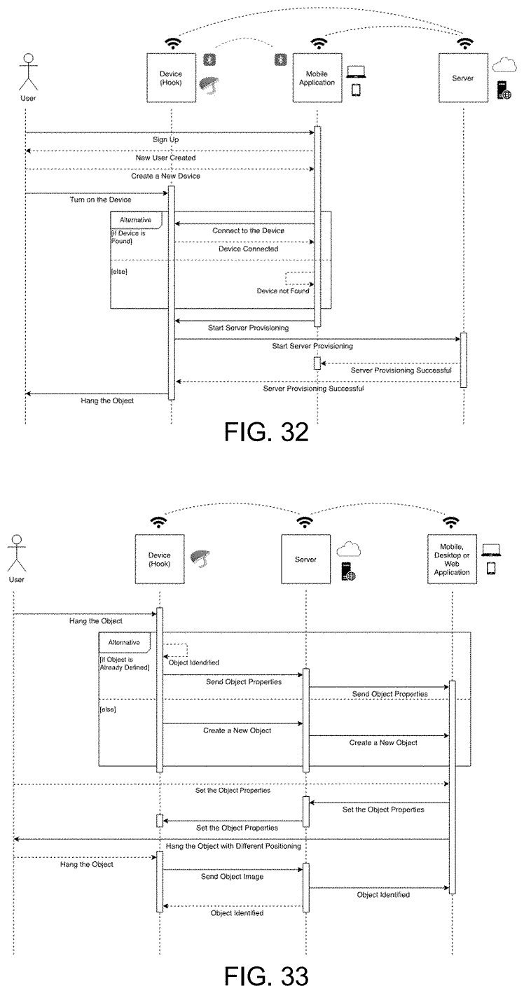

FIG. 32 is a system diagram illustrating one example of an inventory tracking device on the sequence behaviour for product installation in accordance with the present disclosure.

FIG. 33 is a system diagram illustrating one example of an inventory tracking device on sequence behaviour for object training and detection in accordance with the present disclosure.

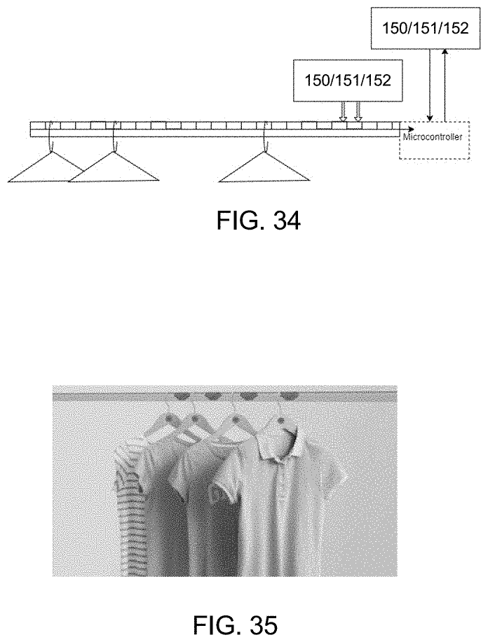

FIG. 34 is a system diagram illustrating one embodiment of a smart rail system in accordance with the present disclosure. In robotics kitchen application this would help the system to check the inventory state in real-time and also enabling the robot to understand the exact position of specific object, similar functionality could be used in shops, warehouses, laundry facilities, manufacturing facilities among many others. Any inventory tracking could be performed using this system. For instance, there are several options that this system could be applied to significantly improve the processes in the retail industry. Clothes would be placed on hangers. RFID tags would be placed either in the cloth label or on the hanger. RFID tag readers would be placed inside the actual rails. Rails would also comprise of cameras, weight sensors and RFID tags to recognize the objects. All objects parameters (shape, colour, weight etc) can be recognized by the system and assign to specific object ID and type. Robotic system can operate and interface with any ingredient storage system.

FIG. 35 depicts one example on the functionality of a smart rail system in accordance with the present disclosure.

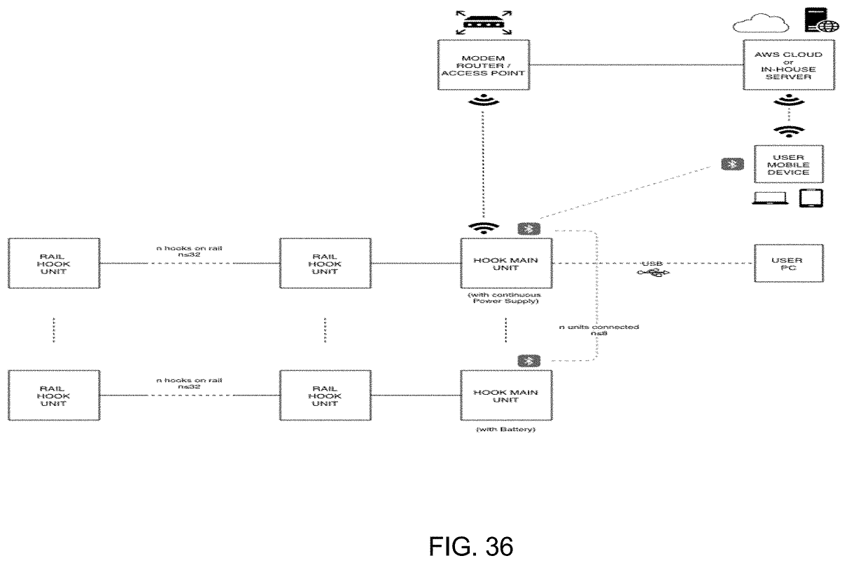

FIG. 36 is a system diagram illustrating one embodiment of a smart rail device example communication system in accordance with the present disclosure.

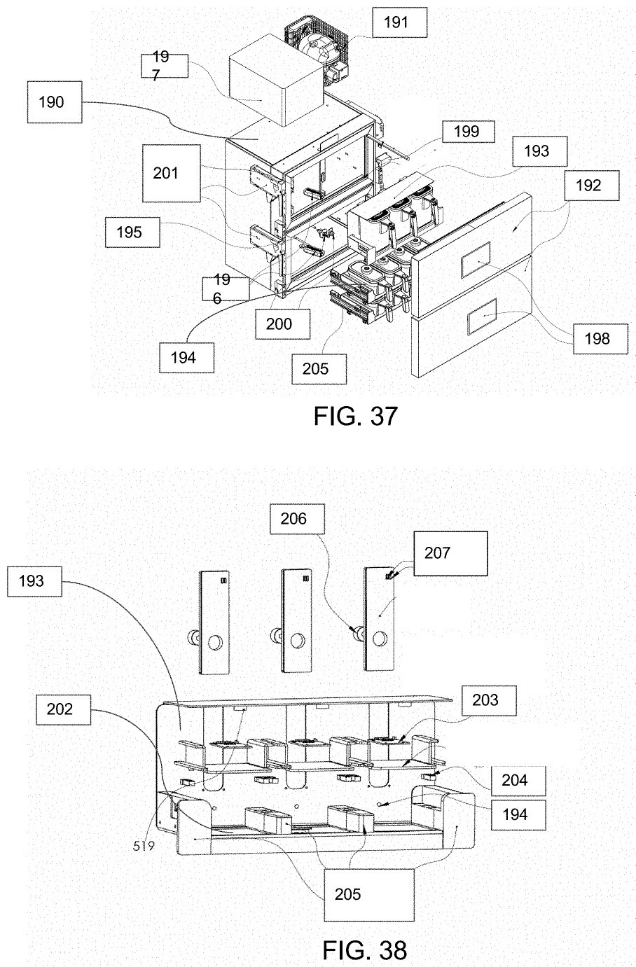

FIG. 37 depicts a smart refrigerated 190 and non-refrigerated ingredient storage 190 system exploded view, which is crucial for recipe execution. Refrigerated ingredient storage system is the storage place for ingredient storing containers. There are several requirements that ingredient storage system need to meet for robotic system compatibility There are several container sizes, each suitable for different ingredient groups, depending on the sizes. Ingredient storage doors 192 can be opened automatically as well as manually, using special adapted dual mode hinges 201, which creates the opportunity to fully automate the process in robot mode. In user operating mode user can ask the system to hand over the specific ingredient to him, because of automatic compartment opening, linear motion and LED indication for each container slot. User will easily understand which container needs to be used while performing recipe cooking. The container needed to be used will be passed the container on the exact time: doors of the ingredient storage 192 will automatically open, tray 193 will automatically extend using linear motion mechanism 200, and LED under container slot will be powered 194. UV light 195 which can perform sterilization procedure inside the refrigerator, either on user request or automatically, using data from camera 196 to determine when sterilization is required.

Each ingredient storage compartment has its own independent processing unit 197 which processes data from all sensors, commands actuators and indicators and exchanges information with other systems. In user mode, user is enabled to control and monitor the refrigerator via GUI 198 or externally i.e. using his phone. System has a compartment locking system 199. User can lock and unlock each compartment whenever needed.

FIG. 38 depicts adapted trays 193 that support the different container sizes. Each container has its slot 202. The refrigerator needs to be aware of the container presence, there are different sensors that indicate its presence. System is using a different type of sensor system: RFID detection 203 or vision 196 to be aware which position is filled with a container storing a certain food type. When a container is placed on the slot, sensors are triggered about environment change and the sensors are performing an ingredient recognition process. RFID tag reader 203 is detecting the data from the RFID tag. Which should comprise of ingredient type, parameters, and expiration date. Vision system 196 inside the fridge is making sure the ingredient type is correct. Each slot is equipped with weight sensors 204, system is always aware of amount of the ingredient inside the container. It allows the robot to perform cooking operation with correct ingredients and correct measures. To allow easier passing of the ingredient containers to user and robot.

FIG. 37 depicts fridge system. In operation, when system understands that certain container needs to be picked, it is sending the signal to appropriate actuator, which first opens the doors 192 then, it is sending the signal to appropriate actuator 200 which controls the motion for tray that desired container is placed on. The tray 193 moves forward to a defined position allowing the robot and user to reach and grasp the containers, easily without any obstructions, from other trays mounted on top or bottom. To maximize the repeatability of the container position within the tray structure, the guides for container sliding positions 205 are making sure that even slightly disoriented container is eventually end up in correct position and orientation, known by the robot. Another factor maximising the repeatability of the container position is magnetic-ferromagnetic or electromagnetic-ferromagnetic 206 interface between the food ingredient container and back wall of the refrigerator. Magnet on the back of refrigerator is pulling the ferromagnetic part mounted on the container towards it. This functionality assures repeatability of the position.

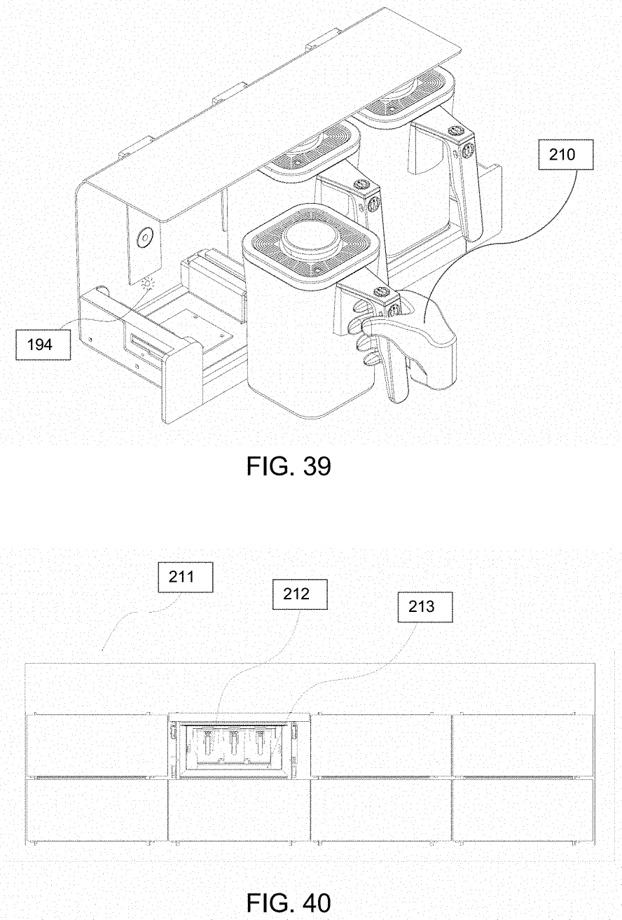

FIG. 39 is a system diagram illustrating a user grasping of a container 210 from container tray, with a light-emitting diode (LED 194) light projected on the position of the container in accordance with the present disclosure.

FIG. 40 is a visual diagram illustrating a refrigerator system 211 with an integrated container tray 212 and a set of containers 213 in a robotic kitchen in accordance with the present disclosure.

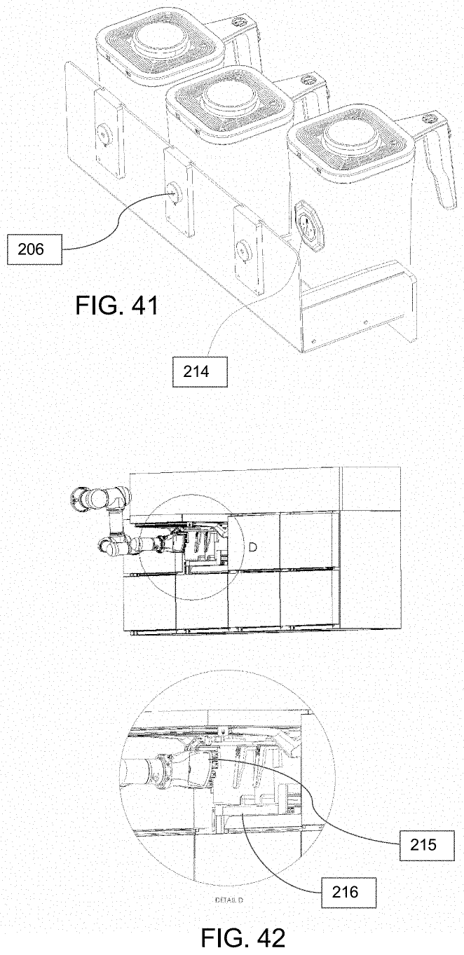

FIG. 41 is a visual diagram illustrating one or more containers with ferromagnetic part 214 placed on the tray with electromagnet 206 auto positioning functionality in accordance with the present disclosure.

FIG. 42 is a visual diagram illustrating the operational compatibility 215 representation with robot and a human hand. Containers placed inside the refrigerator system can be operated freely by anthropomorphic hands in accordance with the present disclosure. Tray is visible in extended position 216.

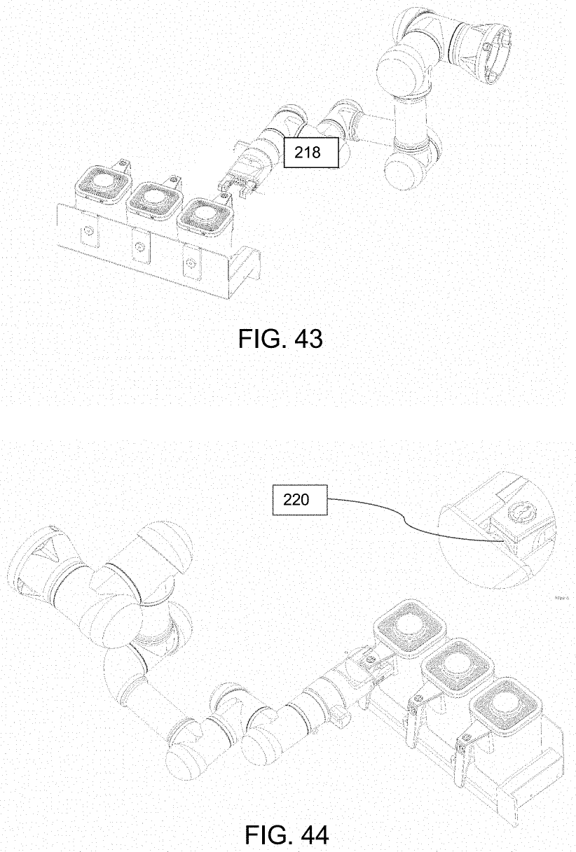

FIG. 43 is a system diagram illustrating the operational compatibility with a gripper 218 type (for example, parallel and electromagnetic) in accordance with the present disclosure. In the example, containers placed inside the refrigerator system can be operated freely by an anthropomorphic hand.

FIG. 44 is a system diagram illustrating a robotic system gripper with an electromagnet grasping 220 and operating one or more containers in accordance with the present disclosure.

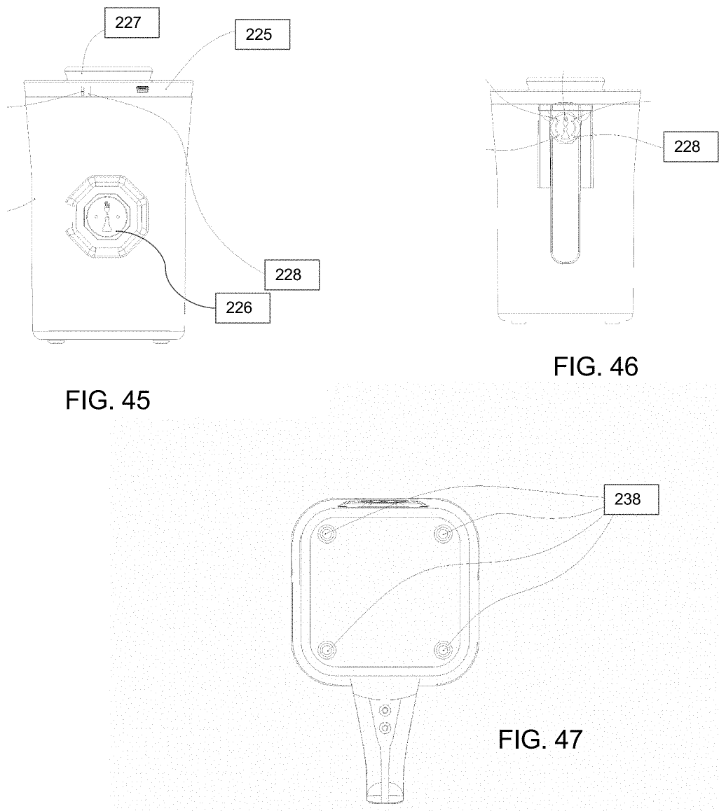

FIG. 45 is a visual diagram illustrating the back of a container with a lid 225 and a push button 227 in a closed position in accordance with the present disclosure. An automatic positioning ferromagnetic part 226 and power contacts 228 are visible.

FIG. 46 is a visual diagram of a coupler for robot gripper, with terminals for power 228 and data exchange, in accordance with the present disclosure.

FIG. 47. is a system diagram illustrating the bottom view of the container. A weight sensors 238 inside the feet of the container are visible.

Smart container, with variety of sizes to match all kinds to food sizes, has numerous sensors and actuators to fulfil wide functionality. This invention document will explain in depth what are those sensors and actuators and what purpose they are serving. All “smart” components are placed inside the containers lid, the most in depth drawing of the lid assembly can be found on

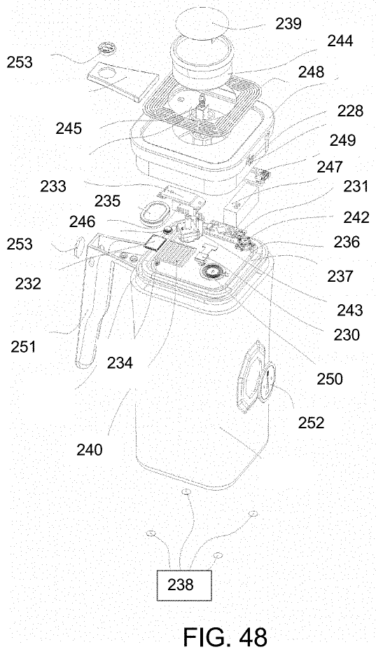

FIG. 48 depicts a smart container system. Camera 230 enables smart container to understand what ingredient is currently inside. It is mounted on the lid and pointed towards bottom of the container to see what it is inside. It can log the time of placing the ingredient inside the container to microprocessor 231 and inform the user that expiry date is coming to an end. It is able to monitor visual state of the ingredient, colour of ingredient inside the container indicating potential decaying of ingredient. It is also able to monitor the light intensity, which often has high effect on quality of the ingredients. It is able to recognize what exact ingredient has been placed inside the container. The camera is able to perform the process which is going to automatically assign the food to the container it is in. User is placing ingredient inside the container, then camera reading is passed to microprocessor 231 external data communication interfaces 232 are passing the data to the cloud, which is performing recognition procedure and passing data back to the container for it to understand what is currently inside the container. external communication data interfaces 232, are crucial in smart functionality of the container. They are providing the actual communication with the cloud and the user. Most operations which require high-computing power are performed on the cloud level, such as image recognition, data login etc. Container has multiprotocol communication system inside: Bluetooth, Wi-Fi, ZigBee, radio etc. Cloud server has the database of whole world's ingredients available. It knows all parameters about the food: ideal colour, temperature, humidity, light conditions to store the food, maximum storing time etc. It can feed all those information's back to the container, the container CPU can crosscheck and compare with conditions currently present inside the container, such as: temperature, humidity, light environment etc. Using external communication interfaces 232 it can also acquire the information about the time period that certain ingredient can be storeds for. This parameter would be saved on container microprocessor 231. When the expiry date would approach closer, external communication modules 232 would inform the container user about how much time left to consume the ingredient. Parameters such as ideal temperature, humidity and light inside the environment are crucial for the good quality of the food. Container has the sensors that can provide real life feedback loop for those parameters, to make sure that food stays up to highest quality. Inside container lid, there is a temperature and humidity sensor 233 and Light sensor 234, which are able to monitor the temperature, humidity and light reading inside the container. It is then passing the readings to systems CPU 231. System is able to log in those parameters along with the time of the reading, to give the history of readings when those would need to be accessed. It also understands what ingredient is placed inside; it can warn the user that the temperature is not appropriate for specific ingredient. User is always able to access the real-time data that indicates, what are crucial parameters of the environment that food is stored in, and check if these are ideal for it. Container is also able to make sound indication when any of those parameters are not right using integrated speaker 235 or LED lights 236 inbuilt into the lid. Those two indicators can be helpful to people with different kinds of disabilities. LED light inside the lid of the container is also giving a lot of aesthetic value for presenting the food inside the container. All parameters of the light such as density, colour etc. can be adjusted easily by the user, or adjusted automatically by CPU 231 and camera 230 readings to match with the environment. For example, after light sensor 234 or camera 231 reading is changing dramatically, from bright one to darker one (refrigerator to dark kitchen at night) microprocessor 231 is triggering powering of LED's, then environment inside the container is enlighten for the user. LED lights 234 are also heavy support for camera 231 functionality in case the environment is too dark to recognize the ingredient inside the container can easily enlighten the environment to perform robust image recognition process. Another light system inside the container which support very crucial functionality are UV lights 237, which are mounted inside container lid, and pointing downwards to container body. User is enabled to run the sterilization process when ingredient has been removed from the container. It is able to detect that automatically, using its weight sensors 238 and camera 231, after the reading value has been changed, CPU 231 is going to ask the user, via cloud interface or physically, using sound signal 235 and indication on GUI screen 239 if the container has been cleaned after removal of the ingredient, based on user answer, sterilization process can run, UV lamps are going to be powered, and environment inside the container sterilized. Another sensor responsible for monitoring quality of the food is the food freshness sensor 240 the detection of volatile compounds with chemical gas sensors is can be reliable way for non-destructive way of determining the foods quality. The best results in maximizing the time period of food freshness could be achieved using vacuum inside the environment where the food is being kept. There is automated vacuum pump 242 inside the containers lid. There is a small hole to keep the air going in and out of the container. Using this component, user can command the container, using GUI touchscreen 239 or wireless communication interface 232 to remove the air, automatically from the environment. There is an air pressure sensor 243 that creates feedback loop for the automated vacuum pump to inform the system if vacuum sealing process was successful, and it is constantly monitoring if the pressure is kept on required level. In conjunction with camera 230 monitoring, data of ingredient entry time and date, temperature and humidity sensor 233 and light level sensor 234 monitoring, there is a strong case that food is going to be kept in high quality.

Lid button 244 placed on the container lid, it can be actuated by human user manually in order to open the container by pushing on it, however, user can also actuate the opening automatically, triggering the opening sequence using touchscreen 239, in this case actuation is performed by an actuator 245. Linear actuator is providing the tool for automated opening and closing as well as locking. Mini actuator providing linear movement is required for releasing the lid form the container body. In this case, once user has triggered automatic opening sequence, container cannot be opened manually, it can only open automatically, and triggering this event can be done only with prior authorization. The authorization can be done using GUI touchscreen 239, by entering password, or can be done using fingerprint sensor 246, this sensor can be either inbuilt inside the GUI touchscreen 239 or can be integrated into the system as separate component. In order to power all components in the system, container comprises of battery 247. There are several ways to charge the battery in smart container. There is a solar cell 248, 24V and 0V power terminals 228, USB interface 249, wireless charging module 250. To make the containers easier to operate, all container sizes have custom designed handle 251, and markers 252 253 which is compatible with human operator as well as robot operator. Robot can use several types of grippers such as: parallel gripper, electromagnetic couplers, robotic hands etc.

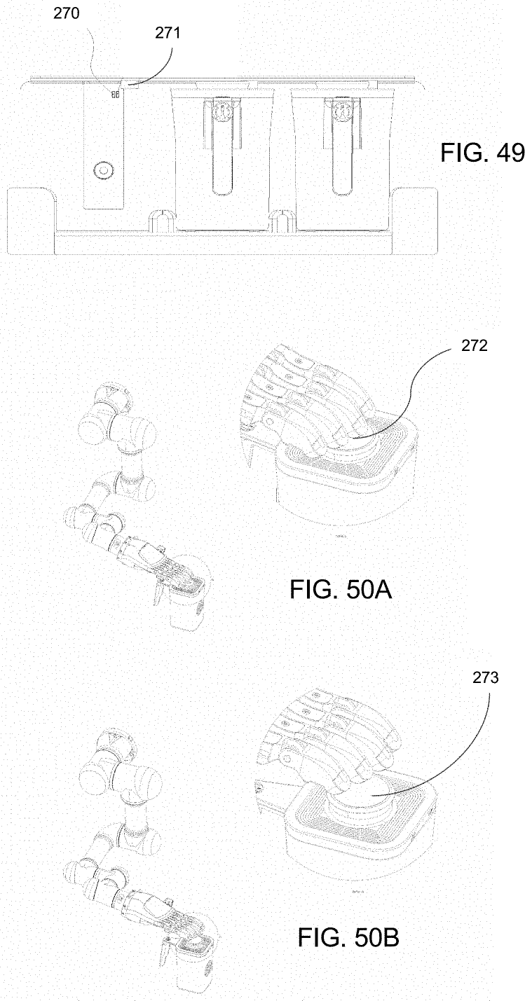

FIG. 49 is a system diagram illustrating an automatic charging station inside the tray for containers, with Physical contacts 270 and wireless charging modules 271, in accordance with the present disclosure.

FIG. 50A is a system diagram illustrating a robot actuating to push to open a container lid mechanism, with a visible closed position 272, in accordance with the present disclosure.

FIG. 50B is a system diagram illustrating a robot actuating the push to open a container lid mechanism, with a visible open position 273, in accordance with the present disclosure.

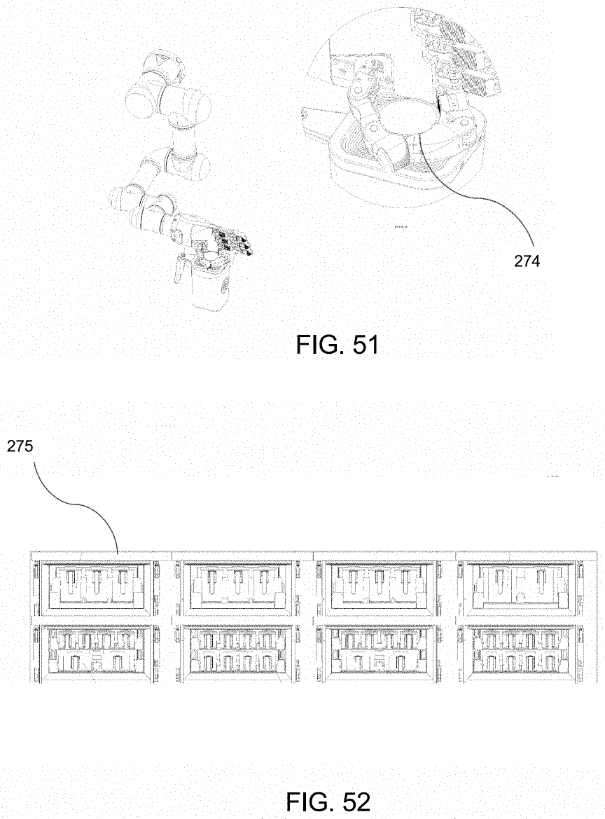

FIG. 51 is pictorial diagram illustrating an exploded view of a robot end effector compatibility 274 with a lid handle operation in accordance with the present disclosure.

FIG. 52 is a system diagram illustrating the different sizes of containers 275 inside the robotic kitchen system refrigerator in accordance with the present disclosure.

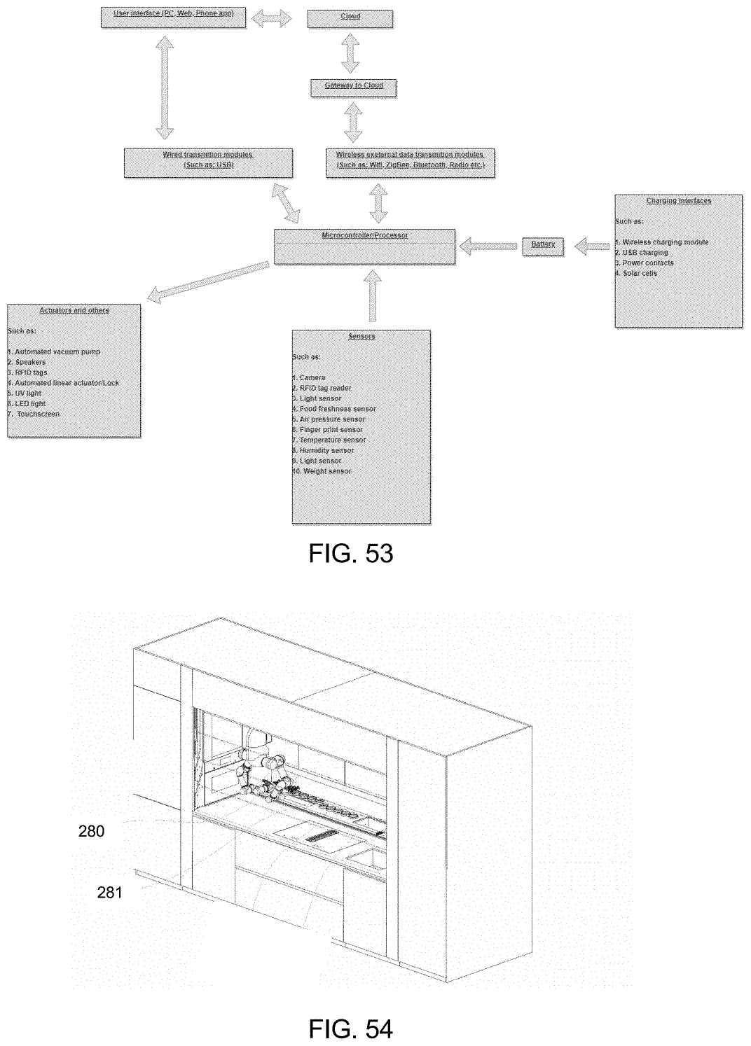

FIG. 53 is a block diagram illustrating overall architecture of the refrigerator system in accordance with the present disclosure.

FIG. 54 is a system diagram illustrating a generic storage space with inventory tracking, position allocation and automatic sterilization functionality 280, with an automatic hand sterilization procedure, in accordance with the present disclosure. Inventory tracking device base 281 is visible.

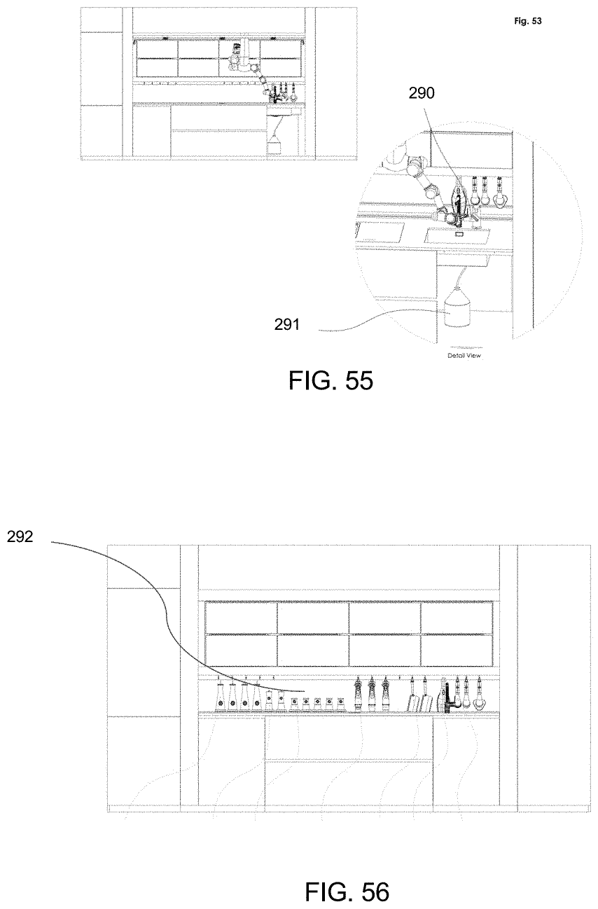

FIG. 55 is a system diagram illustrating a robotic kitchen environment sterilization equipment, with an automatic hand sterilization procedure in accordance with the present disclosure. The robotic kitchen environment sterilization equipment includes various types of cleaning tools 290, with a sterilization liquid tank 291 with automated and manual dispensing vision system responsible for detecting dirt inside the environment and adapting sterilization procedure.

FIG. 56 is a visual diagram illustrating a robotic kitchen in which one or more robotic kitchen equipment 292 are placed inside and under refrigerator storage in accordance with the present disclosure.

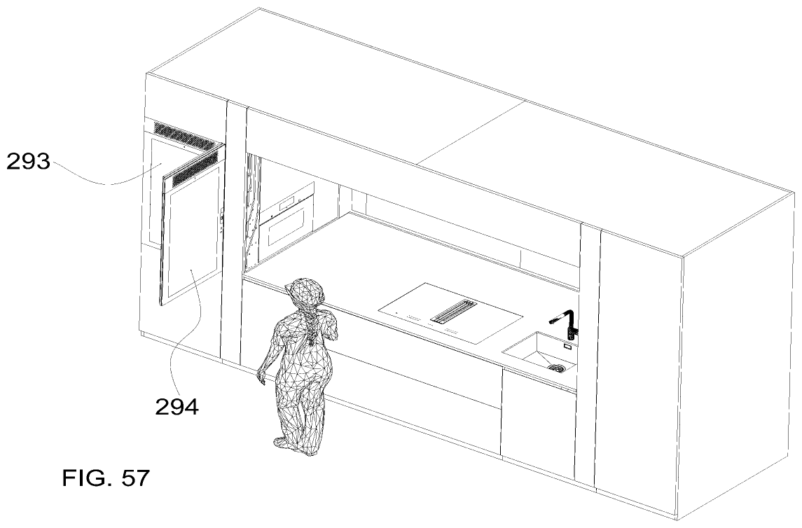

FIG. 57 is a visual diagram illustrating a human user operating a graphical user interface (“GUI”) screen in accordance with the present disclosure.

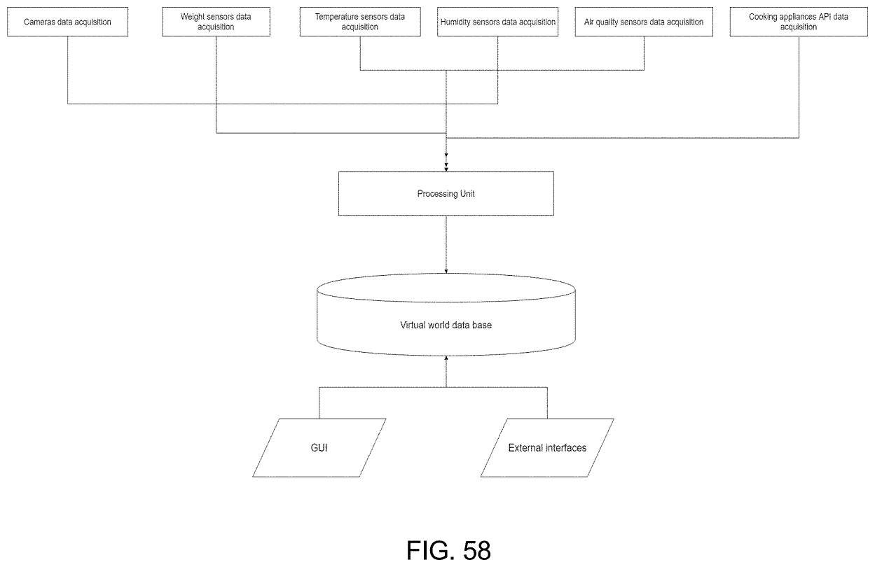

FIG. 58 is a system diagram illustrating a virtual world real time update data stream diagram in accordance with the present disclosure.

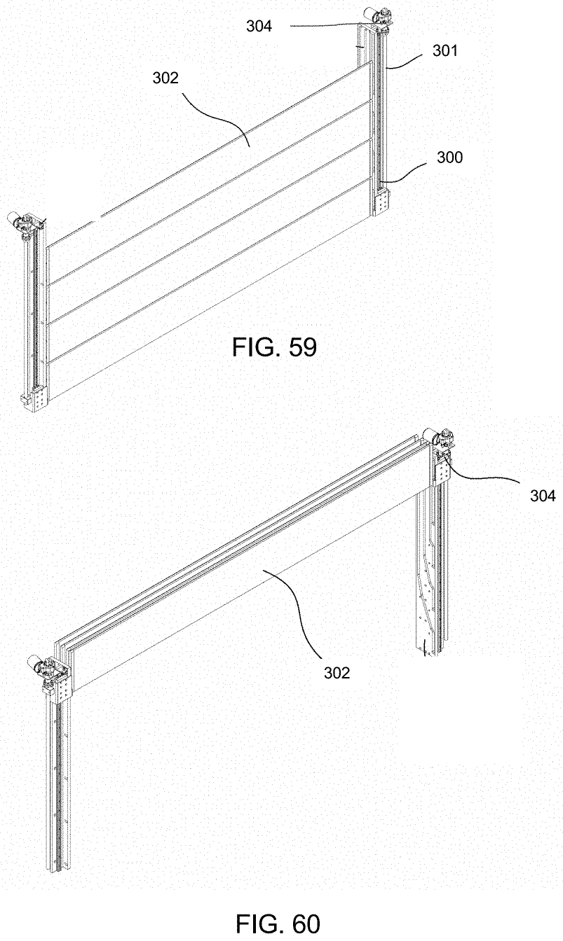

FIG. 59 is a visual diagram illustrating automated safeguard closed position (of a robotic kitchen) in accordance with the present disclosure.

FIG. 60 is a visual diagram illustrating a system with an automated safeguard opened position (of a robotic kitchen) in accordance with the present disclosure.

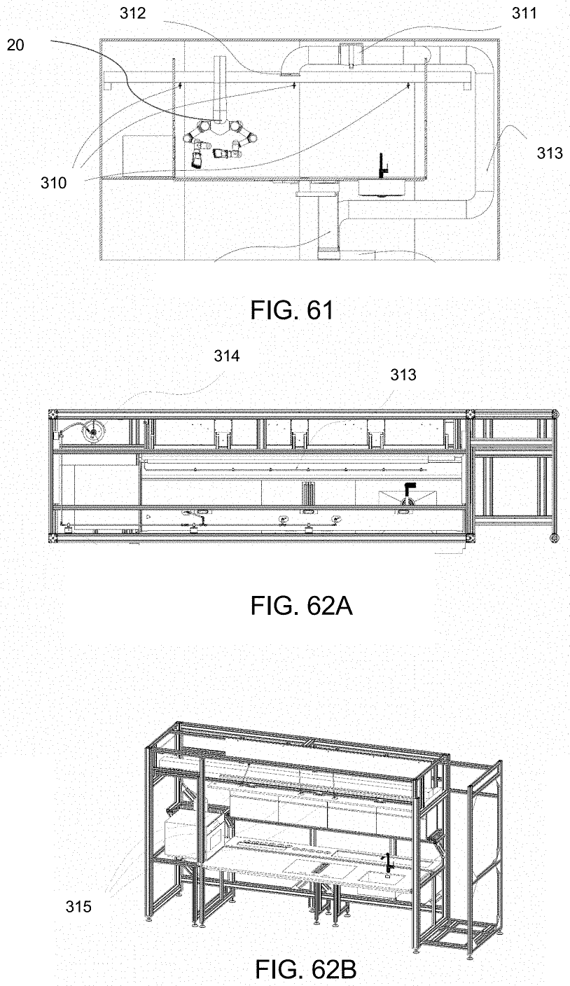

FIG. 61 is a block diagram illustrating a smart ventilation system inside of a robotics system environment in accordance with the present disclosure.

FIG. 62A and FIG. 62B is a block diagram illustrating a top view of a fire safety system along with the indications of nozzles 315 and fire detect tube 313, agent bottle 314 in accordance with the present disclosure.

In one embodiment, a manipulation system in a robotic kitchen includes functionalities as to how to prepare and execute a food preparation recipe, macro manipulation, micro minimanipulation, action primitive, other core components, how a manipulation uses parameter mapping to action primitives, how a system manages default postures, how a sequence of action primitive is executed, a macro/micro action primitive, a micro posture, how the system in a robotic kitchen works with pre-calculated joint trajectories and/or with planning, and the creation process with reconfiguration, as well as elaboration on manipulation to action primitive (AP) to APSB structure.

In one embodiment, a robotic kitchen includes N arms, i.e. the robotic kitchen comprises more than two robot arms. In one example, the robotic arms in a robotic kitchen can be mounted in multiple ways to one or more moving platforms. Some robotic kitchen examples include: (1) three arms single platform, (2) four arms single platform, (3) four platforms and one arm per platform, (4) two platforms with two arms per platform, or any combination and additional extensions of N arms, M platforms. Robotic platforms and arms may also be different, such as having more or less degrees of freedom.

In default postures, robot default postures are typically defined for each robot side: left, right, or dual. Other robotic kitchens may have more than two arms, represented by N arms in which in case a posture for each arm can be defined. In one embodiment of a typical robotic kitchen, for each side, there is a list of possible objects, and for each one object there is one and only one default posture. In one embodiment, default postures are only defined for arms. Torso is typically at predefined centre rotation and height and the horizontal axis is decided at runtime.

An empty hand could refer to a left side, a right side, or a dual side. Held objects can also be on the left side, the right side, or the dual side.

A manipulation represent a building block for a food preparation recipe. A food preparation recipe comprises a sequence of manipulations, which could occur in sequence or in parallel. Some examples of manipulations: (1) “Tip contents of SourceObject onto TargetZones inside a TargetObject then place SourceObject at TargetPlacement”; (2) “Take Object from current placement and place at TargetPlacement”; (3) “Stir ingredients with a Utensil into a Cookware then place Utensil at Target Placement”; and (4) “Select the Temperature of the CombiOven”. Each manipulation operates on one or more objects and has some variable parameters to customization. The variable parameters are usually set by a chef or a cook at recipe creation time.

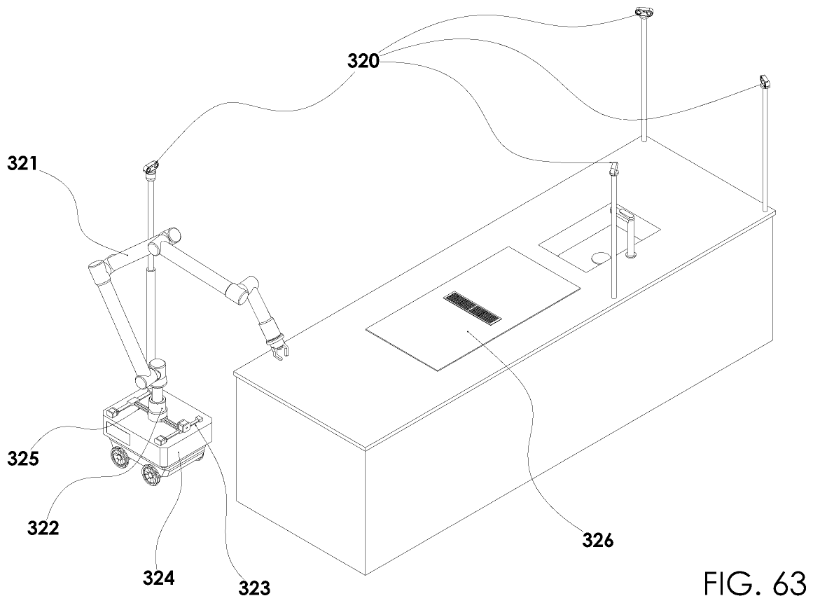

FIG. 63 system diagram illustrating mobile 324 robot manipulator 321 interacting with the kitchen. System sensory data is acquired from sensors 320, robot manipulator is placed on gantry system with X axis 325, Y axis 323, telescopic Z axis 322.

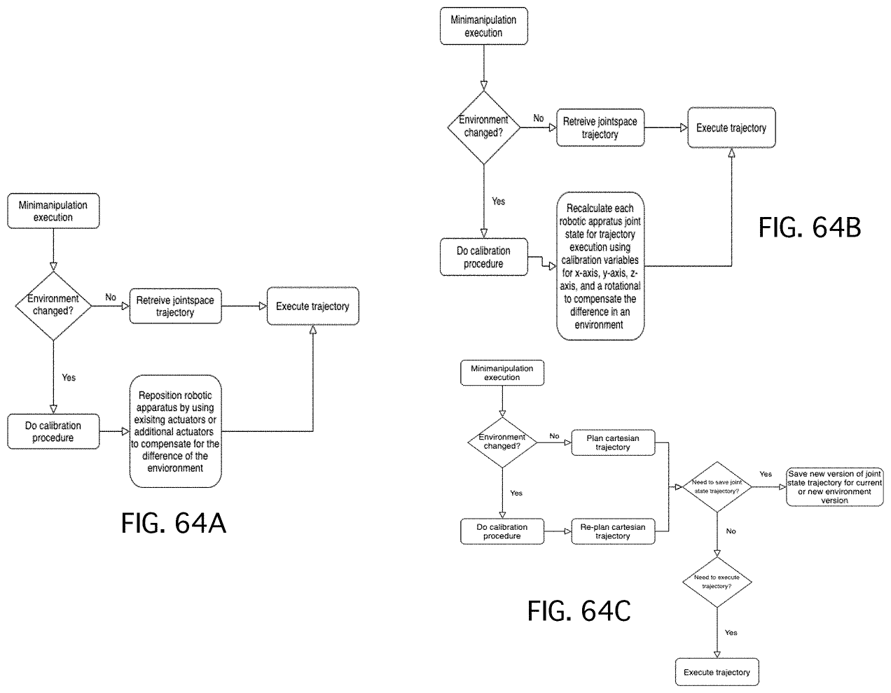

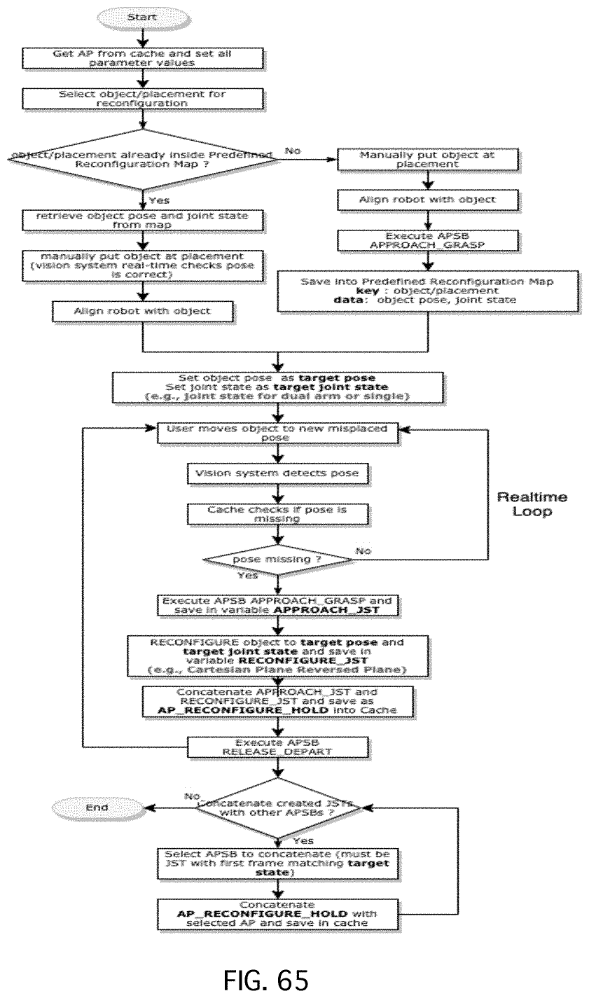

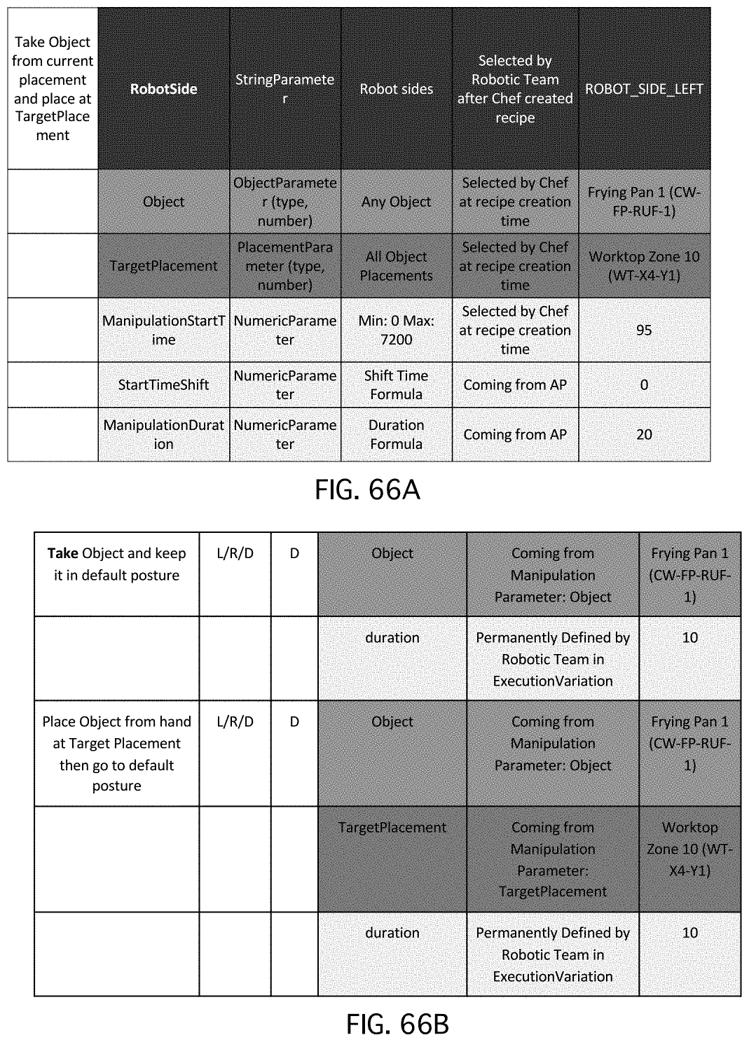

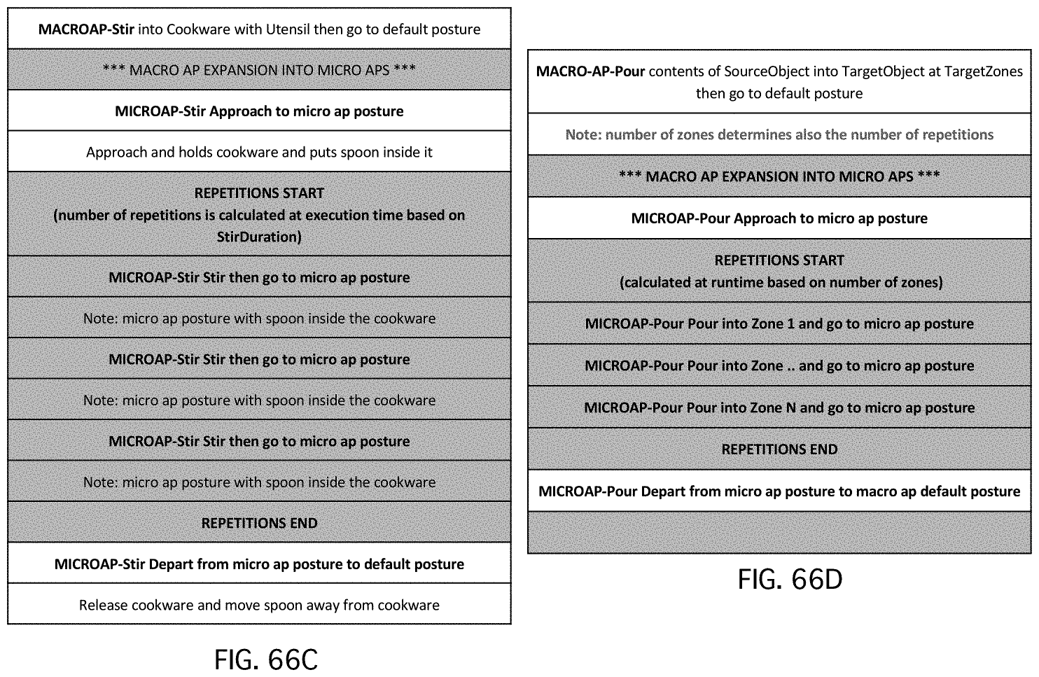

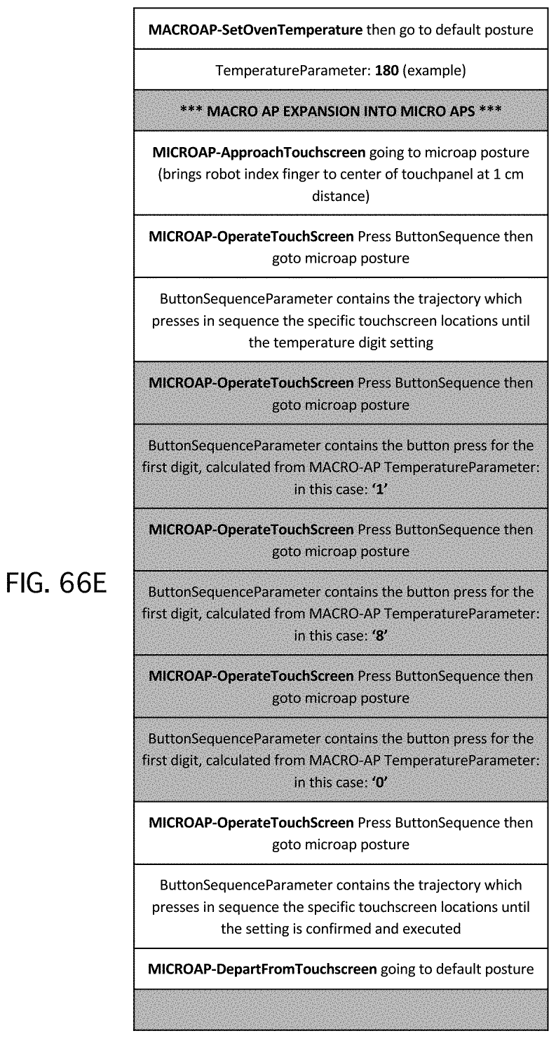

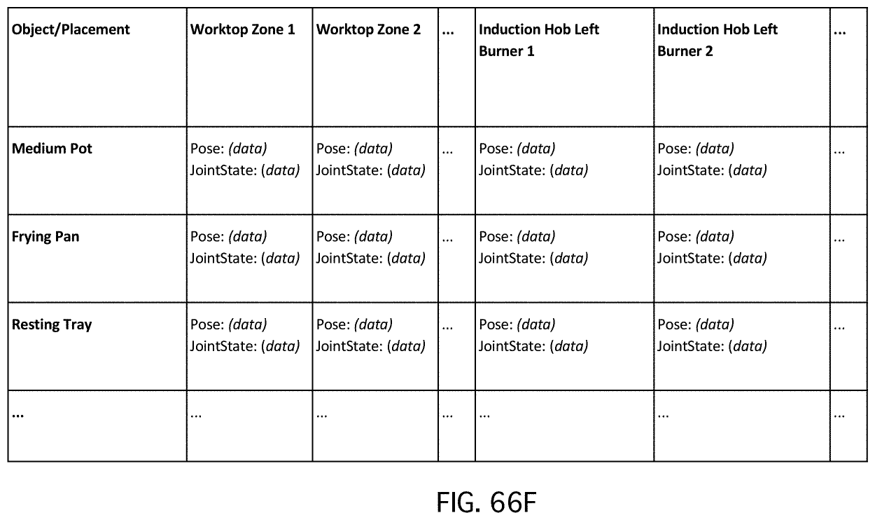

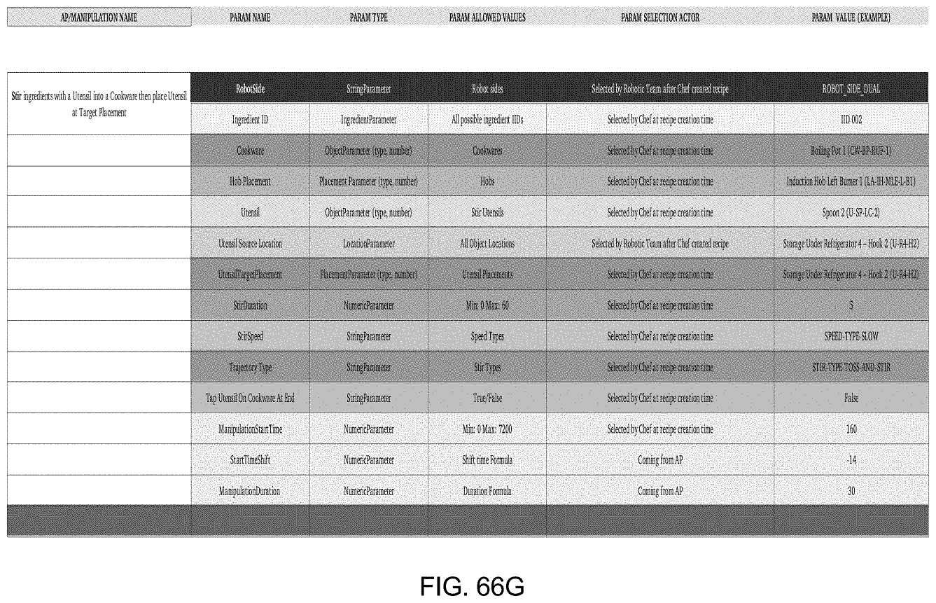

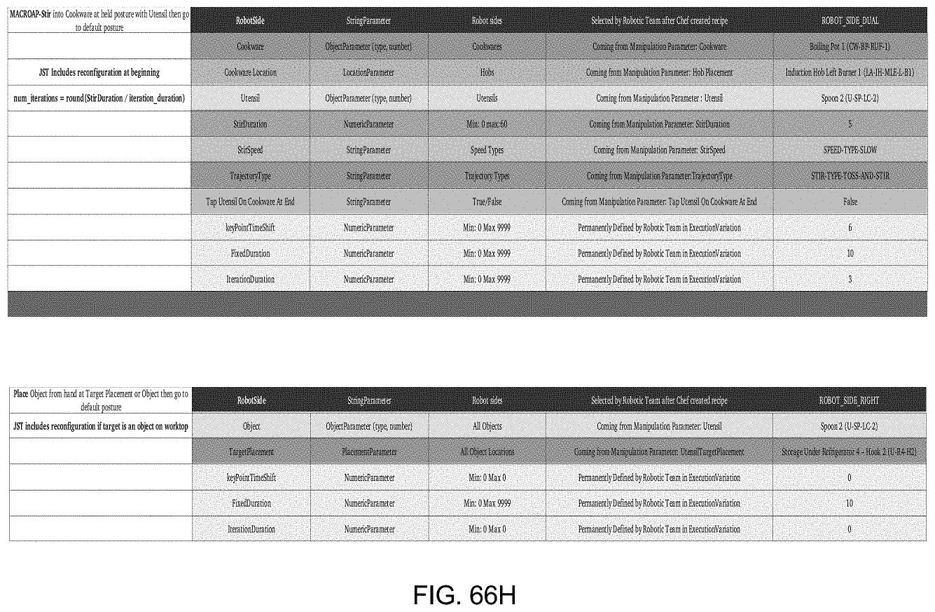

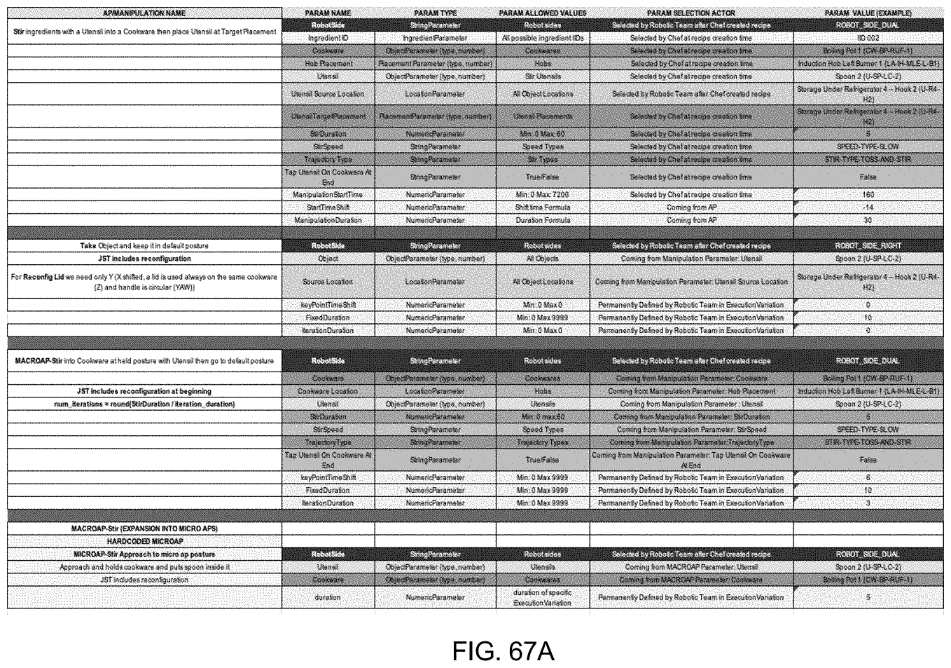

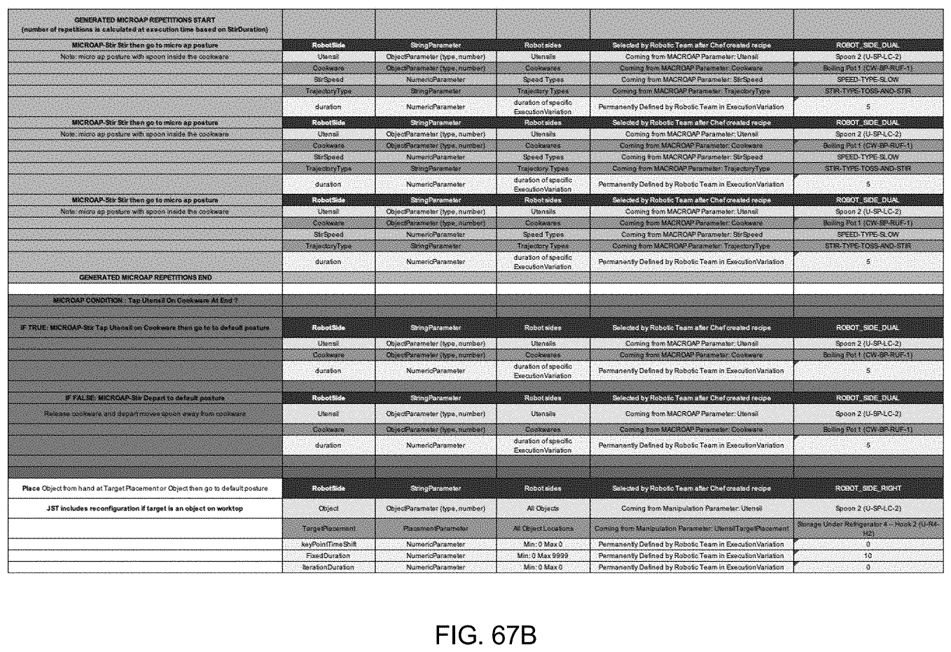

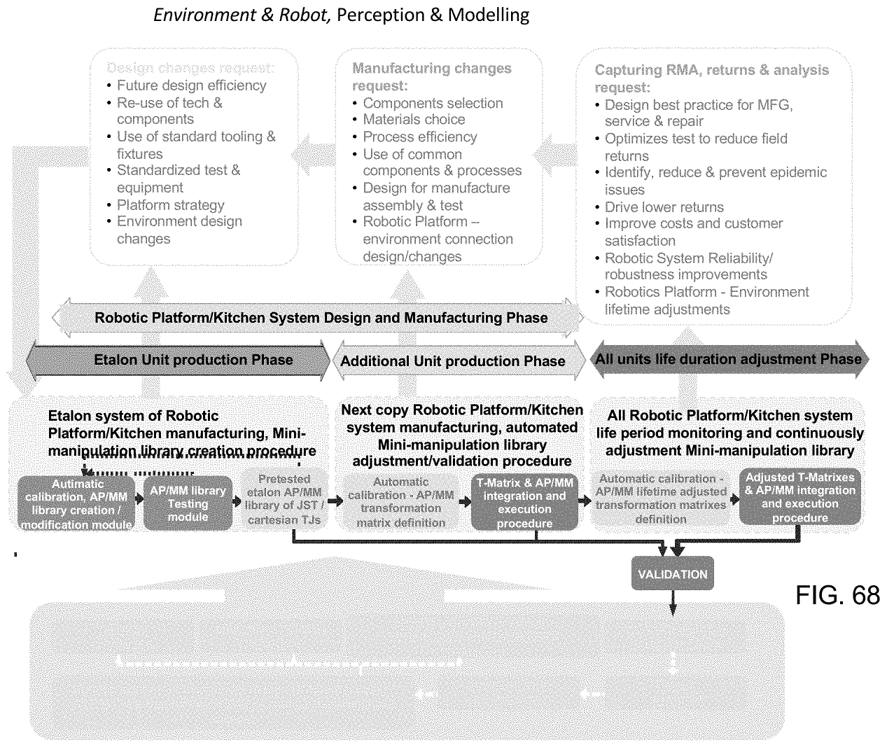

FIG. 64A is a flow diagram illustrating the repositioning a robotic apparatus by using actuators for compensating the difference of an environment in accordance with the present disclosure; FIG. 64B is a flow diagram illustrating the recalculation each robotic apparatus joint state for trajectory execution with x-y-z and rotational axes for compensating the difference of an environment in accordance with the present disclosure; and FIG. 64C is flow diagram illustrating cartesian trajectory planning for environment adjustment. FIG. 65 is a flow diagram illustrating the process of placement for reconfiguration with a joint state. FIGS. 66A-H are table diagrams illustrating one embodiment of a manipulations system for a robotic kitchen. FIGS. 67A-B are tables (intended as one table) illustrating one example of a stir manipulation to action primitive. FIG. 68 is a block diagram illustrating a robotic kitchen manufacturing environment with an etalon unit production phase, an additional unit production phase, and all units life duration adjustment phase in accordance with the present disclosure.

FIG. 66A shows a sample table in a recipe creation and the relationships with manipulations and action primitives. In the example with manipulation parameters, to take a frying_pan an put on the left burner of the induction hob, a chef uses the manipulation: “Take Object from current placement and place at TargetPlacement” and will set the internal parameters this way. In the second column of FIG. 67A, the parameter names show that: Object, TargetPlacement, ManipulationStartTime, StartTimeShift and ManipulationDuration.

Each parameter's value can be set choosing from a predefined allowed list of values (or also range, if it's numeric). Only selectable parameters can be set, others are automatic and cannot be changed by the user which creates the recipe but are a property of the manipulation itself. Selectable parameters which can be set by the user: Object, TargetPlacement, and ManipulationStartTime.

Automatic parameters (property of the manipulation) include StartTimeShift and ManipulationDuration. The automatic parameters are used by the recipe software to manage the creation of the recipe. Some of the automatic parameters can have more than one possible value, depending on the specific values of the selectable parameters.

An Action Primitive (AP) represents a very small or small functional operation, where a sequence of one or more APs compose a Manipulation. For example, the Manipulation is shown in FIG. 67A, while is composed of a sequence of Action Primitives as shown in FIG. 67B. Each manipulation parameter is mapped to one or more action primitive parameters.

The first thing to explain is the side: it can be Left/Right/Dual. For 1 hand operation its only R/L, for dual hand operation it's D.

Note: In other kitchens there may be more than 2 arms, let's say N arms, in that case instead of the variable ‘side’, a vector of arm ids can be used. For example arms_used: [1], or arms_used: [1,2,3], or arms_used: [1,5], any combination can be valid.
In this example Dual is used (‘D’), because the frying pan has 2 handles so 2 hands are needed.
Another dual ap example is “Stir”, because we need one hand to hold the cookware and another hand to move the utensil (spoon for example)
1.1 Manipulation Execution and arm alignment
In the above example:
1. Required Arm base (can also be more arms) is shifted (along the possible axis, depending on the particular kitchen configuration) until it's aligned with the object to take
2. The 1^{st} AP, starting from default posture, approaches and grasp the Frying Pan, then lift it up, then go to default posture
3. Required Arm base (can also be more arms) is shifted (along the possible axis, depending on the particular kitchen configuration) until it's aligned with the target placement
4. The 2^{nd} AP, starting from default posture, places the Frying Pan at the target placement, then release it and go back to default posture

### 2 Recipe Preparation

### 2.1 Compilation

As we previously said, the recipe comprises of a list of Manipulation, where each manipulation is filled with a value for each customizable parameter.
Once each parameter value has been set, for each manipulation, then the recipe is considered complete.
This process of compiling the recipe is done by the chef using Recipe Creator Application

### 2.2 Ingredient Preparation

Once the recipe is compiled, the Cooking Process Manager Application can be started for the next step: Ingredient Preparation.
For each ingredient specified in the recipe (as parameters in the several manipulations), the application will guide the user (typically the owner of the kitchen) to put the specific ingredient inside a specific container, and to put the container in a specific free compatible slot of the kitchen.
The preparation process must be done only once.
Once it's done, the system knows in which container each ingredient is stored, for that specific recipe. Other recipes will have a separate set of assigned ingredients/containers/slots, even if the ingredients used are the same: this limitation is applied to ensure each recipe has exclusive access and availability of its own ingredients.
This information is stored inside an ingredient assignment map.
Each container is an object as the other objects (cookwares, utensils) and it refer to each container with an object parameter which specifies the object type and the object number.
Example of the assignment map after ingredient preparation:
Rice is stored in object_type: medium_container, object_number: 1
Garlic is stored in object_type: medium_container, object_number: 2
Potato is in object_type: long_container, object_number: 1
Salt is in object_type: spice_container, object_number: 1
Pepper is in object_type: spice_container, object_number: 2
Oil is in stored in object_type: bottle, object_number:1
Red Wine is in stored in object_type: bottle, object_number:2
Water is in stored in object_type: bottle, object_number:3

### 2.3 Recipe Conversion

Once the ingredient preparation is done, the recipe must be converted for the robotic system.
The robotic system works only with objects, not with ingredients (a part specific special Manipulations that we will explain afterwards).
So each Ingredient Parameter used in the recipe must be replaced by the Cooking Process Manager to an Object Parameter of the type/number as specified in the ingredient assignment map.
Once the recipe is converted this way, is saved and it's ready to be executed (now or in a future moment, depending on the user's choice).
The conversion process must be done only once.

### 3 Recipe Execution

Once the recipe is converted as explained above, it can be executed by the Cooking Process Manager (aka CPM) and the AP Executor.

### Execution:

1. The CPM processes each manipulation at the time specified in the ManipulationStartTime parameter.
2. For each Manipulation, each AP is sent to the AP Executor and it's executed by the robotic system.
3. The outcome of each AP is sent back to CPM: if not successful the CPM can decide to do it again or abort the recipe.

### 4 AP Execution

Each AP is executed by AP Executor, which reads all parameters, shifts the arm or the platform so it's aligned with the required object or placement, then finally executes the AP.
Each AP starts and ends with a default posture, based on: robot side, held object/s.
This means that the AP execution will start with a default posture and end with a default posture. The start/end posture will be different if during the AP the object is grasped or released.
The following example is based on a simple kitchen configuration with one moving platform with 2 arms (left and right).
4.1 Example: AP sequence
Initial kitchen state

### AP No 1

name: TAKE Object
Variable Parameters: Object, side
Assigned parameter values:
   Object.type: spoon
   Object.number: 1
   side: left
Default Posture configuration
   start_posture_left_object: NONE
   start_posture_right_object: ANY
   end_posture_left_object: Object
   end_posture_right_object: ANY
      Align with object
      Note: Robot moved left close to the spoon aligning the left arm base with the spoon handle

### AP Execution

Start posture
side:left, object_type:NONE
side:right, object_type:ANY

End posture
side:left, object_type:spoon
side:right, object_type:ANY

### AP No 2:

name: TAKE Object
Variable Parameters: Object, side
Assigned parameter values:
   Object.type: medium_container
   Object.number: 3
   side: right
Default Posture configuration
   start_posture_left_object: ANY
   start_posture_right_object: NONE
   end_posture_left_object: ANY
   end_posture_right_object: Object
      Align with Object
      Note: robot moved right close to container aligning the right arm base with the container handle.

### AP Execution

Start posture
side:left, object_type:ANY
side:right, object_type:NONE

End posture
side:left, object_type:ANY
side:right, object_type:medium_container

### AP No 3:

name: MOVE_STICKY_INGREDIENT from SourceObject into TargetObject with Utensil
Variable Parameters: SourceObject, TargetObject, Utensil, side
Assigned parameter values:
   SourceObject.type: medium_container
   SourceObject.number: 3
   TargetObject.type: frying_pan
   TargetObject.number: 1
   Utensil.type: spoon
   Utensil.number: 1
   side: dual
Default Posture configuration
   start_dual_posture_left_object: Utensil
   start_dual_posture_right_object: SourceObject
   end_dual_posture_left_object: Utensil
   end_dual_posture_right_object: SourceObject
      Align with Object
      Note: robot moved down close to frying pan aligning the robot platform with the center of the frying pan.

### AP Execution

Start posture
side:left, object_type: spoon
side:right object_type: medium_container

End posture
side:left, object_type:spoon
side:right object_type: medium_container
   Ap Execution: The stirring ap is performed (not shown here) and the robot moves to the end posture (in this case it's the same as the start posture because the held objects are the same.

### 5 Micro/Macro Action Primitives and Micro Postures

### 5.1 MicroAP

Action Primitives can execute a single functional action, which is composed by a pre-determined number of internal steps.
For some special APs, the number of internal steps may depend on the ap parameters specific values, so it cannot be pre-determined once for all.
For example when stirring some contents inside a frying pan with a spoon, we need to do it for a specific time, specified by the duration parameter.
The core robotic movement of a stirring action comprises of the held spoon moved in a circle inside the cookware. It also may not be a circle, but the simplification we made for the kitchen system is this: the spoon performs ‘some stirring movement’ inside the cookware, with the spoon starting and ending at the same specific pose inside the cookware.
This can schematically described this way:
The core action for stir comprises of a movement for the utensil (spoon) wrt the cookware, where:
start/end utensil pose wrt cookware is the same
start/end jointstate for robot is the same (dual side joint state in this case)
   This core-action is called microAP (micro action primitive).
   The start/end jointstate for robot inside this mircoAP is called micro-default-posture.
   The micro-default-posture is something completely unrelated to the default postures that we discussed earlier, and it's used only in its specific microAP.

### 5.2 MACROAP

MicroAPs cannot be executed alone, but only in a sequence of microAPs packed together in a special AP called MACROAP.
This sequence of microAPs is not pre-defined: for example depending on the stirring time, a certain number of required microAP stirring steps is dynamically created at runtime and the sequence is updated.
The MACROAP can also contain some pre-defined microAPs, usually at the beginning and end of it, other than the dynamically created ones.
The execution of the MACROAP Stir is described below. 67C

### 5.2.1 MACRO-AP Stir

The microAP: Stir Approach is always at beginning of MACRO-Stir
The microAP: Stir Depart is always at end of MACRO-Stir
All the microAPs: Stir Stir are dynamically created at the beginning of the MACROAP execution, based on the parameter: “StirDuration”.
Each microAP, apart the last one, brings the robot to the micro-ap-posture with spoon inside the cookware at the place of start/end of stirring.
In this example we discussed AP Stir, but there are also other types of microAPs, which are calculated based on different parameters as we can see below.

### 5.2.2 MACRO-AP Pour

### 67D

Each microAP, apart the last one, brings the robot to the micro-ap-posture with source object above the center of target object.

### 5.2.3 MACRO-AP SetOvenTemperature

### 66E

Each microAP, apart the last one, brings the robot to the micro-ap-posture with index finger in front of the center of the touchscreen at 1 cm distance

### 6 Planning Modes

The Robotic Kitchen can execute an AP in several different planning modes:
pure real-time planning
   motion plan
   cartesian plan
mixed mode
   motion plan and pre-planned JST
   motion plan, cartesian plan and pre-planned JST (depending on the AP or the internal AP part)
   other combinations of motion plan, cartesian plan, pre-planned JST
pure pre-planned JST
   The pure real-time planning mode allows to execute an AP wherever the manipulated object is located in the kitchen, because the JST is planned right before the execution, based on the object position detected by the vision system.
   The drawback is the calculation complexity, it can take much time depending on the complexity of the problem (number and complexity of collision objects, working space, duration and properties of the trajectory, number of robot's degrees of freedom)
   This calculation complexity can be a problem for the motion planning, but even more for the cartesian planning, because it may cause long delays before the execution can be done, and it could also find a solution (the planned JST) which could be non optimal for the requirements, for several reasons.
   This is a well known problem in robotics.
   In order to avoid this problem, in some cases the robotic system can work with a pre-planned JST, which was previously tested multiple times and saved inside a cache, and then it can be retrieved and executed when required.
   It's also possible to make the robotic system to work with only pre-planned JSTs.
   In the following chapter is explained the method for using pre-planned JSTs.
   6.1 Pre-planned JST mode
   An Action Primitive with pre-planned JST can work only on a pre-defined object placement and pre-defined object pose in the kitchen.
   The pre-planned JST works only if the operated object pose is the one (or it's very close to the one) used when the JST was initially planned.
   If an object moves from it's pre-defined placement the AP doesn't work any more and the robot will collide with or miss the object to manipulate.
   To overcome this problem, we decided to pre-plan, for each AP, a set of JSTs for each combination of objects/placements.
   This set contains each possible object pose (wrt kitchen structure coordinate frame system) inside a limited area around the specified placement.
   All these JST sets are saved inside a cache in the software system. When an AP is executed, the system retrieves from the cache the JST for the specific combination of object_type/placement/object_pose
   Example of query to the cache:

Query parameters:
AP name: TAKE
object_type: frying_pan
object_placement: left_hob_1
object_pose:
   x: 1 m
   y: 20 m
   z: 0 m
   yaw: 10 deg
Note: The number and name of parameters can be different, it's a vector with dynamic size.
This means we can ask to cache using different combinations of parameters, having different filtering rules in order to obtain the required JST.
   The Cache returns the JST associated to the above parameters.
   The reason to specify the placement (left_hob_1) is because the AP was designed for that placement, but the object could have been moved so much to go closer to a different placement (example: right_hob_1) then we want to be sure the system executes the full AP designed for the original placement and not another one.

### 1 Overview

In the JST Kitchen each Action Primitive expects the manipulated object is located at a pre-defined pose in the kitchen and the robot state is at pre-defined posture.
Sometimes the object to manipulate may move from the pre-defined pose, then the AP cannot be executed.
Reconfiguration is a method to bring back the object to the pre-defined placement and the robot to the pre-defined posture, so then the AP can be executed.
2 Pre-defined data

### 2.1 Supported Predefined Placements

In the kitchen we have some pre-defined placements where an object is not mechanically constrained, so it may move unexpectedly:
Induction Hob Left Burner 1 (LA-IH-MLE-L-B1)
Induction Hob Left Burner 2 (LA-IH-MLE-L-B2)
Induction Hob Right Burner 1 (LA-IH-MLE-R-B1)
Induction Hob Right Burner 2 (LA-IH-MLE-R-B2)
Worktop Zone 1 (WT-X1-Y1)
Worktop Zone 2 (WT-X1-Y2)
Worktop Zone 3 (WT-X1-Y3)
Worktop Zone 4 (WT-X2-Y1)
Worktop Zone 5 (WT-X2-Y2)
Worktop Zone 6 (WT-X2-Y3)
Worktop Zone 7 (WT-X3-Y1)
Worktop Zone 8 (WT-X3-Y2)
Worktop Zone 9 (WT-X3-Y3)
Worktop Zone 10 (WT-X4-Y1)
Worktop Zone 11 (WT-X4-Y2)
Worktop Zone 12 (WT-X4-Y3)
   2.2 Supported objects

For each pre-defined placement, any Object which can be placed on it must be supported by reconfiguration, because it may move unexpectedly during the recipe execution.

2.3 Supported Predefined Object poses

The object pose is expressed as mesh_origin frame wrt kitchen structure frame.

For each pre-defined placement/object combination, the reconfiguration data is defined as:
object pose wrt kitchen
robot reconfiguration posture

These data can be called predefined reconfiguration map and must be saved in a permanent structure in the system and used by the reconfiguration process. It can be yaml, DB, ros msg or any other appropriate data structure usable at runtime.

### 2.3.1 Example: Predefined Reconfiguration Map

### 2.3.2 67F

### 3 Reconfiguration Process

For each used placement/object combination (used by any AP), a set of misplaced-object-poses must be supported.

For each misplaced-pose, a JST should be created and saved in cache.

These JSTs may be too many, so the solution is to use a range.

When object is inside this range, 1 JST is used.

So for example we can define for frying pan on hob1, 20 possible ranges for Y and 20 for YAW, and we can discard Z (always 0) and X (orthogonally shifted by gantry which moves the robot platform).

Then in this case we need to create 20×20=400 JST and save all of them inside the cache.

### 3.1 Sharing Reconfiguration

For other placements which only differ by X, reconfiguration can be shared by shifting X (example: Induction Hob Left Burner 1 and Induction Hob Right Burner 1)

In some cases this could be also applied to other axes (example: Z axis).

### 3.2 Creation Process

See flow chart in the next page.

***IMPORTANT***: we want to keep in cache all the created reconfiguration APs before final concatenation in the full AP, because if in the future we need to correct or recreate the subsequent AP (example: STIR) we don't have to re create all the JSTs !

### Stir Manipulation

[1] A Manipulation (‘Stir’ in the example) comprises of several parameters and a sequence of APs.
[2] The Recipe Creator performs a Parameter Propagation Step from AP to Manipulation. Example: it set the value of ManipulationDuation based on the value of AP Duration parameter of each AP in the sequence.
[3] The manipulation parameters are propagated to ap during the recipe preparation step, by CookingProcessManager, to set the ap parameters of each ap in the sequence. This process propagates some parameters from manipulation to ap (almost all of them,).
[4] Each manipulation parameter is selected by different actors at different moments. Some manipulation parameters are selected by Chef at recipe creation time: ‘Ingredient ID’, ‘Cookware’, ‘Hob Placement’, ‘Utensil’, ‘UtensilTargetPlacement’, ‘StirDuration’, ‘StirSpeed’, ‘TrajectoryType’, ‘Tap Utensil On Cook Cookware at End’, ‘ManipulatioonStartTime’. Some parameters are selected by Robotic Team after Chef created recipe: ‘Utensil Source RobotSide’, ‘Location’. Some parameters are propagated back from the APs in the sequence: ‘StartTimeShift’, ‘ManipulationDuration’.

### Stir Manipulation Expanded in APs

[5] The stir manipulation is composed by 3 APs:
1) Take Object and keep it in default posture
2) MACROAP-Stir into Cookware at held posture with Utensil then go to default posture
3) Place Object from hand at Target Placement or Target Object then go to default posture
   [6] Cooking Process Manager, at the end of the recipe preparation step, outputs the executable sequence of APs, each one with all its parameters set. Each AP in this sequence is associated with a timestamp, calculated based on the Manipulation parameter ‘ManipulationStartTime’ and the ‘Duration’ parameter of each AP before it.
   [7] Cooking Process Manager sends each AP to AP Executor for execution at the timestamp specified in the executable sequence.
   [8] AP Executor will execute each AP one by one, reporting any failure to the Cooking ProcessManager. The next ap is executed only if the previous is successful.
   [9] If an AP execution failed, the CookingProcessManager can decide to apply countermeasures to resolve the problem and try again. This retrial can be done multiple times. Based on internal logic, the CookingProcessManager can decide to abort the recipe if the failure is unresolvable.
   [10] There are 3 types of AP
AP
MacroAP
MicroAP
   [12] The Manipulation can be composed only by AP and MacroAP, but not by MicroAP.
   [13] Cooking Process Manager is not aware of the MicroAP type, indeed it will output a sequence of APs which can be only of these types:
AP
MacroAP
   [13] The simple AP type is just executed directly by the executor.
   MACROAP-Stir expanded in MICROAPs
   [14] The MacroAP type is composed internally by a sequence of MicroAPs
   [15] AP Executor expands MacroAp into the MicroAPs sequence at runtime, based on the MacroAP parameters.
   [15] Depending on the specific MacroAp, the logic to expand it into MicroAP may vary.
   [16] In the Stir MacroAp, the sequence of MicroAP is composed dynamically, based on the MacroAp parameters.
   [17] In MacroAP, some MicroAps are hardcoded (always present), some are dynamically generated at execution time, some are conditional.
   [18] The Stir MACROAP-Stir is composed by these MICROAPs:
1. (HARDCODED): MACROAP-Stir Approach to micro ap posture
2. (DYNAMICALLY GENERATED):
   1. MICROAP-Stir Stir then go to micro ap posture
   2. MICROAP-Stir Stir then go to micro ap posture
   3. MICROAP-Stir Stir then go to micro ap posture
   4. . . .
3. (CONDITIONAL: Tap Utensil on Cookware at End?)
   1. (IF TRUE): MICROAP-Stir Tap Utensil on Cookware then go to default posture
   2. (IF FALSE): MICROAP-Stir Depart to default posture

### Stir Manipulation

[1] A Manipulation (‘Stir’ in the example) comprises of several parameters and a sequence of APs.
[2] The Recipe Creator performs a Parameter Propagation Step from AP to Manipulation.
Example: it set the value of ManipulationDuation based on the value of AP Duration parameter of each AP in the sequence.
[3] The manipulation parameters are propagated to ap during the recipe preparation step, by CookingProcessManager, to set the ap parameters of each ap in the sequence. This process propagates some parameters from manipulation to ap (almost all of them,).
[4] Each manipulation parameter is selected by different actors at different moments. Some manipulation parameters are selected by Chef at recipe creation time: ‘Ingredient ID’, ‘Cookware’, ‘Hob Placement’, ‘Utensil’, ‘UtensilTargetPlacement’, ‘StirDuration’, ‘StirSpeed’, ‘TrajectoryType’, ‘Tap Utensil On Cook Cookware at End’, ‘ManipulatioonStartTime’. Some parameters are selected by Robotic Team after Chef created recipe: ‘Utensil Source RobotSide’, ‘Location’. Some parameters are propagated back from the APs in the sequence: ‘StartTimeShift’, ‘ManipulationDuration’.

### Stir Manipulation Expanded in APs

[1] The stir manipulation is composed by 3 APs:
1) Take Object and keep it in default posture.
2) MACROAP-Stir into Cookware at held posture with Utensil then go to default posture.
3) Place Object from hand at Target Placement or Target Object then go to default posture.
   [2] Cooking Process Manager, at the end of the recipe preparation step, outputs the executable sequence of APs, each one with all its parameters set. Each AP in this sequence is associated with a timestamp, calculated based on the Manipulation parameter ‘ManipulationStartTime’ and the ‘Duration’ parameter of each AP before it.
   [3] Cooking Process Manager sends each AP to AP Executor for execution at the timestamp specified in the executable sequence.
   [4] AP Executor will execute each AP one by one, reporting any failure to the Cooking ProcessManager. The next ap is executed only if the previous is successful.
   [5] If an AP execution failed, the CookingProcessManager can decide to apply countermeasures to resolve the problem and try again. This retrial can be done multiple times. Based on internal logic, the CookingProcessManager can decide to abort the recipe if the failure is unresolvable.
   [6] There are 3 types of AP
AP
MacroAP
MicroAP
   [12] The Manipulation can be composed only by AP and MacroAP, but not by MicroAP.
   [13] Cooking Process Manager is not aware of the MicroAP type, indeed it will output a sequence of APs which can be only of these types:
AP
MacroAP
   [13] The simple AP type is just executed directly by the executor.

Calibration of a robotic kitchen can be executed in a different methodologies. In one embodiment, the calibration of the robotic kitchen is conducted with cartesian trajectory. Before any execution of minimanipulation/action primitive, system should check status of environment. In case of no changes, the system will get cartesian trajectory associated with given minimanipulation/action primitive, plan it and execute. In case of changed environment, the calibration procedure should be performed with measuring the actual positions of placements and objects in the kitchen and then providing this data to the system. After this, cartesian trajectory will be re-planned based on updated environment state and then executed.

Calibration with cartesian trajectory diagram description: Before any execution of minimanipulation/action primitive, system should check status of environment. In case of no changes, the system will get cartesian trajectory associated with given minimanipulation/action primitive and plan it. In case of changed environment, the calibration procedure should be performed with measuring the actual state of the system (such as positions of placements and objects in the kitchen) using multiple sensors and then providing this data to the system. After this, cartesian trajectory will be re-planned based on updated environment state. The output from planning is joint state trajectory which can be saved as a new version for current or changed environment. After this, joint state trajectory can be executed.

Calibration with jointspace trajectory diagram description: Before any execution of minimanipulation/action primitive, system should check status of environment. In case of no changes, the system will get jointspace trajectory associated with given minimanipulation/action primitive and execute it. In case of changed environment, the calibration procedure should be performed with measuring the actual positions of placements and objects in the kitchen and then providing this data to the system. After this, joint values in joint state trajectory will modified based on updated environment state in order to shift joints and get new robot joint configuration for the whole trajectory along with usage of additional joints for compensation of the movement in all axes (x-y-z) including rotational movements around each axis and then executed.

In another embodiment, the calibration of the robotic kitchen is conducted with a jointspace trajectory. Before any execution of minimanipulation/action primitive, system should check status of environment. In case of no changes, the system will get jointspace trajectory associated with given minimanipulation/action primitive and execute it. In case of changed environment, the calibration procedure should be performed with measuring the actual positions of placements and objects in the kitchen and then providing this data to the system. After this, joint values in jointspace trajectory will modified based on updated environment state in order to shift joints and get new robot joint configuration for the whole trajectory along with usage of additional joints for compensation of the movement in all axes (x-y-z) including rotational movements around each axis and then executed.

FIG. 69 is a block diagram illustrating an example of a computer device, as shown in 960, on which computer-executable instructions to perform the methodologies discussed herein may be installed and run. As alluded to above, the various computer-based devices discussed in connection with the present disclosure may share similar attributes. Each of the computer devices is capable of executing a set of instructions to cause the computer device to perform any one or more of the methodologies discussed herein. The computer devices may represent any or all of the server, or any network intermediary devices. Further, while only a single machine is illustrated, the term “machine” shall also be taken to include any collection of machines that individually or jointly execute a set (or multiple sets) of instructions to perform any one or more of the methodologies discussed herein. The example computer system 960 includes a processor 962 (e.g., a central processing unit (CPU), a graphics processing unit (GPU), or both), a main memory 964 and a static memory 966, which communicate with each other via a bus 968. The computer system 960 may further include a video display unit 970 (e.g., a liquid crystal display (LCD)). The computer system 960 also includes an alphanumeric input device 972 (e.g., a keyboard), a cursor control device 974 (e.g., a mouse), a disk drive unit 976, a signal generation device 978 (e.g., a speaker), and a network interface device 980.

The disk drive unit 976 includes a machine-readable medium 980 on which is stored one or more sets of instructions (e.g., software 982) embodying any one or more of the methodologies or functions described herein. The software 982 may also reside, completely or at least partially, within the main memory 980 and/or within the processor 962 during execution thereof the computer system 960, the main memory 964, and the instruction-storing portions of processor 982 constituting machine-readable media. The software 982 may further be transmitted or received over a network 984 via the network interface device 986.

While the machine-readable medium 980 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any tangible medium that is capable of storing a set of instructions for execution by the machine and that cause the machine to perform any one or more of the methodologies of the present disclosure. The term “machine-readable medium” shall accordingly be taken to include, but not be limited to, solid-state memories, and optical and magnetic media.

Some portions of the above are presented in terms of algorithms and symbolic representations of operations on data bits within a computer memory. These algorithmic descriptions and representations are the means used by those skilled in the data processing arts to convey most effectively the substance of their work to others skilled in the art. An algorithm is generally perceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), erasable programmable ROMs (EPROMs), electrically erasable and programmable ROMs (EEPROMs), magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

Moreover, terms such as “request”, “client request”, “requested object”, or “object” may be used interchangeably to mean action(s), object(s), and/or information requested by a client from a network device, such as an intermediary or a server. In addition, the terms “response” or “server response” may be used interchangeably to mean corresponding action(s), object(s) and/or information returned from the network device. Furthermore, the terms “communication” and “client communication” may be used interchangeably to mean the overall process of a client making a request and the network device responding to the request.

In respect of any of the above system, device or apparatus aspects, there may further be provided method aspects comprising steps to carry out the functionality of the system. Additionally or alternatively, optional features may be found based on any one or more of the features described herein with respect to other aspects.

The present disclosure has been described in particular detail with respect to possible embodiments. Those skilled in the art will appreciate that the disclosure may be practiced in other embodiments. The particular naming of the components, capitalization of terms, the attributes, data structures, or any other programming or structural aspect is not mandatory or significant, and the mechanisms that implement the disclosure or its features may have different names, formats, or protocols. The system may be implemented via a combination of hardware and software, as described, or entirely in hardware elements, or entirely in software elements. The particular division of functionality between the various system components described herein is merely exemplary and not mandatory; functions performed by a single system component may instead be performed by multiple components, and functions performed by multiple components may instead be performed by a single component.

In various embodiments, the present disclosure can be implemented as a system or a method for performing the above-described techniques, either singly or in any combination. The combination of any specific features described herein is also provided, even if that combination is not explicitly described. In another embodiment, the present disclosure can be implemented as a computer program product comprising a computer-readable storage medium and computer program code, encoded on the medium, for causing a processor in a computing device or other electronic device to perform the above-described techniques.

As used herein, any reference to “one embodiment” or to “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The algorithms and displays presented herein are not inherently related to any particular computer, virtualized system, or other apparatus. Various general-purpose systems may also be used with programs, in accordance with the teachings herein, or the systems may prove convenient to construct more specialized apparatus needed to perform the required method steps. The required structure for a variety of these systems will be apparent from the description provided herein. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

In various embodiments, the present disclosure can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the disclosure include a mobile phone, personal digital assistant, smartphone, kiosk, desktop computer, laptop computer, consumer electronic device, television, set-top box, or the like. An electronic device for implementing the present disclosure may use an operating system such as, for example, iOS available from Apple Inc. of Cupertino, Calif., Android available from Google Inc. of Mountain View, Calif., Microsoft Windows 10 available from Microsoft Corporation of Redmond, Wash., or any other operating system that is adapted for use on the device. In some embodiments, the electronic device for implementing the present disclosure includes functionality for communication over one or more networks, including for example a cellular telephone network, wireless network, and/or computer network such as the Internet.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one as or more than one. The term “plurality,” as used herein, is defined as two or as more than two. The term “another,” as used herein, is defined as at least a second or more.

An ordinary artisan should require no additional explanation in developing the methods and systems described herein but may find some possibly helpful guidance in the preparation of these methods and systems by examining standardized reference works in the relevant art.

While the disclosure has been described with respect to a limited number of embodiments, those skilled in the art, having benefit of the above description, will appreciate that other embodiments may be devised which do not depart from the scope of the present disclosure as described herein. It should be noted that the language used in the specification has been principally selected for readability and instructional purposes, and may not have been selected to delineate or circumscribe the inventive subject matter. The terms used should not be construed to limit the disclosure to the specific embodiments disclosed in the specification and the claims, but the terms should be construed to include all methods and systems that operate under the claims set forth herein below. Accordingly, the disclosure is not limited by the disclosure, but instead its scope is to be determined entirely by the following claims.

What is claimed and desired to be secured by Letters Patent of the United States is:

1. A system for mass production of a robotic kitchen module, comprising:
a kitchen module frame for housing a robotic apparatus in an instrumented environment, the robotic apparatus having one or more robotic arms and one or more effectors, the one or more robotic arms including a share joint, the kitchen module having a set of robotic operable parameters for calibration verifications to an initial state for operation by the robotic apparatus; and
one or more calibration actuators coupled to a respective one of the one or more robotic arms, each calibration actuator corresponding to an axis on x-y-z axes, each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and
a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations.

2. The system of claim 1, wherein the detector comprises at least one probe.

3. The system of claim 2, wherein the kitchen module frame having a physical representation and a virtual representation, the virtual representation of the kitchen module frame being fully synchronized with the physical representation of the kitchen module frame.

4. A robotic multi-function platform, comprising:
an instrumental environment having an operation area and a storage space, the storage area having one or more actuators, one or more rails, a plurality of locations, and one or more placements;
one or more weighting sensors, one or more camera sensors, and one or more lights a processor executed to operate:
receiving a command to locate an identified object, the processor identifying the object location of the object in the storage area, the processor activating the one or more actuators to move the object from the storage area to the operation area of the instrumented environment.

5. A robotic multi-function platform of claim 4, wherein the storage space comprises a refrigerated area, the refrigerated area including one or more sensors and one or more actuators, and one or more automated doors with one or more actuators.

6. The robotic multi-function platform of claim 4, wherein the instrumented environment comprises one or more electronic hooks to change the orientation of the object.

7. A multi-functional robotic platform, comprising:
one or more robotic apparatus;
one or more end effectors;
one or more operation zones;
one or more sensors;
one or more safety guards;
a minimanipulation library comprising one or more minimanipulations;
a task management and distribution module receiving an operation mode, the operation mode including a robot mode, a collaborative mode and a user mode, wherein in the collaborative mode, the task management and distribution module distributing one or more minimanipulations to a first operation zone for a robot and a second operation zone for the user; and
an instrumented environment with one or more operational objects adopted for human and one or more robotic apparatuses interactions.

8. The platform of claim 7, further comprising one or more automated storage area.

9. The platform of claim 7, further comprising one or more inventory devices.

10. The platform of claim 7, further comprising one or more inventory devices. Using cartesian trajectory.
